(19) United States
(12) Patent Application Publication
(10) Pub. No.: US 2026/0072402 A1
(43) Pub. Date: Mar. 12, 2026

(54) SYSTEMS, METHODS, AND DEVICE ARCHITECTURES FOR OPTICAL APPLICATIONS

(71) Applicant: Meta Platforms Technologies, LLC, Menlo Park, CA (US)

(72) Inventors: Tingling Rao, Bellevue, WA (US); Kevin Lai Lin, Pleasanton, CA (US); Kimberly Kay Childress, Duvall, WA (US); Tuoqi Li, Bellevue, WA (US); Alexander Hsing, Redondo Beach, CA (US); Poer Sung, Woodinville, WA (US); Burkley Delesdernier Patterson, Catonsville, MD (US); Min Chul Shin, Bellevue, WA (US); Sean Braxton, Redmond, WA (US); Oliver Strider Cossairt, Seattle, WA (US); Douglas Robert Lanman, Bellevue, WA (US); Nathan Matsuda, Seattle, WA (US); Grace Elizabeth Kuo, Seattle, WA (US)

(21) Appl. No.: 19/323,385

(22) Filed: Sep. 9, 2025

Related U.S. Application Data
(60) Provisional application No. 63/692,291, filed on Sep. 9, 2024.
(60) Provisional application No. 63/720,125, filed on Nov. 13, 2024.
(60) Provisional application No. 63/742,458, filed on Jan. 7, 2025.

(51) Int. Cl. G03H 1/32; G03H 1/18

(52) U.S. Cl. CPC G03H 1/32; G03H 1/18

(57) ABSTRACT

An OSC material may include a grating structure for use in waveguide applications. A method of patterning the OSC material to create the grating structure may include forming a hard mask over the OSC layer and etching the OSC layer through an opening in the hard mask. Furthermore, an improved design of a grating light valve device may include a reflective backplane, an array of micro-ribbons disposed on the reflective backplane, and a metasurface structure positioned beneath the array of micro-ribbons. A multiple stage process may include generating a broad spectrum of light from a laser architecture, filtering and multiplexing the wavelengths of light using an image optimization module, and incoherently averaging the speckle patterns across the various wavelengths using a spatial light modulator architecture.

### CROSS-REFERENCE TO RELATED APPLICATIONS

This application claims priority to U.S. Application No. 63/692,291, filed 9 Sep. 2024, U.S. Application No. 63/720,125, filed 13 Nov. 2024, and U.S. Application No. 63/742,458, filed 7 Jan. 2025, and the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is an illustration of an exemplary method for forming a hard mask over an organic solid crystal material, according to some embodiments.

FIG. 1B-1D is an illustration of an exemplary method for a lithography process for forming a grating structure in an organic solid crystal material, according to some embodiments.

FIG. 2A-2B is an illustration of an exemplary method for etching an organic solid crystal material and a hard mask or forming a grating structure in an organic solid crystal, according to some embodiments.

FIG. 3 is an illustration of an exemplary grating structure in an organic solid crystal material including a conformal coating, according to some embodiments.

FIG. 4 is an illustration of exemplary patterns for a grating structure, according to some embodiments.

FIG. 5 illustrates an example hyperspectral propagation model and perceptual optimization framework.

FIG. 6 illustrates an example holographic image speckle reduction model architecture.

FIG. 7 illustrates an example method for holographic image speckle reduction as disclose herein.

FIG. 8 illustrates a machine learning and training model in accordance with various examples of the present disclosure.

FIG. 9 illustrates example qualitative comparisons between holographic image generation models' outputs of 2-dimensional and 3-dimensional images.

FIG. 10 illustrates example qualitative comparisons between holography models' speckle reduction in holographic images.

FIG. 11 illustrates example qualitative comparisons between holography models' image quality for a single spatial light modulator frame.

FIG. 12 illustrates example qualitative comparisons of image quality between one and two spatial light modulator configurations.

FIG. 13 illustrates example qualitative comparisons between holography models' image quality.

FIG. 14 illustrates an example of tradeoff between wide color gamut and speckle reduction offered by the holographic image speckle reduction model disclosed herein.

FIG. 15 illustrates an example the effect of varying bandwidth and the number of wavelengths on image quality.

FIG. 16 illustrates an example qualitative comparison of holography models' speckle reduction in various images.

FIG. 17 illustrates an example schematic of a setup of a holographic image model.

FIG. 18 illustrates an example overview of the learned parameters in the disclosed holographic image model.

FIG. 19 illustrates an example comparison of 2-dimensional holograms between various holography models and the disclosed model.

FIG. 20 illustrates an example comparison of focal stacks between holography models.

FIG. 21 illustrates example comparisons of focal stacks between holography models.

FIG. 22 illustrates an example block diagram of a device.

FIG. 23 is an illustration of an example artificial-reality system according to some embodiments of this disclosure.

FIG. 24 is an illustration of an example artificial-reality system with a handheld device according to some embodiments of this disclosure.

FIG. 25A is an illustration of example user interactions within an artificial-reality system according to some embodiments of this disclosure.

FIG. 25B is an illustration of example user interactions within an artificial-reality system according to some embodiments of this disclosure.

FIG. 26A is an illustration of example user interactions within an artificial-reality system according to some embodiments of this disclosure.

FIG. 26B is an illustration of example user interactions within an artificial-reality system according to some embodiments of this disclosure.

FIG. 27 is an illustration of an example wrist-wearable device of an artificial-reality system according to some embodiments of this disclosure.

FIG. 28 is an illustration of an example wearable artificial-reality system according to some embodiments of this disclosure.

FIG. 29 is an illustration of an example augmented-reality system according to some embodiments of this disclosure.

FIG. 30A is an illustration of an example virtual-reality system according to some embodiments of this disclosure.

FIG. 30B is an illustration of another perspective of the virtual-reality systems shown in FIG. 30A.

FIG. 31 is a block diagram showing system components of example artificial- and virtual-reality systems.

FIG. 32A is an illustration of an example intermediary processing device according to embodiments of this disclosure.

FIG. 32B is a perspective view of the intermediary processing device shown in FIG. 32A.

FIG. 33 is a block diagram showing example components of the intermediary processing device illustrated in FIGS. 32A and 32B.

FIG. 34A is front view of an example haptic feedback device according to embodiments of this disclosure.

FIG. 34B is a back view of the example haptic feedback device shown in FIG. FIG. 34A according to embodiments of this disclosure.

FIG. 35 is a block diagram of example components of a haptic feedback device according to embodiments of this disclosure.

FIG. 36 an illustration of an example system that incorporates an eye-tracking subsystem capable of tracking a user's eye(s).

FIG. 37 is a more detailed illustration of various aspects of the eye-tracking subsystem illustrated in FIG. 36.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Inorganic, liquid crystal, and polymer materials may be used to form optoelectronic structures and devices. These materials are quickly reaching their application limits due to issues such as weight, limited refractive index, limited birefringence, and lack of tunability. Due to current materials limitation, devices are restricted in size/weight, optoelectronic performance, such as angular bandwidth and resolution, and manufacturability. Therefore, small molecular solid organic materials allow for the formation of novel active and passive optoelectronic elements that can be cheap, and light weight.

Disclosed are organic solid crystals having an actively tunable refractive index and birefringence. Methods of manufacturing such organic solid crystals may enable control of their surface roughness independent of surface features (e.g., gratings) and may include the formation of an organic article therefrom. A variable and controllable refractive index architecture may be incorporated into and enable various optic and photonic devices and systems.

According to various embodiments, an organic article including an organic solid crystal (OSC) may be integrated into an optical component or device, such as an OFET, OPV, OLED, etc., and may be incorporated into an optical element such as a waveguide, Fresnel lens (e.g., a cylindrical Fresnel lens or a spherical Fresnel lens), grating, photonic integrated circuit, birefringent compensation layer, reflective polarizer, index matching layer (LED/OLED), holographic data storage element, and the like.

As will be appreciated, one or more characteristics of organic solid crystals may be specifically tailored for a particular application. For many optical applications, for instance, it may be advantageous to control crystallite size, surface roughness, mechanical strength and toughness, and the orientation of crystallites and/or molecules within an organic solid crystal thin film or fiber.

The active modulation of refractive index may improve the performance of photonic systems and devices, including passive and active optical waveguides, resonators, lasers, optical modulators, etc. Further example active optics include projectors and projection optics, ophthalmic high index lenses, eye-tracking, gradient-index optics, Pancharatnam-Berry phase (PBP) lenses, pupil steering elements, microlenses, optical computing, fiber optics, rewritable optical data storage, all-optical logic gates, multi-wavelength optical data processing, optical transistors, etc.

The present disclosure is generally directed to a process for patterning organic solid crystals for waveguide application. Organic Solid Crystals (OSC) may be made into high refractive-index optical waveguides by patterning gratings directly into the OSC material. A method of patterning gratings on OSCs may include a lithography and etching process to create different shapes of gratings. Additionally, a hard mask may be used during the lithography and etching process to provide a protective layer on the OSCs. In some examples, the hard mask may be left on the gratings if the mask does not impair the optical capabilities of the OSCs. Furthermore, upon patterning gratings on OSCs, a wet-patterning or a dry-patterning fillable material process may be used to minimize the differences in refractive index between the spaces created during etching of gratings and the gratings themselves. Patterning into OSCs for high-refractive index waveguides may be important for the future because they have optical properties that rival those of inorganic crystals. The present disclosure is also generally directed to an improved design for a miniaturized device (e.g., a grating light value) designed to enhance the resolution display quality of augmented reality (AR) and virtual reality (VR) devices. The device may include an array of ribbons (e.g., micro-ribbons) disposed on a reflective backplane. The term “ribbon,” as used herein, may generally refer to any type or form of mechanical component capable of managing, processing, and/or transmitting electronic signals. Ribbons may be formed from a variety of different materials, including without limitation, fabricable materials and materials reactive to visible light. Additionally, the device may further include a metasurface structure applied to the underside of the array of ribbons and/or individually applied to the underside of each ribbon. Finally, the present disclosure is also generally directed to a holographic image model for reducing speckle in images by using a polychromatic light source module to emit a broad spectrum of light using a laser architecture. One or more wavelengths of the light may be filtered or multiplexed using an image optimization module. A spatial light modulator architecture may use one or more spatial light modulators to incoherently average speckle patterns across various wavelengths. Different embodiments may allow for different numbers of lasers or spatial light modulators.

In one example, the disclosed systems and methods for an improved design of a grating light valve (GLV) device may include and/or represent a GLV pixel in a GLV display. The GLV device may include a backplane including an array of ribbons disposed on the backplane. The GLV device may utilize the array of ribbons that may include and/or represent a micromechanical structure to improve the resolution on display devices. In some examples, each ribbon on the array may function as a single pixel on the display device. The improved design of the GLV device may leverage electrostatic actuation, where electronic signals (such as voltage, light sources, etc.) may be applied to the array of ribbons. The electronic signals may cause each ribbon to move across the surface of the backplane. As the ribbons move, an airgap may form between the ribbons and the backplane, where the airgap size may vary in response to the applied electronic signals. In some examples, applying the electric signal to the ribbons may modulate an intensity of light reflected from the backplane, enabling the display to produce varying levels of brightness. The interaction between the ribbons and the light source may include constructive and/or destructive interference principals, enhancing the control over pixel brightness based on a position of each ribbon.

In other examples, the improved design of the GLV device may include a metasurface structure applied to the underside of the array of ribbons. The metasurface structure may be designed to improve the optical response of each ribbon by utilizing properties of sub-wavelength structures, such as gratings and/or photonic crystals. In some examples, the metasurface structure may interact with light that is reflected from the backplane, refining the brightness control at the individual pixel level. In some examples, the metasurface structure may enable the tuning of light interactions through resonant responses, such as Fabry-Perot or photonic crystal effects. In some examples, the GLV device may reduce a stroke length of the ribbons required for full optical state changes. In traditional GLVs, a full optical transition may require a ribbon to move by approximately one-quarter of the wavelength of light (e.g., lambda/4 stroke). Incorporating metasurface structures and exploiting resonant optical interactions may enable the disclosed GLV device to achieve a brighter-to-darker transition, reducing the distance of the required stroke length (e.g., lambda/8 stroke, lambda/16 stroke, lambda/32 stroke etc.). Reducing the distance in this way may improve the actuation speed and power consumption of the GLV device.

In further examples, the metasurface structures may improve an angular response of the array of ribbons, enabling dynamic control over the reflection of light at different angles (e.g., light expressed in an angle range of 0°-180°). Improving the angular response in this way may enable a wider field of view and an improved contrast ratio for display devices, enhancing the overall immersive user experience. In some examples, the array of ribbons may be integrated with a waveguide display to mitigate various forms of pupil disparity, such as pupil size, position, and/or alignment to optimize light uniformity across the viewing area. The disclosed systems and methods for improving the angular response of the array of ribbons may also include using materials responsive to visible light and compatible with fabrication processes. For example, materials such as Si3N4, Al2O3, and TiO2 may be chosen for their ability to be deposited in thin layers and for their responsiveness in the visible light spectrum. Additionally, the metasurface structures may be fine-tuned for specific wavelengths and resonant conditions, allowing for better control over light reflection and reducing interference patterns that could degrade image quality.

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Contemporary holographic displays are hindered by speckle noise which limits accurate reproduction of color and texture in displayed images. The present disclosure relates to systems and methods for speckle reduction in holographic displays, which may occur via wavelength multiplexing. More specifically, the disclosed techniques may reduce speckle in holographic images by wavelength multiplexing. Wavelength multiplexing may comprise utilizing an ultrafast, wavelength-adjustable laser or a dual spatial light modulator (SLM) architecture, enabling the multiplexing of a large set of discrete wavelengths over the visible spectrum. The disclosed holographic image speckle reduction method may be combined with orthogonally related speckle reduction methods for enhanced speckle reduction in holographic images.

The disclosed holographic image speckle reduction technique may enable multiple innovations. The disclosed technique may enable polychromatic illumination, dual-SLM architecture, optimization of display performance using a polychromatic simulation framework, or hyperspectral calibration. By combining the advantages of wavelength multiplexing and a dual-SLM design, the disclosed holographic image speckle reduction technique may be used to adjust image quality to enable significantly reduced speckle noise while maintaining a broader achievable color gamut compared to 2-color primary holographic displays.

The disclosed subject matter may enable the manipulation of speckle patterns across a diversity of wavelengths, resulting in an ability to reduce speckle through incoherent averaging via wavelength multiplexing, an approach that may be orthogonal to contemporary speckle reduction methods. The disclosed holographic image speckle reduction technique may be used in conjunction with those contemporary speckle reduction methods, achieving better speckle reduction than if any of the methods are used alone. The disclosed technique may additionally increase the color gamut relative to three laser RGB architectures.

The disclosed holographic image speckle reduction method may decrease speckle utilizing a system that may comprise an ultrafast wavelength tunable laser source to generate a set of independent polychromatic, spatially coherent wavefronts and a dual SLM architecture. The use of polychromatic illumination may reduce speckle while broadening the achievable color gamut compared to 3-color primary holographic displays.

Features from any of the embodiments described herein may be used in combination with one another in accordance with the general principles described herein. These and other embodiments, features, and advantages will be more fully understood upon reading the following detailed description in conjunction with the accompanying drawings and claims.

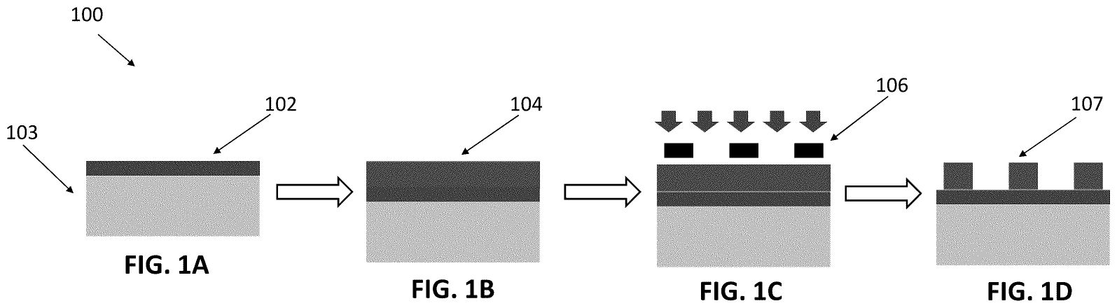

FIGS. 1A, 1B, and 1C illustrate an exemplary method 100 using a lithography process for forming a grating structure in an OSC layer 103 including a hard mask 102. More specifically, FIG. 1A is an illustration of a method for forming the hard mask 102 over the OSC layer 103. In some embodiments, OSC layer 103 may include a crystalline phase including organic small molecules. As used herein, a hard mask may generally refer to a type of masking material that serves as a protective barrier for the OSC layer 103. In some embodiments, hard mask 102 may include a material made up of silicon oxide, silicon nitride, titanium nitride, etc. In some embodiments, hard mask 102 may be formed over OSC layer 103 using a physical vapor deposition (PVD), plasma-enhanced chemical vapor deposition (PECVD), and the like.

As mentioned previously, OSCs may enable a variable refractive index in a waveguides that rival that of inorganic materials. However, forming a grating structure may be more difficult in the OSC layer 103, than an inorganic layer because OSC layer 103 is inherently much softer and more flexible than inorganic materials. Therefore, hard mask 102 may serve as a barrier layer to provide a degree of mechanical protection against any forms of physical stress that may impact a functionality of the OSC layer 103. As will be disclosed herein, hard mask 102 may shield OSC layer 103 from processes that utilize high temperatures such as lithography and etching.

Turning to FIGS. 1B, 1C, and 1D, the illustrated embodiments detail a multi-step lithography process for forming a grating structure in the OSC layer 103. More specifically, FIG. 1B may detail a method of forming a photoresist layer 104 over the hard mask 102. In some embodiments, photoresist layer 104 may be formed over the OSC layer 103. As used herein, a photoresist layer may generally refer to a light-sensitive material applied to a substrate to transfer a pattern. In some embodiments, photoresist layer 104 may be formed by dip-coating, spin-coating, air-brushing, spray-coating, doctor-blading, ink-jet printing, extrusion, soft lithography, replica molding, 3D printing, or other material deposition method suitable for depositing photoresist layer 104 over hard mask 102.

In some embodiments, a grating structure in the OSC layer 103 may be formed by a lithography process such as a photolithography process. As illustrated in FIG. 1C, the photoresist layer 104 may be exposed to a pattern of radiation 106 using a focused energy beam or blanket exposure. Example lithography techniques may include optical, electron beam, imprint, or other patterning techniques capable of resolving features on the order of approximately 120 to approximately 180 nm.

Referring to FIG. 1D, the illustrated embodiment details a patterned photoresist layer 107 that may be developed upon exposure to the pattern of radiation 106 as illustrated in FIG. 1C. For example, a portion of the photosensitive material may be removed by selective development, to produce the patterned photoresist layer 107. In some embodiments, upon developing the patterned photoresist layer 107, a hard bake may further harden the patterned photoresist layer 107 to improve resistance of the patterned photoresist layer 107 during subsequent processes, such as etching.

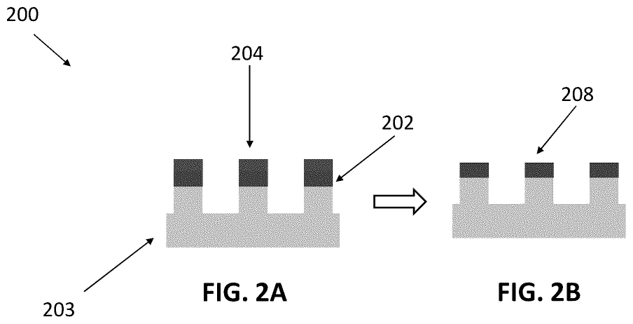

FIGS. 2A and 2B illustrate an exemplary method 200 for etching an OSC layer 203 to form a grating structure 208. As used herein, a grating is an optical element having a periodic structure that is configured to disperse or diffract light into plural component beams. The direction or diffraction angles of the diffracted light may depend on the wavelength of the light incident on the grating, the orientation of the incident light with respect to a grating surface, and the spacing between adjacent diffracting elements. In certain embodiments, grating architectures may be tunable along one, two, or three dimensions. Optical elements may include a single layer or a multilayer OSC architecture.

As illustrated in FIG. 1D, the patterned photoresist layer 107 is thereafter transferred into an underlying hard mask 202 utilizing at least one pattern transfer etching process. Examples of etching processes that may be used to transfer the pattern may include dry etching (e.g., reactive ion etching, plasma etching, or ion beam etching) and/or a chemical wet etch process.

A two-step dry etching process may be favorable because a dry etch is capable of achieving high aspect ratios. The first etch may create the opening in the hard mask 202. The second etch may etch the OSC layer 203 through the opening in the hard mask 202, created by the first etch, to form the grating structure 208. During the second etch of the OSC layer 203, a patterned photoresist layer 204 may be removed. Turning to FIG. 2B, a grating structure 208 may be formed in the OSC layer upon completing the dry etching process. As mentioned previously, hard mask 202 may serve as a protection layer for OSC layer 203 during a lithography and etching process. In some embodiments, hard mask 202 may be left behind in the grating structure 208 if hard mask 202 is optically friendly, as illustrated in FIG. 2B. In some embodiments, if hard mask 202 impairs a functionality of the OSC layer 203 in a waveguide, hard mask 202 may need to be removed during a wet etch process. In some embodiments, grating structure 208 may be etched directly into an OSC layer 203, omitting the hard mask 202 completely.

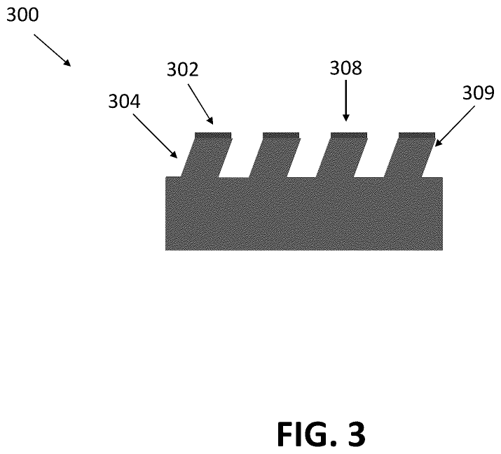

FIG. 3 is an illustration of an exemplary structure 300 including grating structure 308 in an OSC layer 304 including a conformal coating 309. As used herein, a conformal coating can generally refer to a thin protective film that serves as a sealant to encapsulate an entire surface of the grating structure. In some embodiments, the conformal coating 309 may include free-standing molecules (e.g., an oil or a brushed layer of a polymer, oligomer, or small molecules such as silane or a fluorinated polymer). In some embodiments, the conformal coating 309 may encapsulate a hard mask 302.

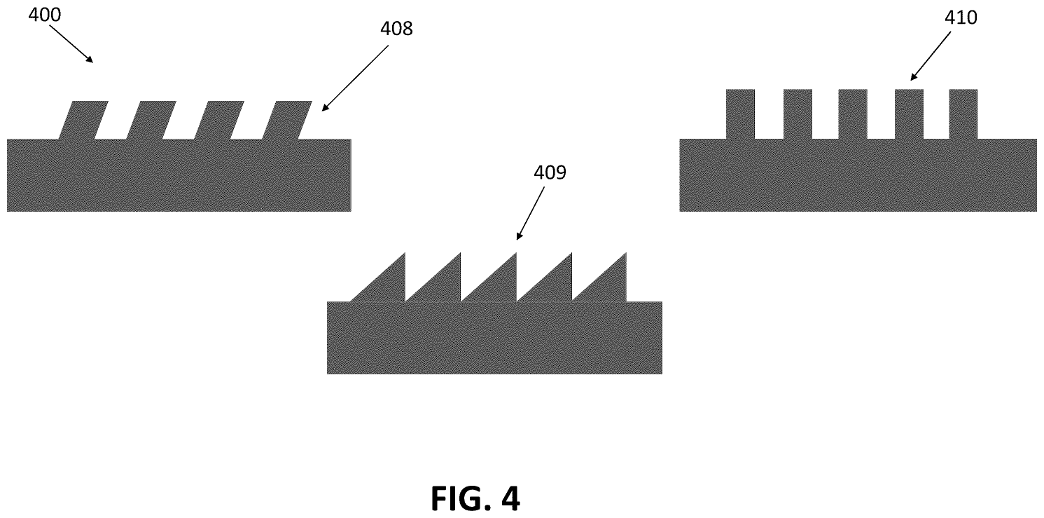

FIG. 4 is an illustration of exemplary patterns 408, 409, and 410 for a grating structure 400. For example, grating structure 400 may include pyramids as seen in pattern 409. Additionally, grating structure 400 may include rectangular prisms as seen in pattern 408 and pattern 410.

In one example, the disclosed systems and methods for an improved design of a grating light valve (GLV) device may include and/or represent a GLV pixel in a GLV display. The GLV device may include a backplane including an array of ribbons disposed on the backplane. The GLV device may utilize the array of ribbons that may include and/or represent a micromechanical structure to improve the resolution on display devices. In some examples, each ribbon on the array may function as a single pixel on the display device. The improved design of the GLV device may leverage electrostatic actuation, where electronic signals (such as voltage, light sources, etc.) may be applied to the array of ribbons. The electronic signals may cause each ribbon to move across the surface of the backplane. As the ribbons move, an airgap may form between the ribbons and the backplane, where the airgap size may vary in response to the applied electronic signals. In some examples, applying the electric signal to the ribbons may modulate an intensity of light reflected from the backplane, enabling the display to produce varying levels of brightness. The interaction between the ribbons and the light source may include constructive and/or destructive interference principals, enhancing the control over pixel brightness based on a position of each ribbon.

In other examples, the improved design of the GLV device may include a metasurface structure applied to the underside of the array of ribbons. The metasurface structure may be designed to improve the optical response of each ribbon by utilizing properties of sub-wavelength structures, such as gratings and/or photonic crystals. In some examples, the metasurface structure may interact with light that is reflected from the backplane, refining the brightness control at the individual pixel level. In some examples, the metasurface structure may enable the tuning of light interactions through resonant responses, such as Fabry-Perot or photonic crystal effects. In some examples, the GLV device may reduce a stroke length of the ribbons required for full optical state changes. In traditional GLVs, a full optical transition may require a ribbon to move by approximately one-quarter of the wavelength of light (e.g., lambda/4 stroke). Incorporating metasurface structures and exploiting resonant optical interactions may enable the disclosed GLV device to achieve a brighter-to-darker transition, reducing the distance of the required stroke length (e.g., lambda/8 stroke, lambda/16 stroke, lambda/32 stroke etc.). Reducing the distance in this way may improve the actuation speed and power consumption of the GLV device.

In further examples, the metasurface structures may improve an angular response of the array of ribbons, enabling dynamic control over the reflection of light at different angles (e.g., light expressed in an angle range of 0°-180°). Improving the angular response in this way may enable a wider field of view and an improved contrast ratio for display devices, enhancing the overall immersive user experience. In some examples, the array of ribbons may be integrated with a waveguide display to mitigate various forms of pupil disparity, such as pupil size, position, and/or alignment to optimize light uniformity across the viewing area. The disclosed systems and methods for improving the angular response of the array of ribbons may also include using materials responsive to visible light and compatible with fabrication processes. For example, materials such as Si3N4, Al2O3, and TiO2 may be chosen for their ability to be deposited in thin layers and for their responsiveness in the visible light spectrum. Additionally, the metasurface structures may be fine-tuned for specific wavelengths and resonant conditions, allowing for better control over light reflection and reducing interference patterns that could degrade image quality.

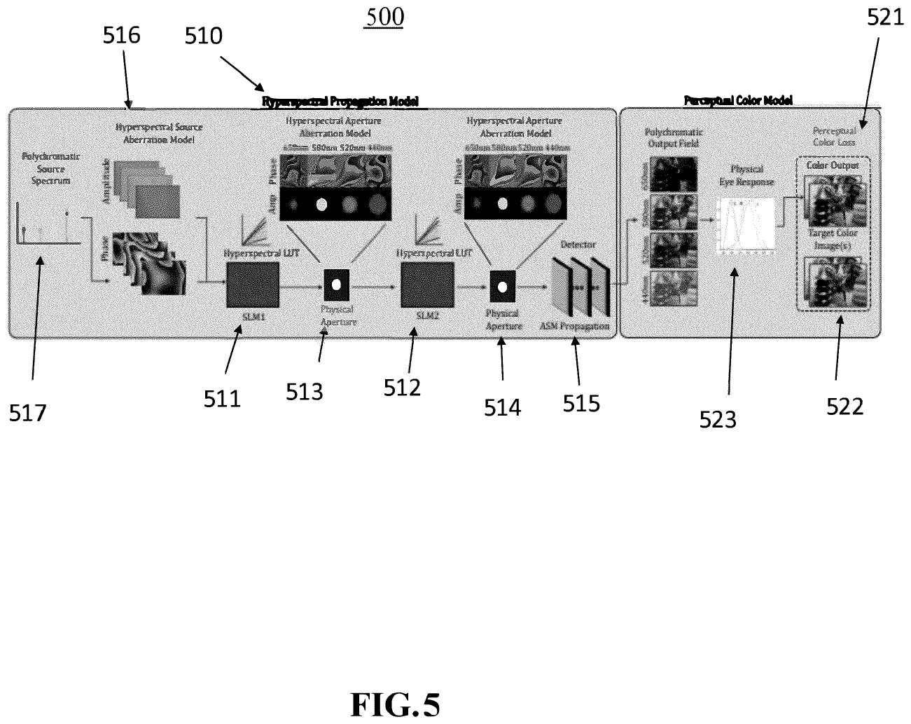

Experimentation has revealed that the disclosed holographic image speckle reduction method advances speckle reduction technology by reducing speckle while broadening the achievable color gamut compared to 3-color primary holographic displays. When combined with orthogonally related speckle reduction techniques, the disclosed holographic image speckle reduction method may further improve image quality. FIG. 5 illustrates an example wavelength multiplexing framework 500. A hyperspectral propagation model 510 may be used to generate polychromatic image data cubes that may be converted to 3-channel Red-Green-Blue (RGB) images using perceptual eye response curves and compared to targets using a perceptual color loss 521. The hyperspectral propagation model 510 may begin with a polychromatic source spectrum 517 that may be used to sample a hyperspectral source aberration model 516 with N-discrete wavelengths, generating a polychromatic field with wavelength-dependent amplitude and phase. These may be processed through spatial light modulators (e.g., SLM 511 and SLM 512) with hyperspectral lookup tables (LUT) that are sampled to create a complex polychromatic aperture (e.g., physical aperture 513 or physical aperture 514) to represent frequency domain aberrations. The polychromatic output field may then be measured on a detector 515 after applying angular spectrum propagation operator (ASM) propagation to simulate focal stack capture with a translation stage. The perceptual response may incorporate spectral weighting based on the physical eye response 523 and perform a differentiable color transformation (e.g., XYZ to sRGB) before mean-squared error (MSE) loss is computed.

The disclosed holographic image speckle reduction method may integrate a hyperspectral propagation model 510 with a perceptual eye response function, addressing color losses and reducing speckle noise through wavelength multiplexing and complementing multisource illumination techniques. The disclosed subject matter may employ perceptually correct color loss functions and polychromatic illumination for more accurate color representation in holographic displays.

The disclosed holographic image speckle reduction model may include a wavelength dependent, differentiable, hyperspectral hologram model that supports camera-in-the-loop calibration. The disclosed subject matter may extend to the wavelength continuous forward model, capturing the complete light propagation cycle through dual SLMs, including wavelength-specific aberrations. Perceptual loss functions may be utilized to enhance the representation of colors as perceived by human vision by incorporating perceptual color-weighting functions into the optimization routines.

A polychromatic source model may be denoted with λi representing the i-th wavelength selected from the polychromatic source, where i∈{1, 2, . . . , Nλ} and Nλ is the total number of wavelengths. The 2D complex field representation of the source-field that illuminates the first SLM 511 with the i-th wavelength can be written as:

$$s \{ x , λ i ) = ej ( x \cdot mi ) , \qquad ( 1 )$$

where x represents the 2D spatial coordinates on the SLM plane and mi is the wavelength-dependent phase slope (in radians per meter) of the i-th wavelength at the SLM plane. For an ideal, collimated system there is little chromatic dispersion, and therefore mi is typically close to 0.

Each pixel of a spatial-light-modulator (such as SLM 511 or SLM 512) may have a wavelength dependent phase-retardation function that maps a grayscale level to the corresponding phase-delay. A wavelength dependent Look-up-Table LUT (g; λ) may be defined, which maps a bit-level value g to the corresponding phase-shift. The LUT may be an idealized model that may not take into account chromatic dispersion in the SLM 511. This model may be accurate for a phase light modulator (PLM) system, but other systems using LCOS SLMs may use an updated model that incorporates chromatic dispersion. The grayscale value at each spatial location x on the SLM 511 may be denoted as g(x). For some situations, quantization may be discounted so that g(x)∈R, while in other situations with 4-bit PLMs g(x)∈{0, . . . , 15}. The phase-shift φk and diffracted field pk induced by the SLM at a given wavelength λi can thus be expressed using the LUT as follows:

$$ϕ k ( x , λ i ) = LUT ( g ( x ) , λ i ) , \qquad ( 2 )$$

$$pk ( x , λ i ) = ei ϕ k ( x , λ i ) \qquad ( 3 )$$

The LUT may be modeled as a linearly separable function of the grayscale value g(x) and the wavelength λi. This may be expressed as:

$$ϕ k ( x , λ i ) = α ( λ i ) \cdot g ( x ) \qquad ( 4 )$$

where α(λi) is wavelength dependent scale factor. The model 510 may ignore chromatic dispersion so that the scale factor is proportional to wavelengths and α(λi)=k·λi, where k is a constant. In some implementations, the values α (λi) may be learned for a set of anchor wavelengths using model training.

The propagation from SLM 511 to SLM 512 may be modeled using the ASM. The propagation over a fixed distance Δz may be expressed as:

$${𝒫}_{Δ z , {λ}_{i}} ( {p}_{1} ( x ; {λ}_{i} ) \cdot s ( x , {λ}_{i} ) ) \qquad ( 5 )$$

Here, PΔz,λ denotes the ASM propagation operator, Δz is the fixed distance between the two SLMs (511 and 512), and p1 (x; λi)·s(x, λi) may represent the initial complex field after SLM 511 was applied. The ASM propagation operator for a given wavelength λ, propagation distance z, and a complex field f (x) may be defined as:

$${𝒫}_{z , λ} \{ f ( x ) \} = {ℱ}^{- 1} \{ ℱ \{ f ( x ) \} \cdot {ℋ}_{z , λ} ( u ) \} , \qquad ( 6 )$$

$${ℋ}_{z , λ} ( u ) = \{ \begin{matrix}exp ( \frac{2 π jz}{λ} \sqrt{1 - {‖ λ u ‖}^{2}} ) , & if \sqrt{{‖ u ‖}^{2}} < \frac{1}{λ} , \\ 0 , & otherwise .\end{matrix} \qquad ( 7 )$$

Here, F {·} is the 2D Fourier transform operator and u is the 2D coordinate in frequency space. The intensity at the sensor plane located at propagation distance z from SLM 512 may be expressed as:

$${I}^{m} ( x , z ; {λ}_{í} ) = {\vert {𝒫}_{z , {λ}_{i}} ( {𝒫}_{Δ z , {λ}_{i}} ( {p}_{1} ( x , {λ}_{i} ) \cdot s ( x , {λ}_{i} ) ) \cdot {p}_{2} ( x , {λ}_{i} ) ) \vert}^{2} . \qquad ( 8 )$$

The laser amplitude, αi, controls the intensity for laser wavelength λi. When computing the hologram, αi may be optimized, as the optimal weighting between the wavelengths may not be known a priori. The overall signal intensity measured at a specific wavelength for a given laser power may be defined as:

$$I ( x , z ; {λ}_{i} , {a}_{i} , g ) = {a}_{i} \cdot {I}^{m} ( x , z ; {λ}_{i} , g ) , \qquad ( 9 )$$

where dependence on the two SLM (e.g., SLM 511 and SLM 512) patterns used in the disclosed holographic image speckle reduction method setups has been denoted, g=(g1 (x), g2(x)).

In an ideal optical setup, aberrations are typically negligible, and the dependence on the wavelength is minimal. However, some setups may exhibit significant aberrations which necessitate calibration. In holographic and computational imaging prototypes, apertures (e.g., physical aperture 513 and physical aperture 514) may be used strategically to manage higher-order aberrations and block unwanted direct current (DC) components. The effect of each wavelength passing through the aperture (e.g., physical aperture 513 and physical aperture 514) differs due to variations in the spatial frequency cut-off. This phenomenon may be precisely modeled, as depicted in FIG. 5.

The wavelength-dependent spatial frequency cutoff may be modeled by incorporating an aperture (e.g., physical aperture 514) into the ASM. The modified propagation operator Pz that includes the physical aperture 514 is defined as follows:

$${𝒫}_{z , λ} \{ f ( x ) \} = {ℱ}^{- 1} \{ ℱ \{ f ( x ) \} ⊙ {ℋ}_{z , λ} ( u ) ⊙ 𝒜 ( u , λ ) \} , \qquad ( 10 )$$

where A (u, λ) ensures that the propagation model accounts for the impact of the physical aperture 514 on different wavelengths. In the general case, A (u, λ) may denote a complex pupil function, P (u, λ), which encapsulates both the amplitude transmission and the optical path difference (OPD) effects:

$$𝒜 ( u , λ ) = 𝒯 ( u , λ ) \cdot {e}^{i \cdot \frac{2 π}{λ} OPD ( u , λ )} , \qquad ( 11 )$$

where T (u, λ) represents the amplitude function and OPD(u, λ) is the optical path difference across the physical aperture 514 for different wavelengths. The disclosed simulation method may assume P (u, λ)=1, while the exact form of the aberration function for the disclosed system may not be known a-priori and may be learned via the training procedure outlined below.

To accurately represent the perceived colors of a polychromatic hologram, it may be significant to consider the human visual system's response to different wavelengths. To achieve this, the Long, Medium, and Short (LMS) response functions (e.g. physical eye response 523) of the human eye, which weigh the contribution of each wavelength based on the sensitivity of the corresponding cone cells, may first be computed. The LMS response function LMSc (λi) for a channel c∈[l,m,s] may be formulated as:

$${LMS}^{c} ( x , z ; {λ}_{i} , {a}_{i} , g ) = \int I ( x , z ; {λ}_{i} , {a}_{i} , g ) \cdot {W ( {λ}_{i} )}^{c} , d {λ}_{i} , \qquad ( 12 )$$

where W (λi)c is the LMS weighting function for channel c, the three channel model output may be defined as LMS(x, z; λi, αi, g)∈R3. This equation integrates over the product of the hologram intensity and the spectral weighting functions to obtain the LMS response for each channel. However, the LMS response may not provide an ideal color space to measure perceptual similarities for human vision. To improve perceptual accuracy, the estimated LMS response may be converted into sRGB (for narrow gamut targets) or CIE XYZ (for wide-gamut targets) color space.

The disclosed holographic image speckle reduction method may incorporate perceptual color spaces. The image in the target color space (e.g., Target color image 522) may be defined as T(x, z)∈R3 at propagation distance z. Each pixel location (x, z) in the target may include a 3-dimensional value defined in a known color space (e.g., as LMS, sRGB, CIEXYZ, CIELUV). In order to compute a loss between the model and target, the model output from LMS color space (Eq. 12) may be mapped into the target color space using a differentiable color transformation. The 3-color model output O∈R3 may be denoted in the target color space as:

$$O ( x , z ; {λ}_{i} , {a}_{i} , g ) = M [ LMS ( x , z ; {λ}_{i} , {a}_{i} , g ) ] , \qquad ( 13 )$$

where M [·] represents the differentiable color transformation from LMS to target color spaces (e.g., LMS to sRGB).

A discretized set of 2D spatial coordinates X∈{(x, y)|x∈[1, . . . , Nx], y∈[1, . . . , Ny]} and propagation distances Z∈RNz may first be defined. Vector valued representations of the model parameters may be defined as follows: each of the Ns SLM patterns for each of the Nt time frames g∈RNx·Ny·Ns·Nt, wavelength values 1∈ [symbol] ^{N}^{_{λ}}, and wavelength amplitudes a ∈ [symbol] ^{N}^{_{λ}}. The loss may then be defined as the l2 MSE-loss between the target and model output, formulating the optimization problem for the SLM pattern as:

$$\hat{s} , \hat{a} = {arg min}_{s , a} {\sum }_{x ∈ 𝕏} {\sum }_{z ∈ ℤ} {‖ O ( x , z ; s , a , l ) - T ( x , z ) ‖}_{2}^{2} , \qquad ( 14 )$$

In a variant of this loss function, the wavelengths I may also be optimized in addition to the laser amplitude of each wavelength a, as

$$\hat{s} , \hat{a} , \hat{l} = {arg min}_{s , a , l} {\sum }_{x ∈ 𝕏} {\sum }_{z ∈ ℤ} {‖ O ( x , z ; s , a , l ) - T ( x , z ) ‖}_{2}^{2} , \qquad ( 15 )$$

Note that this may be feasible in some scenarios because a laser source allows for an arbitrary choice of wavelengths. However, if a fixed array of wavelength primaries is chosen, wavelength optimization is not possible. Measurable improvements have been shown when wavelength optimization is enabled, but a freely tunable polychromatic source may be more complex than using a fixed number of wavelengths.

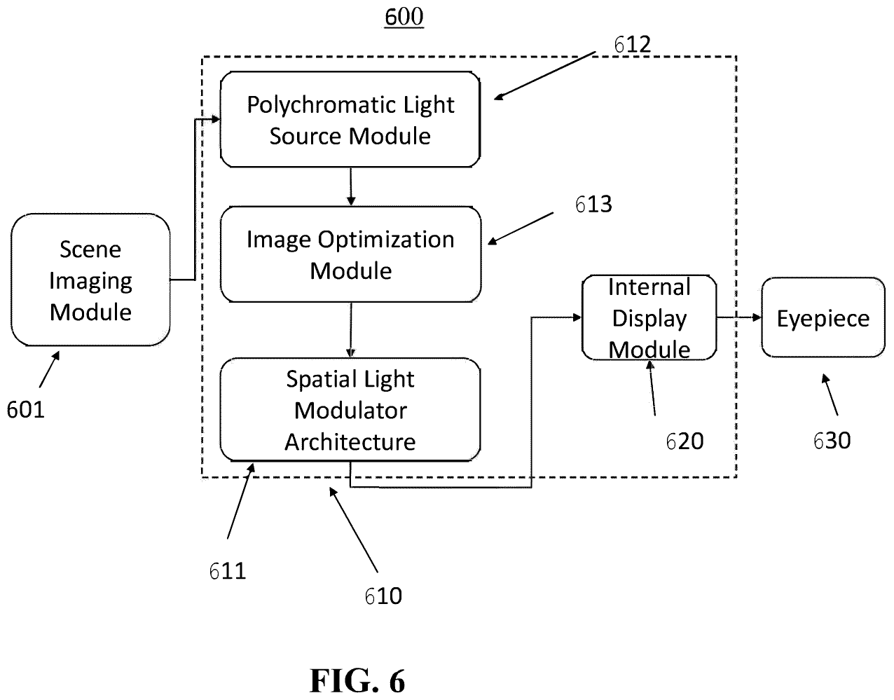

FIG. 6 illustrates an example holographic image display model 600. A module for scene imaging module (e.g., scene imaging module 601) may be used to translate a 2-dimensional or 3-dimensional scene to a holographic display model (e.g., holographic display model 610) to create a 2-dimensional or 3-dimensional hologram. A module for generating polychromatic light (e.g., polychromatic light source module 612) may be used to generate a broad spectrum of wavelengths of light to be filtered or multiplexed by an image optimization module (e.g., image optimization module 613). Polychromatic illumination may enable a significant reduction in speckle noise. A spatial light modulator architecture (e.g., spatial light modulator architecture 611) may be used to decouple speckle patterns across different wavelengths through incoherent averaging of the individual speckle patterns. In some examples of the holographic image display model, the spatial light modulator architecture may include a number of spatial light modulators with an air gap in between the spatial light modulators. FIG. 5 provides an example implementation that includes two spatial light modulators (e.g., SLM 511 and SLM 512). In other examples, the spatial light modulator architecture may include one spatial light modulator.

An internal display module (e.g., internal display module 620) may be used to transfer the holographic image from the spatial light module to a system of displays. In some examples, the internal display module may include relay optics and a number of displays. In an example that includes two displays, the image may be transferred to one display to a second display via relay optics. Following the second display, the holographic image may be transferred to an eyepiece (e.g., eyepiece 630).

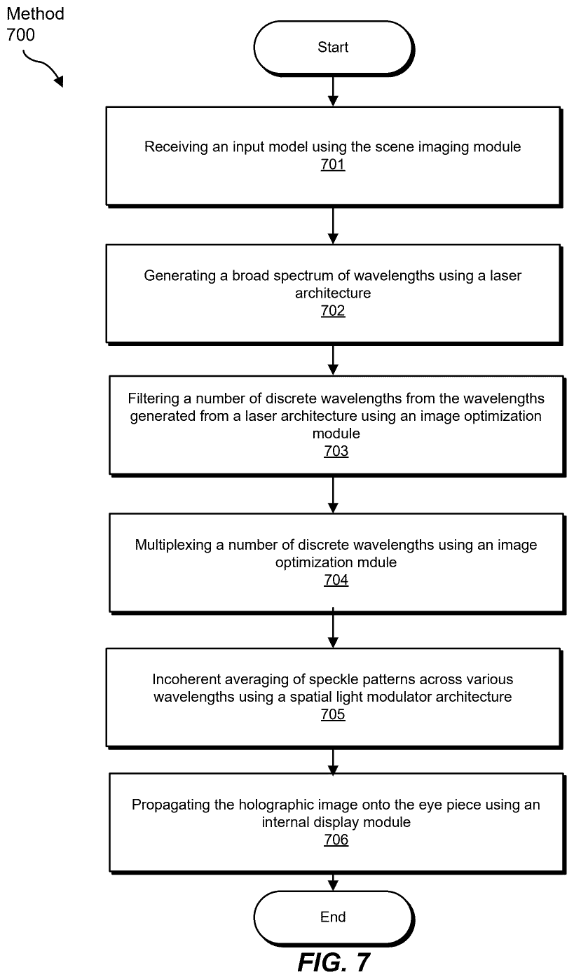

FIG. 7 illustrates an example method 700 for holographic image speckle reduction as disclosed herein. At step 701, an input model may be received at the scene imaging module 601.

At step 702, the polychromatic light source module 612 may generate a broad spectrum of light using a laser architecture. The laser architecture may be configured to generate a set of polychromatic, spatially coherent wavefronts. It is also contemplated that the laser architecture may include one or more lasers. At step 703, an image optimization module 613 may be used to filter a number of discrete wavelengths from the wavelengths generated from the laser architecture. The image optimization module may be configured to optimize for the wavelengths or intensity of light emitted from the laser architecture.

At step 704 the image optimization module 613 may be used to multiplex a number of discrete wavelengths emitted from the laser architecture. At step 705, a spatial light modulator architecture 611 may be used for incoherent averaging of speckle patterns across various wavelengths. The spatial light modulator architecture may include a number of spatial light modulators or a number of hyperspectral lookup tables. At step 706, a holographic image may be propagated onto an eyepiece 630 using an internal display module 620. The internal display module may include a number of relay optics or a number of displays.

Methods, systems, and apparatuses with regard to holographic image speckle reduction via wavelength multiplexing are disclosed herein. A method, system, or apparatus may provide for reducing speckle in a holographic image using a holographic display model; generating a broad spectrum of light using a laser architecture; filtering and multiplexing a number of wavelengths generated from the laser architecture using an image optimization module; and incoherent averaging of speckle patterns across various wavelengths using a spatial light modulator architecture.

A method for speckle reduction in holographic images, may include: generating a broad spectrum of light using a laser architecture, wherein the laser architecture may include one or more lasers; filtering a number of discrete wavelengths using an image optimization module; multiplexing a number of discrete wavelengths using the image optimization module; and incoherently averaging speckle patterns across various wavelengths using a spatial light modulator architecture. The laser architecture may be configured to generate a set of polychromatic, spatially coherent wavefronts. The image optimization module may be configured to optimize for the wavelengths or intensity of light emitted from the laser architecture. The spatial light modulator architecture may include a number of spatial light modulators or a number of hyperspectral lookup tables. The spatial light modulator architecture may include an air gap in between one and any subsequent spatial light modulators.

An apparatus for holographic image speckle reduction may include: a processor; a memory; a laser architecture; and a spatial light modulator architecture. The memory may include instructions that, when executed by the processor, cause the apparatus to: generate a broad spectrum of light using a laser architecture; filter a number of discrete wavelengths using an image optimization module; multiplex a number of discrete wavelengths using the image optimization module; and incoherently average speckle patterns across multiple wavelengths using a spatial light modulator architecture. The laser architecture may be configured to generate a set of polychromatic, spatially coherent wavefronts. The laser architecture may include one or more lasers. The spatial light modulator architecture may include a number of spatial light modulators or a number of hyperspectral lookup tables. The spatial light modulator architecture may include an air gap in between one and any subsequent spatial light modulators.

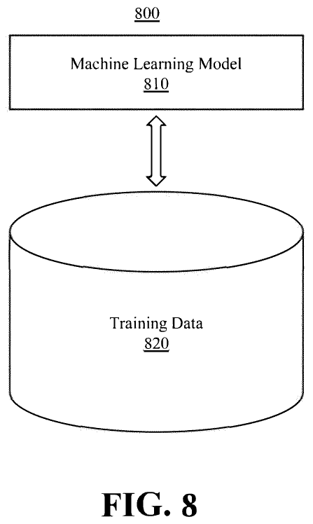

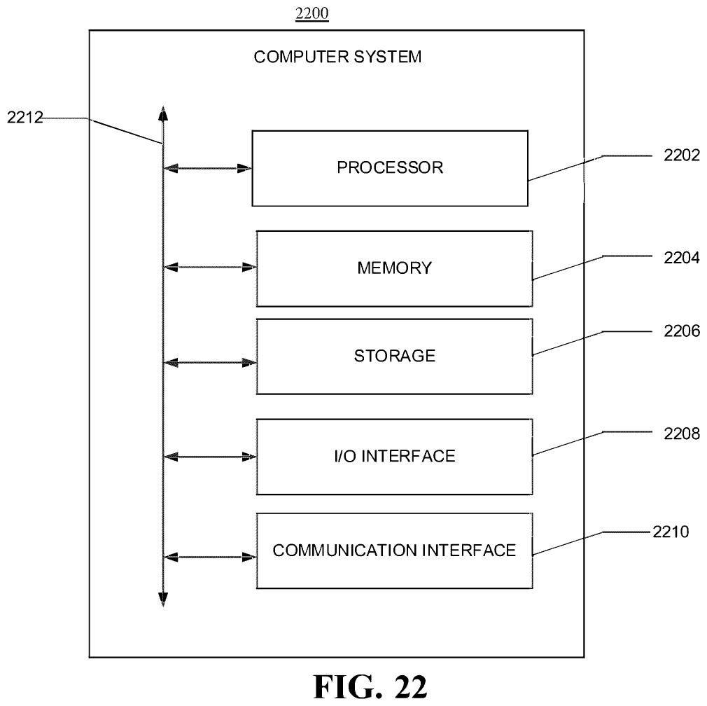

FIG. 8 illustrates a framework 800 employed by a software application (e.g., computer code, a computer program) for holographic image speckle reduction, in accordance with aspects discussed herein. The framework 800 may be hosted remotely. Alternatively, framework 800 may reside within a holographic display model and may be processed by the computing system 2200 shown in FIG. 22. Machine learning model 810 may be operably coupled with the stored training data 820 in a database. Machine learning (ML) and AI are generally used interchangeably herein.

In an example, the training data 820 may include attributes of thousands of objects. For example, the object(s) may be identified or associated with user profiles, posts, photographs/images, videos, augmented reality data, sensor data (e.g., capacitive based sensors, magnetic based sensors, resistive based sensors, pressure-based sensors, or audio-based sensors), or the like. The training data 820 employed by machine learning model 810 may be fixed or updated periodically. Alternatively, training data 820 may be updated in real-time or near real-time based upon the evaluations performed by machine learning model 810 in a non-training mode.

In operation, the machine learning model 810 may evaluate attributes of images, audio, videos, capacitance, resistance, or other information obtained by hardware (e.g., sensors, peripherals, etc.). For example, aspects of a user profile, posts, images, resistance, capacitance, audio, pressures, size, shape, orientation, position of an object and the like may be ingested and analyzed. The attributes of any of the above may then be compared with respective attributes of stored training data 820 (e.g., prestored objects). The likelihood of similarity between each of the obtained attributes and the stored training data 820 (e.g., prestored objects) may be given a determined confidence score. In one example, if the confidence score exceeds a predetermined threshold, the attribute is included in an instruction that is ultimately communicated, which may be to a user via a user interface of a computing device (e.g., computing system 2200). The sensitivity of sharing more or less attributes may be customized based upon the needs of the particular device.

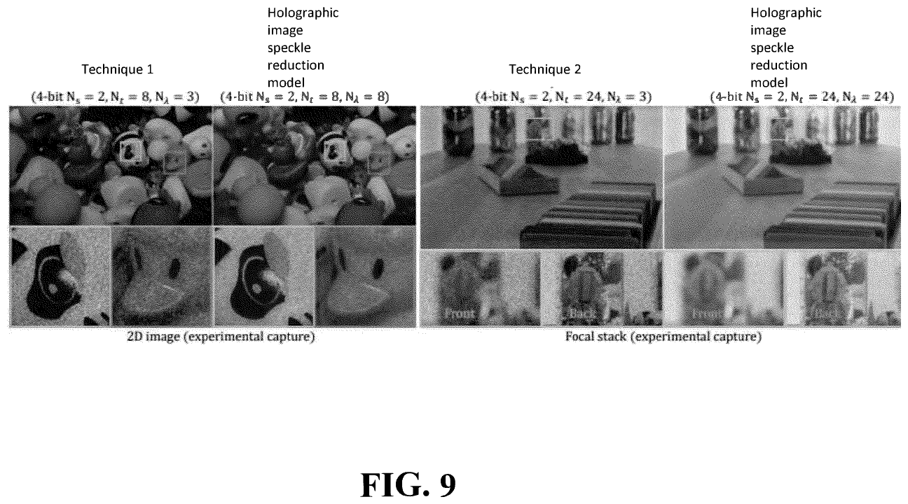

FIG. 9 illustrates the speckle reduction on both 2-dimensional images and 3-dimensional focal stacks with natural looking defocus cues using the disclosed holographic image speckle reduction method. Instead of illuminating the SLM with three wavelengths, the disclosed holographic image speckle reduction method may multiplex polychromatic illumination, which may incoherently average at the detector plane. Incoherent refers to the different wavelengths of light not having a fixed phase relationship with each other. When these various wavelengths reach the detector plane, they combine in a way that their intensities (not their amplitudes) add together. This is in contrast to coherent light, where the phases of the waves are related and can interfere constructively or destructively. Multiple spatial light modulators may be used with an air gap in between. The disclosed technique may break speckle correlations between wavelengths, enabling high-resolution holograms with significantly suppresses speckle noise.

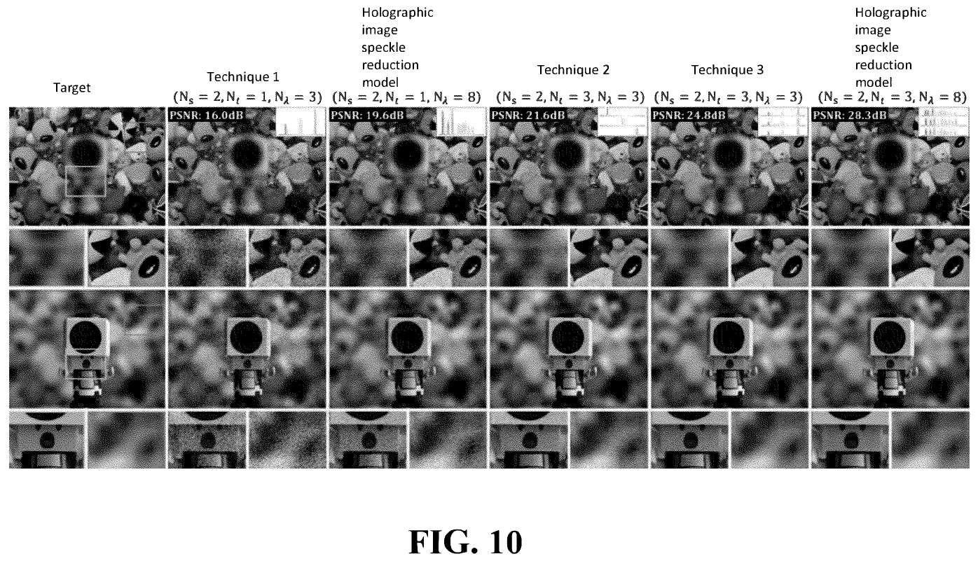

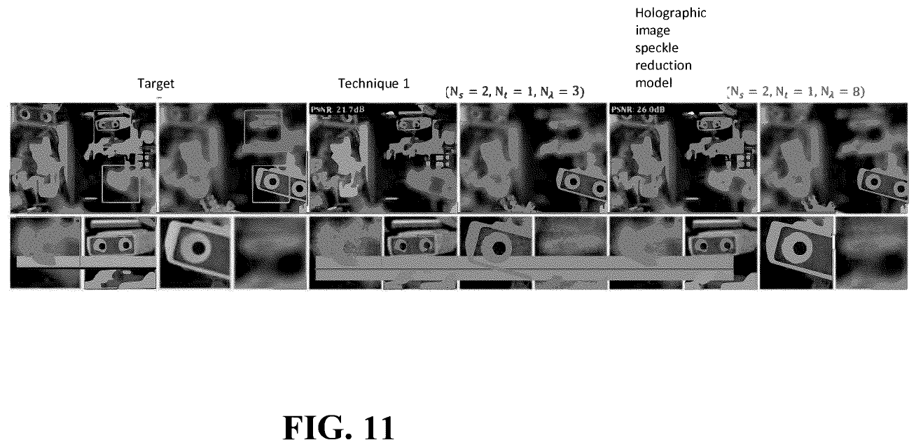

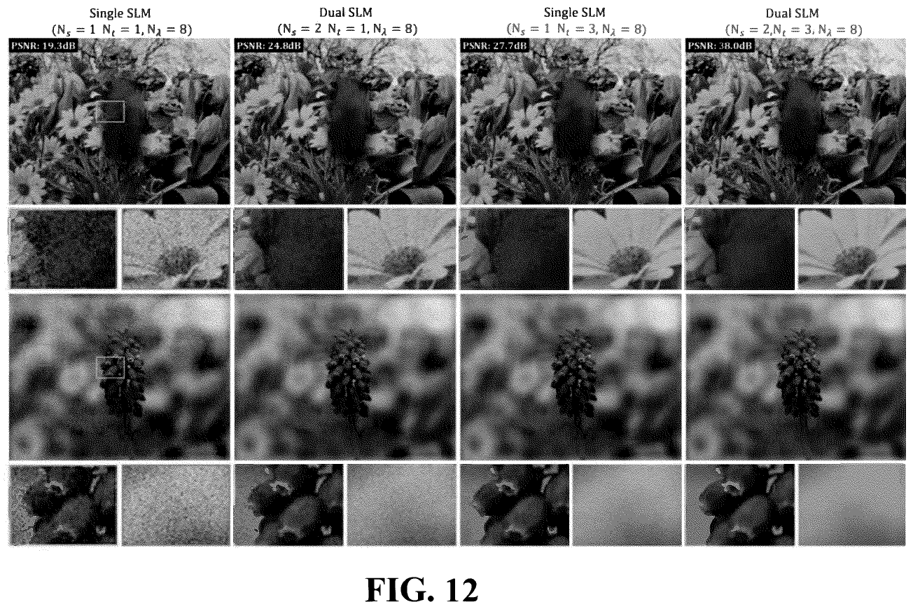

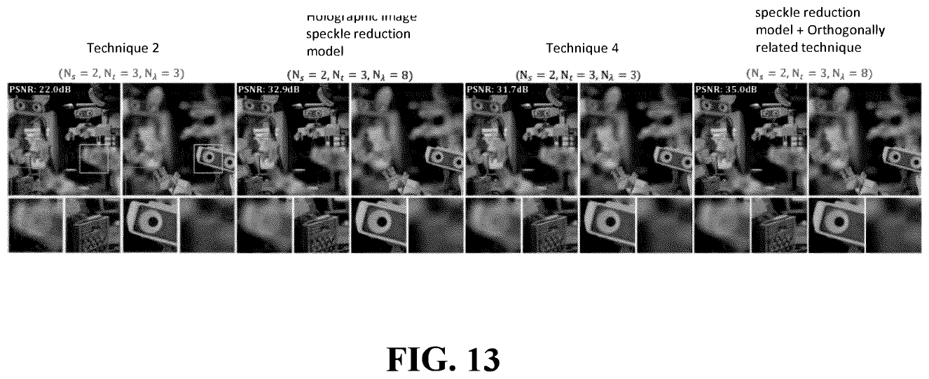

The choice of color space used inside the loss-function may have a significant influence on speckle. For instance, performing hologram optimization in the sRGB space may place a higher emphasis on a narrow gamut of color values, while the CIEXYZ space can enforce accurate color representation over a wider gamut. FIG. 10, FIG. 11, FIG. 12, or FIG. 13 may illustrate focal stack simulations where an sRGB loss was used. In those cases, speckle was reduced and the best Peak Signal-to-Noise Ratio (PSNR) was produced.

FIG. 10 illustrates a comparison of the disclosed holographic image speckle reduction method with conventional holography methods. The disclosed method shows significant performance gains in speckle reduction compared to conventional methods. The figure shows example results of the disclosed holographic image speckle reduction method and other holographic methods. The disclosed holographic image speckle reduction method, in single-frame and three-frame configurations, may achieve higher PSNR, with the three-frame disclosed holographic image speckle reduction method providing over a 6 dB improvement compared to conventional technique 2. Despeckled results are evident in the insets. Illumination spectra are shown in the top right of each column.

FIG. 11 illustrates a comparison of image quality with varying wavelengths for a single SLM frame. The first column shows the target focal stack. The second column shows technique 1's result with 3 wavelengths optimized in a single frame, producing a PSNR of 21.7 dB. The third column shows a result with 8 wavelengths from the disclosed subject matter, resulting in a PSNR of 26.0 dB. The results demonstrate that the disclosed holographic image speckle reduction method effectively reduces speckle noise in single frame, with more wavelengths yielding better image quality and more accurate color.

FIG. 12 illustrates a comparison of speckle reduction with the use of one SLM vs. two SLMs. The use of a dual SLM configuration effectively mitigates the wavelength-dependent memory effect. The figure compares single-SLM and dual-SLM setups in single-frame and three-frame configurations. The dual-SLM approach shows a clear reduction in speckle noise, with PSNR values indicating significant performance gains. In the three-frame configuration, the dual-SLM setup achieves near-perfect image reconstruction.

FIG. 13 illustrates a comparison of the disclosed subject matter with conventional speckle reduction methods for speckle reduction. The mean PSNR may be reported for each example over the full focal stack. The focal stacks correspond to different techniques, such as technique 2, the disclosed holographic image speckle reduction method, technique 4, and a combination of the disclosed holographic image speckle reduction method and technique 4. The combination of methods may further improve the PSNR, indicating a synergistic effect.

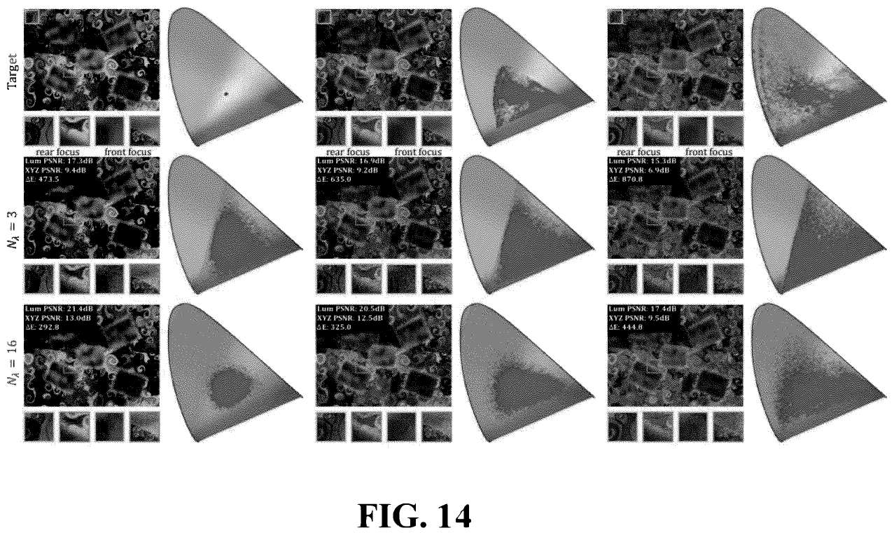

FIG. 14 illustrates the disclosed holographic image speckle reduction method PSNR and the resulting color gamut. The disclosed method may use the CIEXYZ loss which may produce higher quality color reproduction, at the cost of some loss in speckle reduction. Examples in the figure may use a single frame dual SLM setup (Ns=2, Nt=1). FIG. 14 illustrates example tradeoffs between wide color gamut and speckle reduction offered by the disclosed holographic image speckle reduction method. The first row shows the targets with increasingly wide color gamut, from left to right. The second and third rows show the reconstructed images for Nλ=3 and Nλ=16 wavelengths, respectively, with varying PSNR values for luminance (Lum PSNR) and XYZ color space (XYZ PSNR), along with color difference (ΔE). There may be a balance between achieving a wide color gamut and reducing speckle noise, with higher numbers of wavelengths providing better speckle reduction at the cost of gamut size.

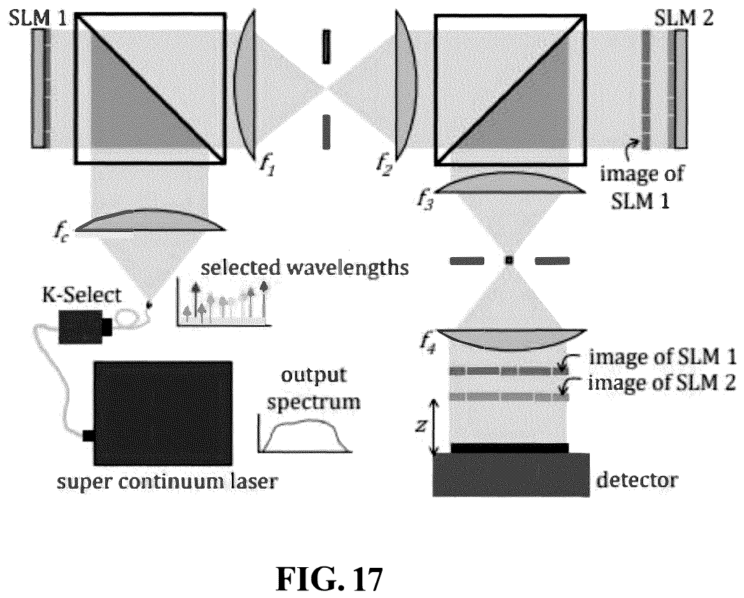

FIG. 17 illustrates an example schematic of a setup of a holographic image model. This example may use two SLMs. A 4f system may be in between the two SLMs. A second 4f may be used to relay the SLMs to the correct positions in front of a bare sensor, which may be mounted on a linear motion stage. Irises may be in the Fourier planes and may block the DC component. A NKT super continuum laser may be used for illumination, allowing center wavelength to be tuned anywhere in the visible spectrum.

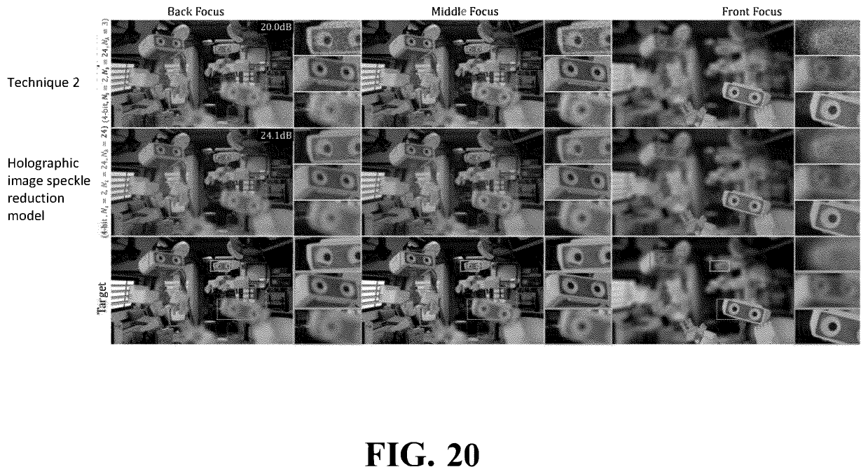

FIG. 20 illustrates an example comparison of focal stacks between holography models. Focal stacks created using technique 1 may suffer from speckle noise since there may be insufficient degrees of freedom on the SLM to control speckle throughout a 3D volume. The disclosed holographic image speckle reduction method may reduce speckle, enabling focal stacks with natural defocus cues. In an example, the disclosed holographic image speckle reduction method may increase PSNR by 4.1 dB.

FIG. 22 illustrates an example computer system 2200. One or more computer systems 2200 perform one or more steps of one or more methods described or illustrated herein. In examples, software running on one or more computer systems 2200 performs one or more steps of one or more methods described or illustrated herein or provides functionality described or illustrated herein. Examples include one or more portions of one or more computer systems 2200. Herein, reference to a computer system may encompass a computing device, and vice versa, where appropriate. Moreover, reference to a computer system may encompass one or more computer systems, where appropriate.

The computer system 2200 includes a processor 2202 and memory 2204. The memory 2204 stores instructions that, when executed by the processor 2202, cause the computer system 2200 to implement the image editing functionality described herein. The computer system 2200 may be communicatively connected with an eyepiece 630.

This disclosure contemplates any suitable number of computer systems 2200. This disclosure contemplates computer system 2200 taking any suitable physical form. As example and not by way of limitation, computer system 2200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2200 may include one or more computer systems 2200; be unitary or distributed; span multiple locations; span multiple machines; span multiple data centers; or reside in a cloud, which may include one or more cloud components in one or more networks. Where appropriate, one or more computer systems 2200 may perform without substantial spatial or temporal limitation one or more steps of one or more methods described or illustrated herein. As an example, and not by way of limitation, one or more computer systems 2200 may perform in real time or in batch mode one or more steps of one or more methods described or illustrated herein. One or more computer systems 2200 may perform at different times or at different locations one or more steps of one or more methods described or illustrated herein, where appropriate.

In examples, computer system 2200 includes a processor 2202, memory 2204, storage 2206, an input/output (I/O) interface 2208, a communication interface 2210, and a bus 2212 (e.g., communication bus). Although this disclosure describes and illustrates a particular computer system having a particular number of particular components in a particular arrangement, this disclosure contemplates any suitable computer system having any suitable number of any suitable components in any suitable arrangement.

In examples, processor 2202 includes hardware for executing instructions, such as those making up a computer program. As an example and not by way of limitation, to execute instructions, processor 2202 may retrieve (or fetch) the instructions from an internal register, an internal cache, memory 2204, or storage 2206; decode and execute them; and then write one or more results to an internal register, an internal cache, memory 2204, or storage 2206. In particular embodiments, processor 2202 may include one or more internal caches for data, instructions, or addresses. This disclosure contemplates processor 2202 including any suitable number of any suitable internal caches, where appropriate. As an example, and not by way of limitation, processor 2202 may include one or more instruction caches, one or more data caches, and one or more translation lookaside buffers (TLBs). Instructions in the instruction caches may be copies of instructions in memory 2204 or storage 2206, and the instruction caches may speed up retrieval of those instructions by processor 2202. Data in the data caches may be copies of data in memory 2204 or storage 2206 for instructions executing at processor 2202 to operate on; the results of previous instructions executed at processor 2202 for access by subsequent instructions executing at processor 2202 or for writing to memory 2204 or storage 2206; or other suitable data. The data caches may speed up read or write operations by processor 2202. The TLBs may speed up virtual-address translation for processor 2202. In particular embodiments, processor 2202 may include one or more internal registers for data, instructions, or addresses. This disclosure contemplates processor 2202 including any suitable number of any suitable internal registers, where appropriate. Where appropriate, processor 2202 may include one or more arithmetic logic units (ALUs); be a multi-core processor; or include one or more processors 2202. Although this disclosure describes and illustrates a particular processor, this disclosure contemplates any suitable processor.

In examples, memory 2204 includes main memory for storing instructions for processor 2202 to execute or data for processor 2202 to operate on. As an example, and not by way of limitation, computer system 2200 may load instructions from storage 2206 or another source (such as, for example, another computer system 2200) to memory 2204. Processor 2202 may then load the instructions from memory 2204 to an internal register or internal cache. To execute the instructions, processor 2202 may retrieve the instructions from the internal register or internal cache and decode them. During or after execution of the instructions, processor 2202 may write one or more results (which may be intermediate or final results) to the internal register or internal cache. Processor 2202 may then write one or more of those results to memory 2204. In particular embodiments, processor 2202 executes only instructions in one or more internal registers or internal caches or in memory 2204 (as opposed to storage 2206 or elsewhere) and operates only on data in one or more internal registers or internal caches or in memory 2204 (as opposed to storage 2206 or elsewhere). One or more memory buses (which may each include an address bus and a data bus) may couple processor 2202 to memory 2204. Bus 2212 may include one or more memory buses, as described below. In examples, one or more memory management units (MMUs) reside between processor 2202 and memory 2204 and facilitate accesses to memory 2204 requested by processor 2202. In particular embodiments, memory 2204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2204 may include one or more memories 2204, where appropriate. Although this disclosure describes and illustrates particular memory, this disclosure contemplates any suitable memory.

In examples, storage 2206 includes mass storage for data or instructions. As an example, and not by way of limitation, storage 2206 may include a hard disk drive (HDD), a floppy disk drive, flash memory, an optical disc, a magneto-optical disc, magnetic tape, or a Universal Serial Bus (USB) drive or a combination of two or more of these. Storage 2206 may include removable or non-removable (or fixed) media, where appropriate. Storage 2206 may be internal or external to computer system 2200, where appropriate. In examples, storage 2206 is non-volatile, solid-state memory. In particular embodiments, storage 2206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2206 taking any suitable physical form. Storage 2206 may include one or more storage control units facilitating communication between processor 2202 and storage 2206, where appropriate. Where appropriate, storage 2206 may include one or more storages 2206. Although this disclosure describes and illustrates particular storage, this disclosure contemplates any suitable storage.

In examples, I/O interface 2208 includes hardware, software, or both, providing one or more interfaces for communication between computer system 2200 and one or more I/O devices. Computer system 2200 may include one or more of these I/O devices, where appropriate. One or more of these I/O devices may enable communication between a person and computer system 2200. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2208 for them. Where appropriate, I/O interface 2208 may include one or more device or software drivers enabling processor 2202 to drive one or more of these I/O devices. I/O interface 2208 may include one or more I/O interfaces 2208, where appropriate. Although this disclosure describes and illustrates a particular I/O interface, this disclosure contemplates any suitable I/O interface.

In examples, communication interface 2210 includes hardware, software, or both providing one or more interfaces for communication (such as, for example, packet-based communication) between computer system 2200 and one or more other computer systems 2200 or one or more networks. As an example, and not by way of limitation, communication interface 2210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2210 for it. As an example, and not by way of limitation, computer system 2200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2200 may include any suitable communication interface 2210 for any of these networks, where appropriate. Communication interface 2210 may include one or more communication interfaces 2210, where appropriate. Although this disclosure describes and illustrates a particular communication interface, this disclosure contemplates any suitable communication interface.

In particular embodiments, bus 2212 includes hardware, software, or both coupling components of computer system 2200 to each other. As an example and not by way of limitation, bus 2212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2212 may include one or more buses 2212, where appropriate. Although this disclosure describes and illustrates a particular bus, this disclosure contemplates any suitable bus or interconnect.

The disclosed holographic image speckle reduction method utilizes an ultrafast, wavelength-adjustable laser and a dual Spatial Light Modulator (SLM) architecture, enabling the multiplexing of a large set of discrete wavelengths over the visible spectrum. The spatial separation in a dual-SLM setup may allow for the independent manipulation of speckle patterns across a diversity of wavelengths. This results in a novel and effective technique for speckle reduction through incoherent averaging via wavelength multiplexing, an approach that is orthogonal to existing speckle reduction methods. Furthermore, the use of polychromatic illumination may broaden the achievable color gamut compared to 3-color primary holographic displays.

Research on wavelength multiplexing marks a clear advancement towards the realization of high-fidelity, immersive holographic displays, paving the way for the next generation of near-eye displays.

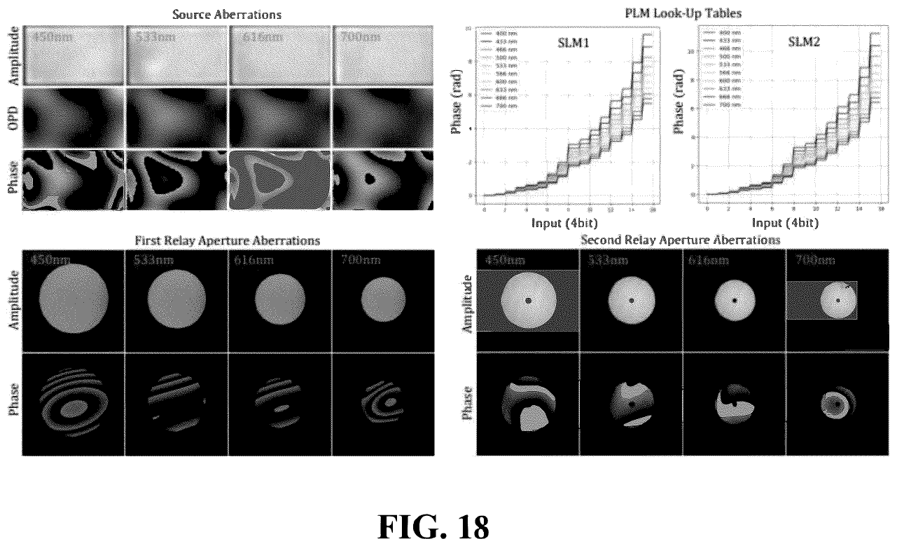

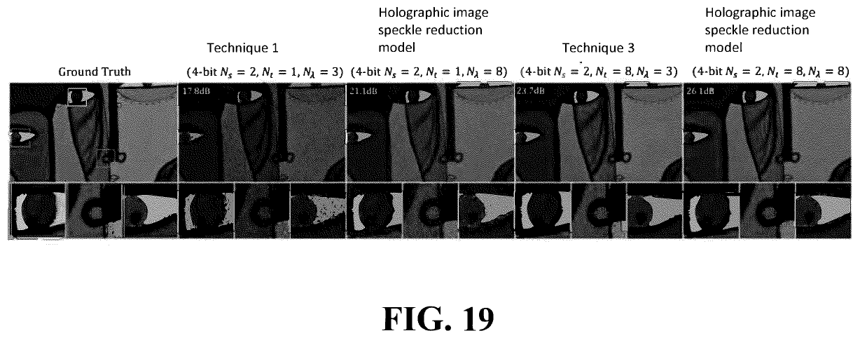

The disclosed subject matter develops differentiable computer-generated holography (CGH) optimization routines similar to state-of-the-art holography displays and may incorporate arbitrary source spectral profiles and perceptually motivated color response functions together with hardware constraints on SLM speed and resolution (see FIG. 5). Differentiable hyperspectral hologram model may be learned (see FIG. 18) and shown through extensive simulations (FIG. 10, FIG. 11, FIG. 12, FIG. 13, or FIG. 14) and examples (FIG. 9, FIG. 19, or FIG. 18) that polychromatic illumination can significantly reduce speckle noise when compared to holographic displays generated using technique 2 that may only illuminate with one narrowband laser source at a time. Polychromatic illumination may reduce speckle noise by as much as 5-6 dB in simulation and 3-4 dB in experiment, relative to time-sequential RGB color holography architectures.

The disclosed technique may include a polychromatic holographic display system that may reduce speckle noise in a manner complimentary to existing speckle reduction techniques (e.g. time multiplexing, Multisource, partial coherence). Furthermore, the disclosed system has the added advantage of increasing the color gamut relative to existing three-laser RGB architectures. The disclosed holographic image speckle reduction system may utilize an ultrafast, wavelength-tunable laser source to generate a set of independent polychromatic, spatially coherent wavefronts. The disclosed technique may incoherently multiplex the images created from these discrete wavelengths, which may be integrated due to the finite response time of the retina. The disclosed holographic image speckle reduction technique may treat the polychromatic illumination wavelengths λi,i∈{1, . . . , Nλ} as trainable parameters that can be optimized on a per-scene basis because the choice of wavelengths has a strong effect on the speckle contrast and color fidelity of displayed images. When the polychromatic wavelengths are spread far enough from each other along the visible spectrum, they each produce sufficiently decorrelated speckle patterns. Since the speckle fields produced by each wavelength are mutually incoherent, they do not interfere, and their intensities simply average to reduce speckle contrast. Furthermore, a dual-SLM architecture may be utilized for near-eye displays. The disclosed technique may demonstrate that the dual-SLM architecture helps decorrelate wavelength-dependent speckle fields in a manner similar to Multisource architectures, breaking the “memory effect” and enabling effective speckle reduction through incoherent averaging.

The disclosed subject matter may be associated with the following subjects: (1) Polychromatic illumination; (2) dual-SLM architecture; (3) Polychromatic simulation framework; (4) hyperspectral calibration; or (5) Experimental validation. Subject (1) may involve using a super-continuum laser may to generate a broad spectrum of wavelengths, from which a large number of discrete wavelengths may be selectively filtered and multiplexed. This polychromatic illumination may enable a significant reduction in speckle noise. Subject (2) may enable speckle patterns to be decoupled across different wavelengths by implementing some spatial separation between two SLMs. Subject (3) may model key aspects of the optical system, wavelength selection, speckle reduction, and color gamut analysis, as well as perceptual loss. The framework may enable the optimization of display performance given a set of hardware constraints. Subject (4) may involve a calibration method that calibrates a holographic system for every wavelength in the visible spectrum using just a few learnable parameters. Subject (5) may involve the demonstration that the disclosed technique results in significant improvements in color reproduction and speckle contrast compared to conventional holographic displays.

To mitigate speckle noise in holographic displays, several approaches have been explored, each with its own advantages and limitations. Many of such approaches may be limited to minimizing speckle only from particular viewing angles, produce low-quality holographic images, or require specialized components that limit image quality in aspect other than speckle.

The disclosed method may be combined with other speckle reduction techniques (see FIG. 13). This disclosed subject matter may offer an orthogonal speckle reduction method that may leverage wavelength diversity to achieve independent speckle patterns. The disclosed method may combine the advantages of wavelength multiplexing and a dual-SLM design to achieve high-quality images with significantly reduced speckle noise while maintaining a reasonably large color gamut.

The use of multiple, mutually incoherent wavelengths in the disclosed system may enable effective speckle reduction through incoherent averaging. When the intensities of the wavelength-dependent speckle patterns are summed together, the resulting speckle contrast may be reduced.

The disclosed holographic image speckle reduction method may be compared against three conventional methods for creating color holograms. Techniques 1, 2, and 3 may be three examples of conventional methods of holographic image speckle reduction.

While both technique 1 and technique 3 have been demonstrated previously using smooth phase, these techniques have previously not been evaluated for random-phase holograms. In FIG. 10, the disclosed holographic image speckle reduction method is compared against these three methods. Note that while technique 1, technique 2, and technique 3 may be used with single SLM architectures, a dual-SLM architecture (Ns=2) may be used for fair comparison against the disclosed holographic image speckle reduction method. Both single-frame and three-frame reconstruction algorithms may be evaluated. For the single frame case, the disclosed holographic image speckle reduction method with Nλ=8 may perform 3.6 dB better than using just three colors. When the time budget to three frames is extended, the disclosed holographic image speckle reduction method may achieve a 6.7 dB PSNR boost over technique 1, and 3.5 dB boost over technique 3. Overall, the disclosed holographic image speckle reduction method may demonstrate significant performance gains over conventional methods, particularly in reducing speckle, thereby enhancing image quality.

The benefit of multiplexing multiple wavelengths within a single SLM frame may be illustrated. FIG. 11 demonstrates that the disclosed holographic image speckle reduction method with Nλ=16 may produce 4.3 dB improvement in speckle noise reduction relative to technique 1, which may only multiplex 3 wavelengths into a single frame. These results may demonstrate that the disclosed holographic image speckle reduction method may effectively incorporate more wavelengths with greater speckle diversity, yielding better image quality with less speckle contrast.

The disclosed subject matter may demonstrate significant performance improvements using a single SLM. However, to further mitigate the wavelength-dependent memory effect, dual-SLMs may be used, as previously detailed. FIG. 12 compares the performance of using one SLM versus two SLMs in both single-frame and time-multiplexed configurations. The dual-SLM setup may effectively break the wavelength-dependent memory effect, resulting in a noticeable reduction in speckle noise. For the single-frame configuration, the dual-SLM approach may significantly enhance image quality by 5.3 dB compared to the single-SLM case. When extending the time budget to three frames, the dual-SLM configuration may achieve near-perfect image reconstruction, as indicated by the substantial PSNR gain and the despeckled images in the insets. This improvement may underscore the advantage of utilizing multiple SLMs for holographic displays, which may lead to superior image quality and reduced speckle noise.

The disclosed subject matter is a speckle reduction method that may leverage wavelength diversity to achieve uncorrelated speckle patterns in a manner similar, yet orthogonal to the angular diversity approach used in technique 4. To demonstrate this orthogonality, the two methods are compared in FIG. 13. This comprehensive comparison highlights the effectiveness of the disclosed holographic image speckle reduction method, technique 4, and their combination in speckle reduction. Both 9 wavelength disclosed holographic image speckle reduction method and technique 4 may produce similar performance benefits over technique 2, while the two may be combined, which may produce an addition 2-3 dB performance boost.

The disclosed holographic image speckle reduction method introduces a fundamental trade-off between speckle reduction and color gamut of displayed images. On the one hand, the choice of more than 3 wavelengths introduces the possibility to display images that span a much larger color gamut. However, saturated colors near the border of the gamut cannot be reproduced with the same amount of speckle reduction as low-saturation colors in the center of the gamut. Low-saturation colors can be reproduced with the least amount of speckle noise since independent speckle patterns produced by each source wavelength can all contribute to reproduce colors in the middle of the gamut. This is not the case for highly saturated colors, where, for example, the speckle of red wavelengths cannot be used to help reduce speckle of blueish pixels.

FIG. 14 illustrates and analysis of how the image content, particularly the range of desired colors or gamut in a scene, affects different holographic display prototypes. To perform this analysis, an artificial 3D target defined in XYZ color space that encompasses colors across the entire human-visible spectrum may be created. The target may be transformed into luminance, saturation, and hue (using LCHuv representation) so that the “color gamut” of the scene can effectively be changed by scaling the saturation channel. The top row of FIG. 14 shows an image of targets with varying saturation, together with their respective xy-chromaticity plots on top of the horseshoe gamut representing human-viewable colors. In the second and third rows, these targets may be used to optimize two systems of the disclosed holographic image speckle reduction method with Nλ=3 and Nλ=16, respectively. Optimization may be performed in one time frame (Nt=1). This will naturally lead to noisy images but it may provide the fairest comparison. The following key observations have been noted: (1) Increasing the number of wavelengths may reduce speckle noise; (2) increasing the number of wavelengths may produce a more accurate perceptual color representation; and (3) increasing the number of wavelengths may enable a wide color gamut.

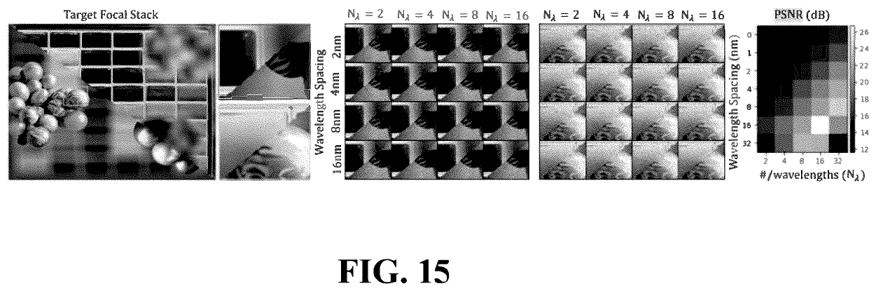

FIG. 15 illustrates an example ablation study focusing on the relationship between reduction method. In this example all wavelengths may be chosen to be fixed and evenly spaced in the center of the visible spectrum. Wavelength optimization may improve PSNR compared to fixed, uniformly spaced wavelengths spread over the visible spectrum, but the improvement may largely be content dependent and may not be greater than around 1-2 decibels (dB).

The example may provide insight into the optimal choice for source illumination spectrum with respect to speckle noise reduction. The magnitude for each wavelength may be optimized on a per-target basis. To focus on speckle reduction performance, color may be ignored, and a monochromatic target and sensor model (flat sensor response from 800 nm-2200 nm) may be used instead of color targets, LMS response curves and a perceptual color loss.

An example heatmap in FIG. 15 reveals a general trend that increasing the number of wavelengths may enhance the ability to reduce speckle, as it introduces more diversity in the wavelengths used. Similarly, for a fixed number of wavelengths, performance may increase as the wavelength spacing is increased. For this example, the optimal performance may be attained with Nλ=16 wavelengths and a spacing of 16 nm, with a bandwidth of 240 nm that covers most of the visible spectrum. However, the number of wavelengths may be increased to Nλ=32 or the spacing to 32 nm, which may cause some wavelengths to fall outside the visible spectrum, which may mitigate the effects of wavelength diversity and increasing speckle noise.

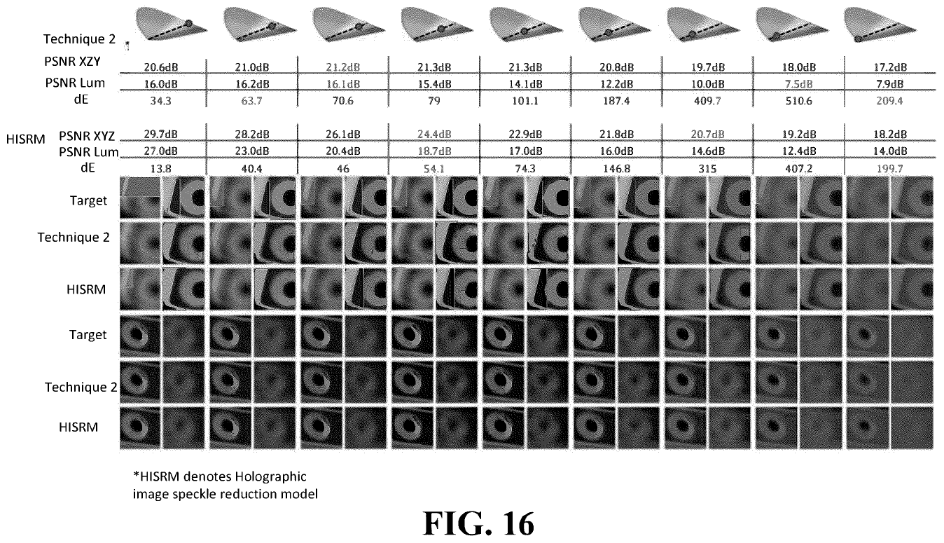

In FIG. 16, a simple example may be used to investigate the premise that wavelength multiplexing may enable greater speckle reduction compared to a time-sequential display where one wavelength is on at a given time. For this example, a mono-color (not monochromatic) focal-stack target that may vary on a linear curve in xyY-chromaticity space may be defined, where the corresponding color in the image is rendered out. 2 frames for temporal multiplexing may be allowed, as illustrated in FIG. 16. For a technique 2, the sensor may integrate over 2 frames with 1 wavelength on at a time: for each time frame, the wavelength magnitude may be optimized for a single wavelength while the other wavelength amplitude may be fixed at zero. For the disclosed holographic image speckle reduction method, the sensor may integrate over 2 frames, but now for each time frame the amplitude of both wavelengths may be optimized to the target. As a result, the final output image may integrate 4 mutually incoherent speckle fields instead of just two for technique 2. For evaluation, PSNR in XYZ and luminance (from CIE LUV) and the averaged color difference (CIE6000 ΔE) may be computed. The disclosed holographic image speckle reduction method may outperform the technique 2, providing speckle reduction and maintaining image quality, confirming that color multiplexing can be leveraged to improve imaging performance.

The disclosed holographic image speckle reduction method may reduce speckle in near-eye holographic displays. However, in practice, achieving high-quality experimental results may necessitate precise knowledge and characterization of the system parameters, such as the source amplitude and phase, SLM look up table, the relative positioning of the two SLMs, and aperture aberration functions. To calibrate the disclosed system, a design that includes a physics-inspired forward model where unknown parameters may be learned from a dataset of experimentally captured SLM-image pairs may be used.

Conventional physics-inspired calibration methods may work only for monochromatic illumination. Therefore, to display RGB images, typically three independent models may be learned. In most cases, a monochromatic image for each color channel may then be optimized with the respective model. The disclosed approach may take into account the physical response of the human eye to ensure correct color reproduction.

One example approach to implementing the disclosed holographic image speckle reduction method may be to optimize an independent model for each wavelength in the visible spectrum. However, this may demand an immense amount of captured data, training time, and storage capacity, with each model still likely to overfit the data. Given the smooth behavior of physical optics, especially concerning wavelength dependency, the wavelength dependency of each component may be directly modeled in one single hyperspectral holographic system. This approach may have several explicit benefits: it may reduce the number of learned parameters, making the disclosed calibration procedure more robust to local minima, and may allow for quicker convergence to a global solution due to lightweight parameterization. FIG. 18 illustrates an example of the learned parameters in the disclosed model. The top left section illustrates 4 of the 10 anchor wavelengths that may be utilized in the disclosed model. The disclosed method may independently learn the amplitude and Optical Path Difference (OPD). For enhanced visualization, the wrapped phase of the source field may also be presented. The top-right graph displays the learned 4-bit Look-Up Table (LUT) for both SLM1 and SLM2, which may cover wavelengths from 800 to 2200 nm. The bottom row depicts the learned amplitude and the Zernike aberrations which may correspond for four selected wavelengths for both relays. The second relay may incorporate a DC-filter term. Notice the quality of the reconstructed aperture term. Despite not imaging the aperture plane, the disclosed calibration procedure may be robust enough to reconstruct fine details in Fourier Domain even though images may be captured in spatial domain.

The polychromatic source s(x, λi) may be used as a trainable parameter in the disclosed holographic image speckle reduction models. A straightforward approach to model the hyperspectral source may be to learn a 2D complex field at Ns anchor wavelengths and then perform a 1-D linear interpolation for intermediate wavelengths during evaluation. However, it may be necessary to learn Optical Path Differences (OPD) directly at these anchor wavelengths instead of phase in order to avoid issues with phase wrapping. The wavelength-dependent OPD may be smooth, which may make it a suitable representation of our source field with a small number of parameters. In one example, the amplitude and OPD of the source field may be learned independently for each anchor wavelength. During the forward pass, 1D linear interpolation may be performed in the wavelength dimension to compute the complex field for arbitrary wavelengths.

In the disclosed model, a continuous valued phase SLM may be used with a linear LUT. In an example of the disclosed subject matter, the Phase Light Modulator (PLM) device may produce 4-bit phase modulation with a non-uniform LUT and may be used. For each PLM, the 16-bit values may be passed through a learned lookup table (LUT) which may describe the mapping from digital input to phase LUT (g; λ). The LUT may be parameterized by multiple learned coefficients (one for each possible input value). To model the quantized behavior of the SLM, a simple straight-through estimator may be utilized. To correctly model possible higher-order effects, the phase values may be upsampled by 2× to avoid any problems with Nyquist sampling that might occur inside the disclosed forward model.

To model wavelength dependence, LUT coefficients may be learned at a specific reference wavelength λref. For any other incoming field at wavelength λin, the LUT coefficient may be scaled by the ratio λref/λin. This may model the physics as the PLM mirrors move up/down, producing a wavelength independent optical path difference (OPD), and a phase modulation that may scale linearly with wavelength.

To address potential misalignment between the two SLMs at a sub-pixel level, their relative positions in the disclosed model may be considered. After the field is propagated from the first SLM, a learned warping function may be utilized to transform the field into the coordinate space of the second SLM. This warping function, which may be derived from thin-plate spline model, may compensate for any non-radial distortion between the SLMs, which may allow for precise alignment even when non-ideal relay optics are present. The warping may be executed in a differentiable manner, which may employ bilinear interpolation on both the real and imaginary components of the complex field. One transform for some or all wavelengths may be learned if SLM alignment is not expected to be wavelength dependent.

To model the OPD in the aperture aberration function A(u, λ) from Eqn. 11, the 3D function may be expanded into a separable basis consisting of a 2D Zernike basis in frequency coordinates u and a 1D polynomial in wavelength. A low dimensional model may be used for the OPD (e.g., XX Zernike coefficients and YY degree polynomial). For the amplitude component, a single tensor (typically ZZ×lower resolution than the SLM) at a reference wavelength λref may be learned. For any other incoming field at wavelength λin, the tensor may be geometrically scaled by a factor of the ratio λref/λin.

FIG. 18 bottom depicts the learned amplitude and the Zernike aberrations which may correspond for four selected anchor wavelengths and both relays. The disclosed low-dimensional aperture model may be robust and may estimate aperture aberrations with extremely high fidelity. Notice the quality of the reconstructed aperture term for the second relay. The disclosed calibration procedure may be robust enough to reconstruct fine details in the Fourier domain.

To optimize the learnable parameters of the disclosed model, a dataset that may include SLM-image pairs may be gathered. Gradient descent optimization may be employed in PyTorch to fine-tune the unknown parameters. A geometric alignment between both SLMs and the sensor may first be performed by sequentially displaying a grid of Fresnel patterns on each SLM (and zero phase on the other) to create two grid-like calibration targets on the detector plane. Once a rough alignment has been established, all model parameters, including refinement of the thin-plate spline parameters used for alignment, may be trained.

Unlike many models in previous studies, the disclosed model may not incorporate any black-box neural networks and all parameters may have a physical interpretation. This approach may reduce the number of learnable parameters, thereby requiring less training data, speeding up the optimization process, and minimizing the risk of overfitting. For instance, the disclosed model's training data set may include a number (e.g., 500) of captures over the full spectrum to be calibrated, and the training process may take a number of minutes (e.g., 5-10 minutes) on an Nvidia A6000. Additionally, even though training data may be captured at a single propagation distance z, the disclosed model may generalize well to other planes without the need for retraining.

The disclosed subject matter may present an effective method for reducing speckle noise in holographic displays while maintaining image resolution and creating focal stacks with realistic blur. Examples may show that the disclosed method may outperform conventional methods, especially in 3D content where speckle noise may be more pronounced.

The disclosed holographic image speckle reduction method may introduce a hyper-spectral modeling framework using polychromatic illumination and a dual-SLM architecture. This approach may show promise for future holographic displays by providing clear and high-quality images. The disclosed holographic image speckle reduction method may work robustly for random phase holograms that produce uniform eyebox intensity. Uniform eyebox intensity may be particularly beneficial for near-eye display applications where pupil position can vary significantly, reducing artifacts and enhancing the viewing experience.

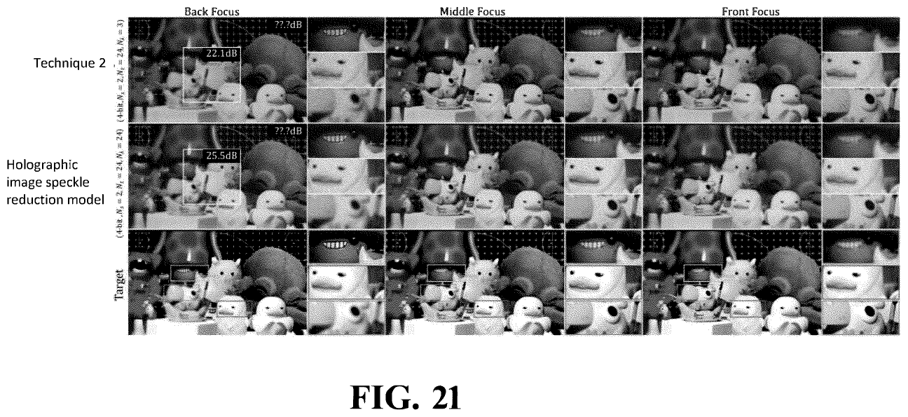

Conventional speckle reduction methods may experience a tradeoff between contrast and speckle reduction that can be achieved with the method: a larger number of sources may increase speckle reduction at the cost of decreased contrast. The disclosed holographic image speckle reduction method has not experienced a significant loss in contrast as Nλ is increased. Furthermore, our 2D examples may have demonstrated low black levels and high contrast (see FIG. 19). However, some of our focal stack results may reconstruct black levels poorly and may exhibit reduced contrast (see FIG. 21).

The disclosed holographic image speckle reduction method may achieve enhanced performance results using more than one SLM. However, a Single SLM configuration may open possibilities for simpler and more cost-effective designs. One of the SLMs may be replaced with a static diffractive optical element (DOE), and could still offer many benefits, although despeckling efficiency might decrease due to fewer degrees of freedom. A single SLM setup may remain effective, indicating potential for practical implementation.

The disclosed system's experimental prototype is far too large to implement as a near-eye display. The dual-SLM setup and the use of super-continuum lasers or polychromatic illumination present significant hurdles in terms of miniaturization and integration into small form factors. In one example, the disclosed holographic image speckle reduction system may comprise a compact architecture that integrates the disclosed holographic image speckle reduction method into near-eye displays, possibly using waveguides and transmissive amplitude modulators. However, while waveguides have been demonstrated as a feasible path towards miniaturization of near-eye holographic displays, further investigation may be required to determine if incorporating polychromatic illumination into such a system is either feasible or practical. Developing a practical implementation for polychromatic illumination for holographic displays is a challenging task in and of itself. While implementing a polychromatic illumination module with (>Nλ=3) discrete laser sources is a feasible path towards implementation, it remains to be seen whether such a path is a practical approach for future commercial near-eye display architectures.

The disclosed subject matter introduces an advancement of the development of high-quality, immersive holographic displays. The disclosed technique may produce high quality imagery for random phase holograms that may produce a uniform eyebox and realistic focal cues. The disclosed holographic image speckle reduction method may present a method to explore wavelength diversity in the field of near-eye holographic displays. By utilizing polychromatic illumination and a dual-SLM architecture, the disclosed subject matter may improve speckle reduction and overall image quality, achieving results comparable to or better than existing state-of-the-art methods.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of the disclosed holographic image speckle reduction components, among other things as disclosed herein. For example, one skilled in the art will recognize that the disclosed holographic image speckle reduction method, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—the disclosed holographic image speckle reduction—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### EXAMPLE EMBODIMENTS

Example 1: A method comprising forming a layer of an organic solid crystal (OSC) material, forming a hard mask over the OSC layer, creating an opening in the hard mask, and etching the OSC layer through the opening in the hard mask to form a grating structure in the OSC layer.

Example 2: The method of Example 1, where the OSC layer comprises a crystalline phase.

Example 3: The method of any of Examples 1 and 2, where the grating structure comprises pyramids or rectangular prisms.

Example 4: The method of any of Examples 1-3, where opening the hard mask further comprises etching the hard mask prior to etching the OSC layer.

Example 5: The method of any of Examples 1-4, where a conformal coating may form over the grating structure.

Example 6: The method of any of Examples 1-5, where the hard mask is silicon oxide, silicon nitride, or titanium nitride.

Example 7: A device comprising (i) a reflective backplane, (ii) an array of micro-ribbons disposed on the reflective backplane, and (iii) a metasurface structure positioned beneath the array of micro-ribbons.

Example 8: The device of Example of 7, wherein the metasurface structure comprises a plurality of metasurface structures individually positioned beneath each micro-ribbon in the array of micro-ribbons.

Example 9: A method of speckle reduction in holographic display comprising (i) generating a broad spectrum of light using a laser architecture, (ii) filtering multiple ‘discrete wavelengths using an image optimization module, (iii) multiplexing multiple discrete wavelengths using the image optimization module, and (iv) incoherently averaging speckle patterns across various wavelengths using a spatial light modulator architecture.

Example 10: The method of Example 9, where the laser architecture is configured to generate a set of polychromatic, spatially coherent wavefronts.

Example 11: The method of any of Examples 9 and 10, where the laser architecture comprises one or more lasers.

Example 12: The method of any of Examples 9-11, where the image optimization module is configured to optimize for wavelengths and intensity of light emitted from the laser architecture.

Example 13: The method of any of Example 9-12, where the spatial light modulator architecture comprises multiple spatial light modulators and multiple hyperspectral lookup tables.

Example 14: The method of any of Examples 9-13, where spatial light modulators have an air gap in between one and any subsequent spatial light modulators.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

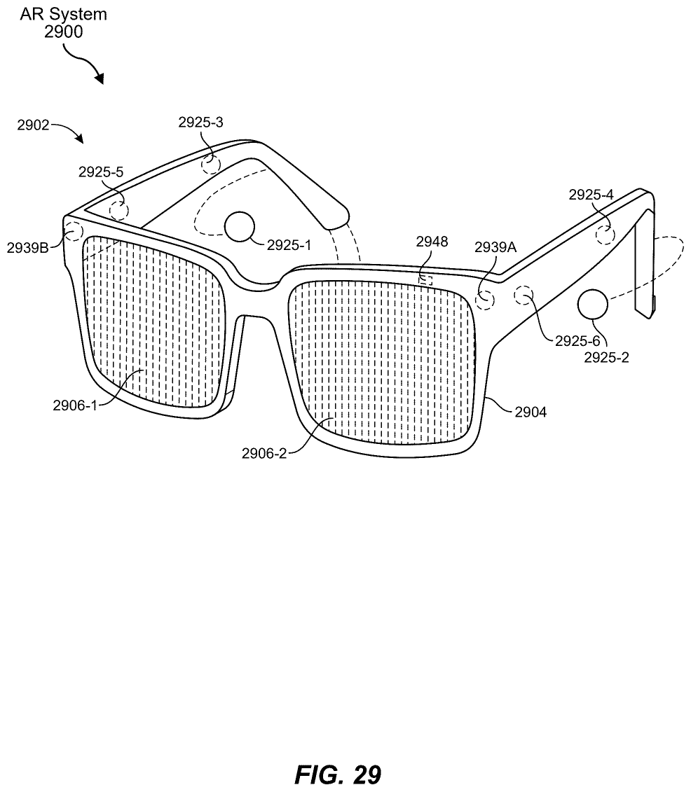

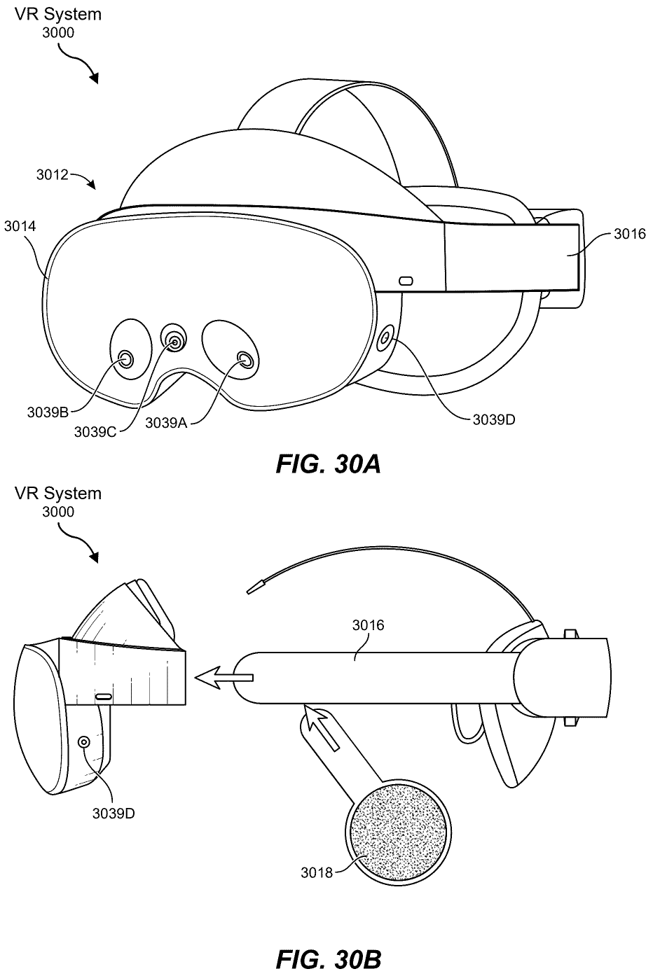

AR systems may be implemented in a variety of different form factors and configurations. Some AR systems may be designed to work without near-eye displays (NEDs). Other AR systems may include a NED that also provides visibility into the real world (such as, e.g., augmented-reality system 2900 in FIG. 29) or that visually immerses a user in an artificial reality (such as, e.g., virtual-reality system 3000 in FIGS. 30A and 30B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

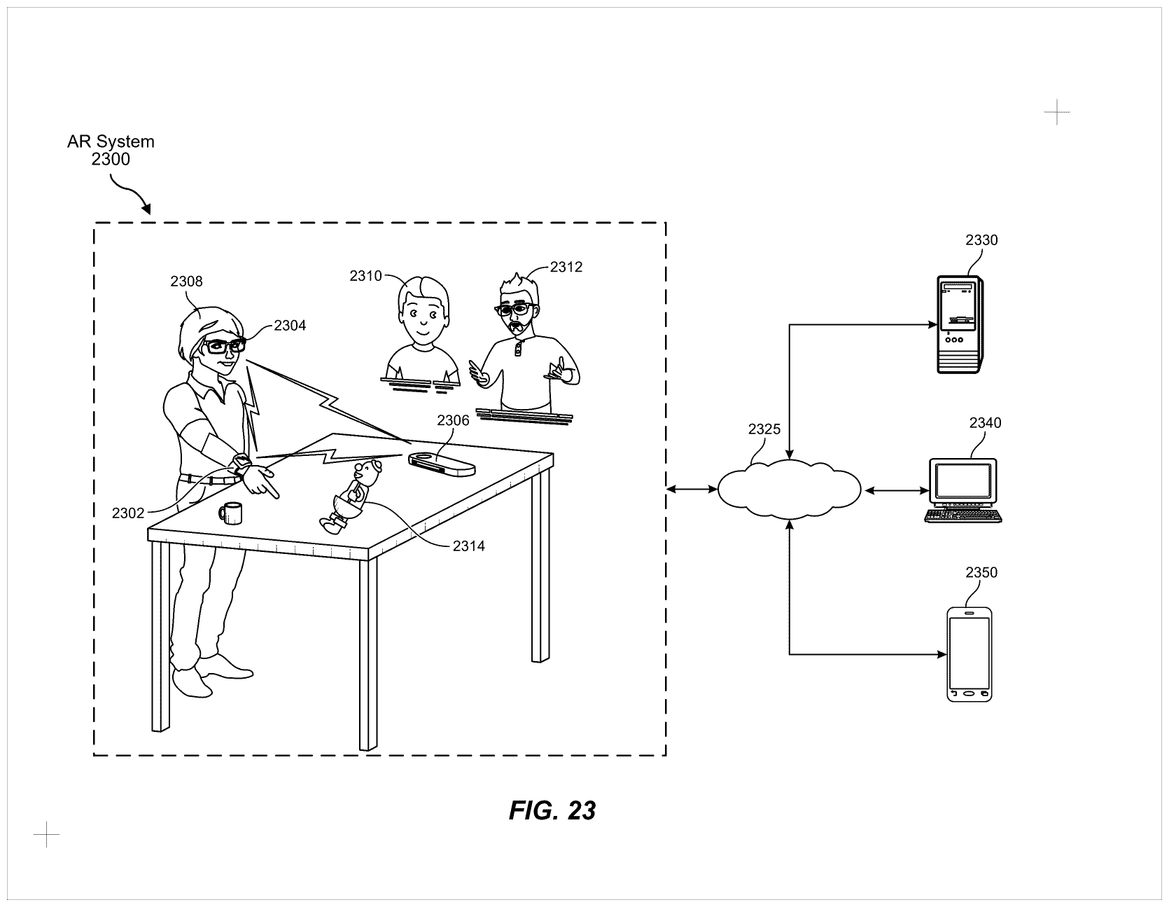

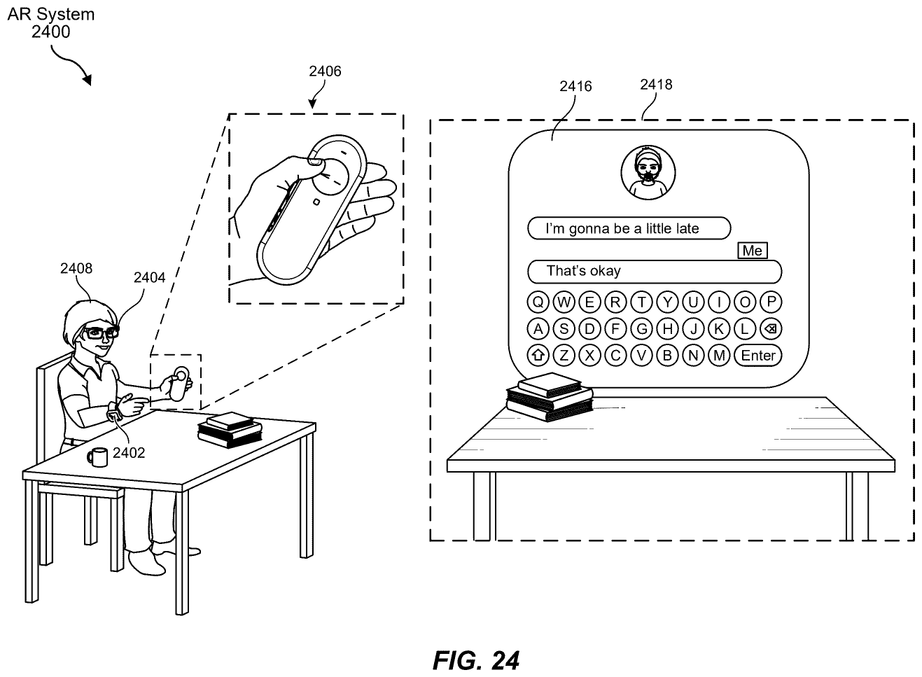

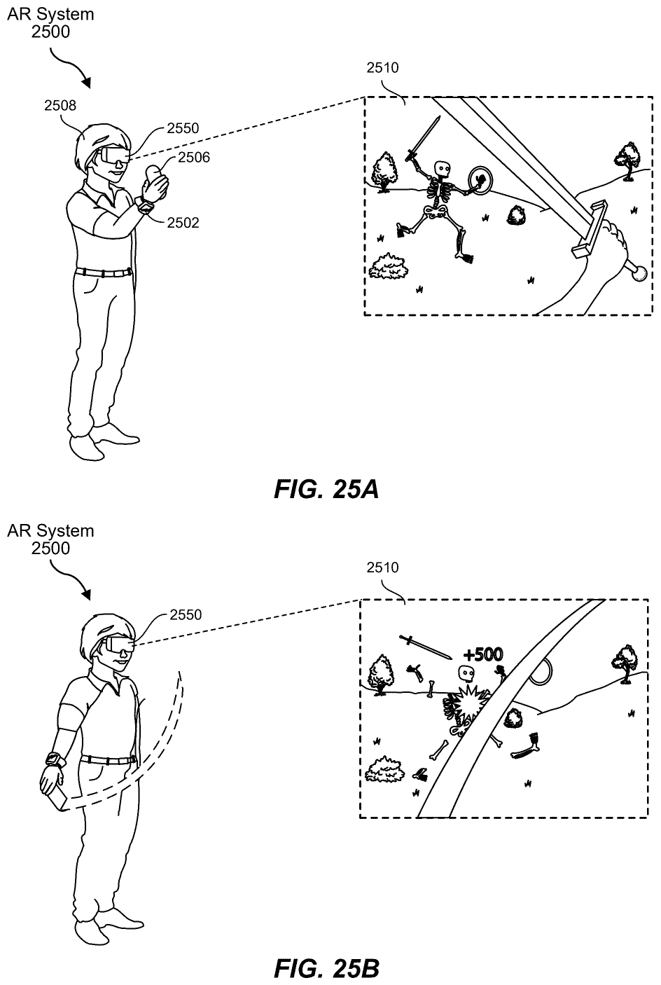

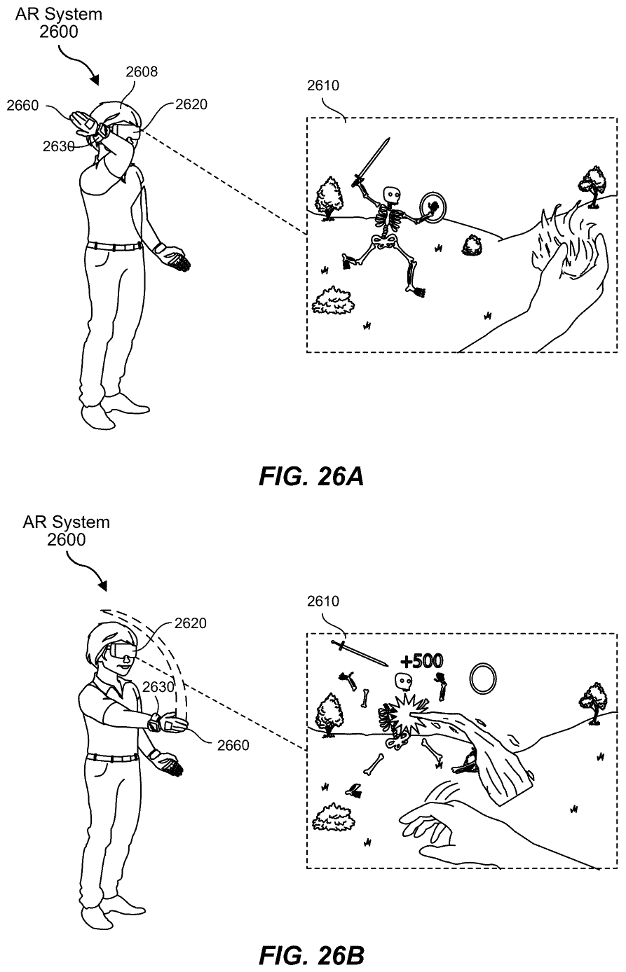

FIGS. 23-26B illustrate example artificial-reality (AR) systems in accordance with some embodiments. FIG. 23 shows a first AR system 2300 and first example user interactions using a wrist-wearable device 2302, a head-wearable device (e.g., AR glasses 2900), and/or a handheld intermediary processing device (HIPD) 2306. FIG. 24 shows a second AR system 2400 and second example user interactions using a wrist-wearable device 2402, AR glasses 2404, and/or an HIPD 2406. FIGS. 25A and 25B show a third AR system 2500 and third example user 2508 interactions using a wrist-wearable device 2502, a head-wearable device (e.g., VR headset 2550), and/or an HIPD 2506. FIGS. 26A and 26B show a fourth AR system 2600 and fourth example user 2608 interactions using a wrist-wearable device 2630, VR headset 2620, and/or a haptic device 2660 (e.g., wearable gloves).

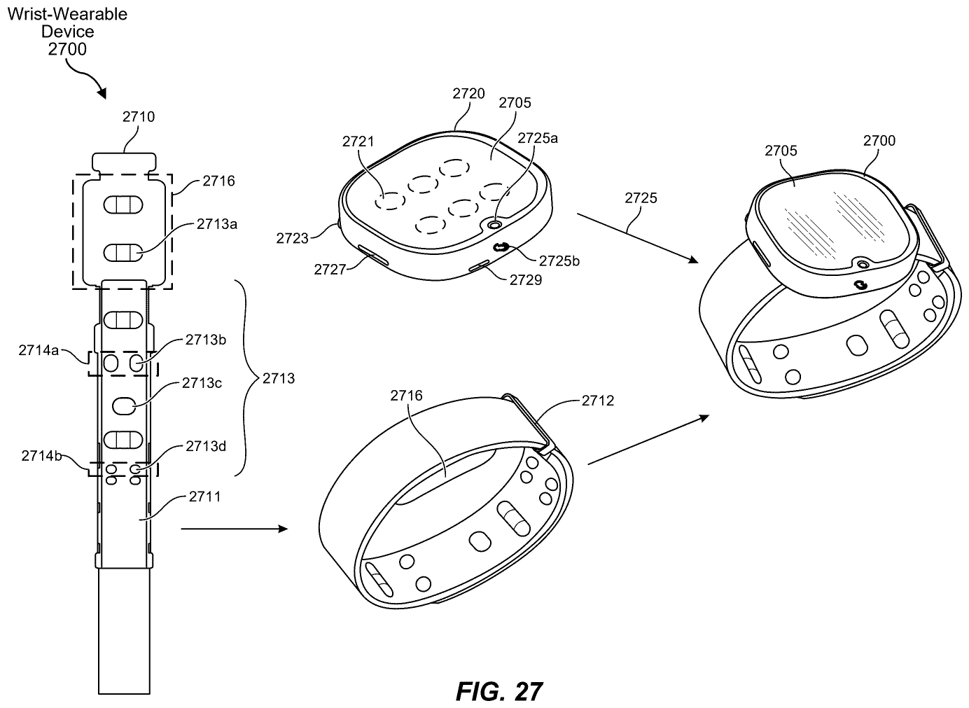

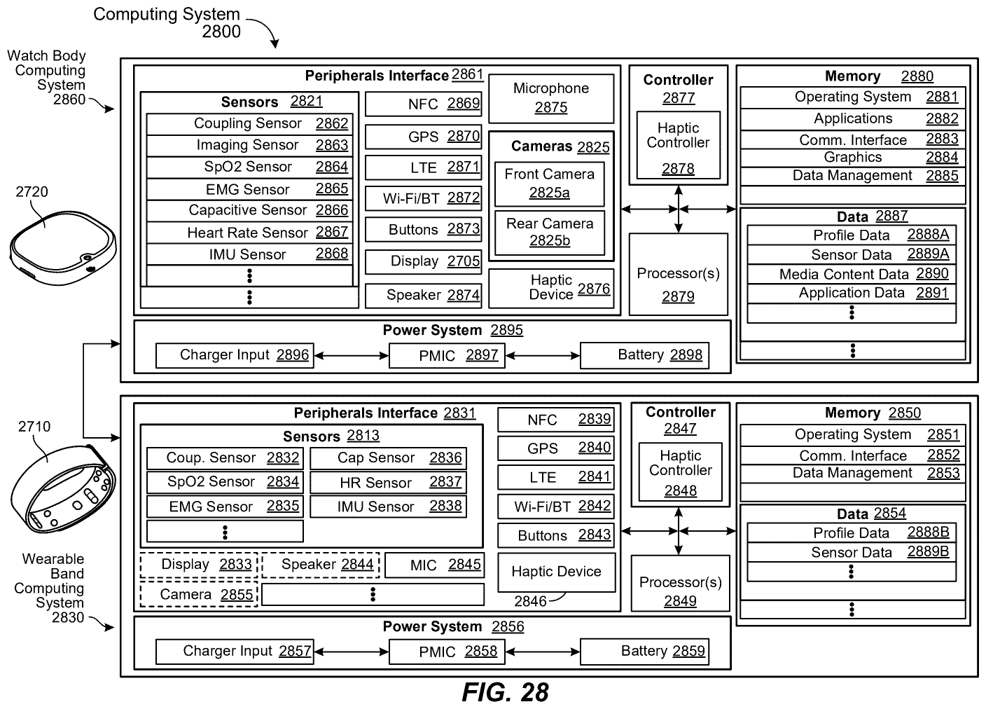

A wrist-wearable device 2700, which can be used for wrist-wearable device 2302, 2402, 2502, 2630, and one or more of its components, are described below in reference to FIGS. 27 and 28; head-wearable devices 2900 and 3000, which can respectively be used for AR glasses 2304, 2404 or VR headset 2550, 2620, and their one or more components are described below in reference to FIGS. 29-31.

Referring to FIG. 23, wrist-wearable device 2302, AR glasses 2304, and/or HIPD 2306 can communicatively couple via a network 2325 (e.g., cellular, near field, Wi-Fi, personal area network, wireless LAN, etc.). Additionally, wrist-wearable device 2302, AR glasses 2304, and/or HIPD 2306 can also communicatively couple with one or more servers 2330, computers 2340 (e.g., laptops, computers, etc.), mobile devices 2350 (e.g., smartphones, tablets, etc.), and/or other electronic devices via network 2325 (e.g., cellular, near field, Wi-Fi, personal area network, wireless LAN, etc.).

In FIG. 23, a user 2308 is shown wearing wrist-wearable device 2302 and AR glasses 2304 and having HIPD 2306 on their desk. The wrist-wearable device 2302, AR glasses 2304, and HIPD 2306 facilitate user interaction with an AR environment. In particular, as shown by first AR system 2300, wrist-wearable device 2302, AR glasses 2304, and/or HIPD 2306 cause presentation of one or more avatars 2310, digital representations of contacts 2312, and virtual objects 2314. As discussed below, user 2308 can interact with one or more avatars 2310, digital representations of contacts 2312, and virtual objects 2314 via wrist-wearable device 2302, AR glasses 2304, and/or HIPD 2306.

User 2308 can use any of wrist-wearable device 2302, AR glasses 2304, and/or HIPD 2306 to provide user inputs. For example, user 2308 can perform one or more hand gestures that are detected by wrist-wearable device 2302 (e.g., using one or more EMG sensors and/or IMUs, described below in reference to FIGS. 27 and 28) and/or AR glasses 2304 (e.g., using one or more image sensor or camera, described below in reference to FIGS. 29-10) to provide a user input. Alternatively, or additionally, user 2308 can provide a user input via one or more touch surfaces of wrist-wearable device 2302, AR glasses 2304, HIPD 2306, and/or voice commands captured by a microphone of wrist-wearable device 2302, AR glasses 2304, and/or HIPD 2306. In some embodiments, wrist-wearable device 2302, AR glasses 2304, and/or HIPD 2306 include a digital assistant to help user 2308 in providing a user input (e.g., completing a sequence of operations, suggesting different operations or commands, providing reminders, confirming a command, etc.). In some embodiments, user 2308 can provide a user input via one or more facial gestures and/or facial expressions. For example, cameras of wrist-wearable device 2302, AR glasses 2304, and/or HIPD 2306 can track eyes of user 2308 for navigating a user interface.

Wrist-wearable device 2302, AR glasses 2304, and/or HIPD 2306 can operate alone or in conjunction to allow user 2308 to interact with the AR environment. In some embodiments, HIPD 2306 is configured to operate as a central hub or control center for the wrist-wearable device 2302, AR glasses 2304, and/or another communicatively coupled device. For example, user 2308 can provide an input to interact with the AR environment at any of wrist-wearable device 2302, AR glasses 2304, and/or HIPD 2306, and HIPD 2306 can identify one or more back-end and front-end tasks to cause the performance of the requested interaction and distribute instructions to cause the performance of the one or more back-end and front-end tasks at wrist-wearable device 2302, AR glasses 2304, and/or HIPD 2306. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 11-12, HIPD 2306 can perform the back-end tasks and provide wrist-wearable device 2302 and/or AR glasses 2304 operational data corresponding to the performed back-end tasks such that wrist-wearable device 2302 and/or AR glasses 2304 can perform the front-end tasks. In this way, HIPD 2306, which has more computational resources and greater thermal headroom than wrist-wearable device 2302 and/or AR glasses 2304, performs computationally intensive tasks and reduces the computer resource utilization and/or power usage of wrist-wearable device 2302 and/or AR glasses 2304.

In the example shown by first AR system 2300, HIPD 2306 identifies one or more back-end tasks and front-end tasks associated with a user request to initiate an AR video call with one or more other users (represented by avatar 2310 and the digital representation of contact 2312) and distributes instructions to cause the performance of the one or more back-end tasks and front-end tasks. In particular, HIPD 2306 performs back-end tasks for processing and/or rendering image data (and other data) associated with the AR video call and provides operational data associated with the performed back-end tasks to AR glasses 2304 such that the AR glasses 2304 perform front-end tasks for presenting the AR video call (e.g., presenting avatar 2310 and digital representation of contact 2312).

In some embodiments, HIPD 2306 can operate as a focal or anchor point for causing the presentation of information. This allows user 2308 to be generally aware of where information is presented. For example, as shown in first AR system 2300, avatar 2310 and the digital representation of contact 2312 are presented above HIPD 2306. In particular, HIPD 2306 and AR glasses 2304 operate in conjunction to determine a location for presenting avatar 2310 and the digital representation of contact 2312. In some embodiments, information can be presented a predetermined distance from HIPD 2306 (e.g., within 5 meters). For example, as shown in first AR system 2300, virtual object 2314 is presented on the desk some distance from HIPD 2306. Similar to the above example, HIPD 2306 and AR glasses 2304 can operate in conjunction to determine a location for presenting virtual object 2314. Alternatively, in some embodiments, presentation of information is not bound by HIPD 2306. More specifically, avatar 2310, digital representation of contact 2312, and virtual object 2314 do not have to be presented within a predetermined distance of HIPD 2306.

User inputs provided at wrist-wearable device 2302, AR glasses 2304, and/or HIPD 2306 are coordinated such that the user can use any device to initiate, continue, and/or complete an operation. For example, user 2308 can provide a user input to AR glasses 2304 to cause AR glasses 2304 to present virtual object 2314 and, while virtual object 2314 is presented by AR glasses 2304, user 2308 can provide one or more hand gestures via wrist-wearable device 2302 to interact and/or manipulate virtual object 2314.

FIG. 24 shows a user 2408 wearing a wrist-wearable device 2402 and AR glasses 2404, and holding an HIPD 2406. In second AR system 2400, the wrist-wearable device 2402, AR glasses 2404, and/or HIPD 2406 are used to receive and/or provide one or more messages to a contact of user 2408. In particular, wrist-wearable device 2402, AR glasses 2404, and/or HIPD 2406 detect and coordinate one or more user inputs to initiate a messaging application and prepare a response to a received message via the messaging application.

In some embodiments, user 2408 initiates, via a user input, an application on wrist-wearable device 2402, AR glasses 2404, and/or HIPD 2406 that causes the application to initiate on at least one device. For example, in second AR system 2400, user 2408 performs a hand gesture associated with a command for initiating a messaging application (represented by messaging user interface 2416), wrist-wearable device 2402 detects the hand gesture and, based on a determination that user 2408 is wearing AR glasses 2404, causes AR glasses 2404 to present a messaging user interface 2416 of the messaging application. AR glasses 2404 can present messaging user interface 2416 to user 2408 via its display (e.g., as shown by a field of view 2418 of user 2408). In some embodiments, the application is initiated and executed on the device (e.g., wrist-wearable device 2402, AR glasses 2404, and/or HIPD 2406) that detects the user input to initiate the application, and the device provides another device operational data to cause the presentation of the messaging application. For example, wrist-wearable device 2402 can detect the user input to initiate a messaging application, initiate and run the messaging application, and provide operational data to AR glasses 2404 and/or HIPD 2406 to cause presentation of the messaging application. Alternatively, the application can be initiated and executed at a device other than the device that detected the user input. For example, wrist-wearable device 2402 can detect the hand gesture associated with initiating the messaging application and cause HIPD 2406 to run the messaging application and coordinate the presentation of the messaging application.

Further, user 2408 can provide a user input provided at wrist-wearable device 2402, AR glasses 2404, and/or HIPD 2406 to continue and/or complete an operation initiated at another device. For example, after initiating the messaging application via wrist-wearable device 2402 and while AR glasses 2404 present messaging user interface 2416, user 2408 can provide an input at HIPD 2406 to prepare a response (e.g., shown by the swipe gesture performed on HIPD 2406). Gestures performed by user 2408 on HIPD 2406 can be provided and/or displayed on another device. For example, a swipe gestured performed on HIPD 2406 is displayed on a virtual keyboard of messaging user interface 2416 displayed by AR glasses 2404.

In some embodiments, wrist-wearable device 2402, AR glasses 2404, HIPD 2406, and/or any other communicatively coupled device can present one or more notifications to user 2408. The notification can be an indication of a new message, an incoming call, an application update, a status update, etc. User 2408 can select the notification via wrist-wearable device 2402, AR glasses 2404, and/or HIPD 2406 and can cause presentation of an application or operation associated with the notification on at least one device. For example, user 2408 can receive a notification that a message was received at wrist-wearable device 2402, AR glasses 2404, HIPD 2406, and/or any other communicatively coupled device and can then provide a user input at wrist-wearable device 2402, AR glasses 2404, and/or HIPD 2406 to review the notification, and the device detecting the user input can cause an application associated with the notification to be initiated and/or presented at wrist-wearable device 2402, AR glasses 2404, and/or HIPD 2406.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2404 can present to user 2408 game application data, and HIPD 2406 can be used as a controller to provide inputs to the game. Similarly, user 2408 can use wrist-wearable device 2402 to initiate a camera of AR glasses 2404, and user 2408 can use wrist-wearable device 2402, AR glasses 2404, and/or HIPD 2406 to manipulate the image capture (e.g., zoom in or out, apply filters, etc.) and capture image data.

Users may interact with the devices disclosed herein in a variety of ways. For example, as shown in FIGS. 25A and 25B, a user 2508 may interact with an AR system 2500 by donning a VR headset 2550 while holding HIPD 2506 and wearing wrist-wearable device 2502. In this example, AR system 2500 may enable a user to interact with a game 2510 by swiping their arm. One or more of VR headset 2550, HIPD 2506, and wrist-wearable device 2502 may detect this gesture and, in response, may display a sword strike in game 2510. Similarly, in FIGS. 26A and 26B, a user 2608 may interact with an AR system 2600 by donning a VR headset 2620 while wearing haptic device 2660 and wrist-wearable device 2630. In this example, AR system 2600 may enable a user to interact with a game 2610 by swiping their arm. One or more of VR headset 2620, haptic device 2660, and wrist-wearable device 2630 may detect this gesture and, in response, may display a spell being cast in game 2510.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2902.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 27 and 28 illustrate an example wrist-wearable device 2700 and an example computer system 2800, in accordance with some embodiments. Wrist-wearable device 2700 is an instance of wearable device 2302 described in FIG. 23 herein, such that the wearable device 2302 should be understood to have the features of the wrist-wearable device 2700 and vice versa. FIG. 28 illustrates components of the wrist-wearable device 2700, which can be used individually or in combination, including combinations that include other electronic devices and/or electronic components.

FIG. 27 shows a wearable band 2710 and a watch body 2720 (or capsule) being coupled, as discussed below, to form wrist-wearable device 2700. Wrist-wearable device 2700 can perform various functions and/or operations associated with navigating through user interfaces and selectively opening applications as well as the functions and/or operations described above with reference to FIGS. 23-26B.

As will be described in more detail below, operations executed by wrist-wearable device 2700 can include (i) presenting content to a user (e.g., displaying visual content via a display 2705), (ii) detecting (e.g., sensing) user input (e.g., sensing a touch on peripheral button 2723 and/or at a touch screen of the display 2705, a hand gesture detected by sensors (e.g., biopotential sensors)), (iii) sensing biometric data (e.g., neuromuscular signals, heart rate, temperature, sleep, etc.) via one or more sensors 2713, messaging (e.g., text, speech, video, etc.); image capture via one or more imaging devices or cameras 2725, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2720, independently in wearable band 2710, and/or via an electronic communication between watch body 2720 and wearable band 2710. In some embodiments, functions can be executed on wrist-wearable device 2700 while an AR environment is being presented (e.g., via one of AR systems 2300 to 2600). The wearable devices described herein can also be used with other types of AR environments.

Wearable band 2710 can be configured to be worn by a user such that an inner surface of a wearable structure 2711 of wearable band 2710 is in contact with the user's skin. In this example, when worn by a user, sensors 2713 may contact the user's skin. In some examples, one or more of sensors 2713 can sense biometric data such as a user's heart rate, a saturated oxygen level, temperature, sweat level, neuromuscular signals, or a combination thereof. One or more of sensors 2713 can also sense data about a user's environment including a user's motion, altitude, location, orientation, gait, acceleration, position, or a combination thereof. In some embodiment, one or more of sensors 2713 can be configured to track a position and/or motion of wearable band 2710. One or more of sensors 2713 can include any of the sensors defined above and/or discussed below with respect to FIG. 27.

One or more of sensors 2713 can be distributed on an inside and/or an outside surface of wearable band 2710. In some embodiments, one or more of sensors 2713 are uniformly spaced along wearable band 2710. Alternatively, in some embodiments, one or more of sensors 2713 are positioned at distinct points along wearable band 2710. As shown in FIG. 27, one or more of sensors 2713 can be the same or distinct. For example, in some embodiments, one or more of sensors 2713 can be shaped as a pill (e.g., sensor 2713a), an oval, a circle a square, an oblong (e.g., sensor 2713c) and/or any other shape that maintains contact with the user's skin (e.g., such that neuromuscular signal and/or other biometric data can be accurately measured at the user's skin). In some embodiments, one or more sensors of 2713 are aligned to form pairs of sensors (e.g., for sensing neuromuscular signals based on differential sensing within each respective sensor). For example, sensor 2713b may be aligned with an adjacent sensor to form sensor pair 2714a and sensor 2713d may be aligned with an adjacent sensor to form sensor pair 2714b. In some embodiments, wearable band 2710 does not have a sensor pair. Alternatively, in some embodiments, wearable band 2710 has a predetermined number of sensor pairs (one pair of sensors, three pairs of sensors, four pairs of sensors, six pairs of sensors, sixteen pairs of sensors, etc.).

Wearable band 2710 can include any suitable number of sensors 2713. In some embodiments, the number and arrangement of sensors 2713 depends on the particular application for which wearable band 2710 is used. For instance, wearable band 2710 can be configured as an armband, wristband, or chest-band that include a plurality of sensors 2713 with different number of sensors 2713, a variety of types of individual sensors with the plurality of sensors 2713, and different arrangements for each use case, such as medical use cases as compared to gaming or general day-to-day use cases.

In accordance with some embodiments, wearable band 2710 further includes an electrical ground electrode and a shielding electrode. The electrical ground and shielding electrodes, like the sensors 2713, can be distributed on the inside surface of the wearable band 2710 such that they contact a portion of the user's skin. For example, the electrical ground and shielding electrodes can be at an inside surface of a coupling mechanism 2716 or an inside surface of a wearable structure 2711. The electrical ground and shielding electrodes can be formed and/or use the same components as sensors 2713. In some embodiments, wearable band 2710 includes more than one electrical ground electrode and more than one shielding electrode.

Sensors 2713 can be formed as part of wearable structure 2711 of wearable band 2710. In some embodiments, sensors 2713 are flush or substantially flush with wearable structure 2711 such that they do not extend beyond the surface of wearable structure 2711. While flush with wearable structure 2711, sensors 2713 are still configured to contact the user's skin (e.g., via a skin-contacting surface). Alternatively, in some embodiments, sensors 2713 extend beyond wearable structure 2711 a predetermined distance (e.g., 0.1-2 mm) to make contact and depress into the user's skin. In some embodiment, sensors 2713 are coupled to an actuator (not shown) configured to adjust an extension height (e.g., a distance from the surface of wearable structure 2711) of sensors 2713 such that sensors 2713 make contact and depress into the user's skin. In some embodiments, the actuators adjust the extension height between 0.01 mm-1.2 mm. This may allow a the user to customize the positioning of sensors 2713 to improve the overall comfort of the wearable band 2710 when worn while still allowing sensors 2713 to contact the user's skin. In some embodiments, sensors 2713 are indistinguishable from wearable structure 2711 when worn by the user.

Wearable structure 2711 can be formed of an elastic material, elastomers, etc., configured to be stretched and fitted to be worn by the user. In some embodiments, wearable structure 2711 is a textile or woven fabric. As described above, sensors 2713 can be formed as part of a wearable structure 2711. For example, sensors 2713 can be molded into the wearable structure 2711, be integrated into a woven fabric (e.g., sensors 2713 can be sewn into the fabric and mimic the pliability of fabric and can and/or be constructed from a series woven strands of fabric).

Wearable structure 2711 can include flexible electronic connectors that interconnect sensors 2713, the electronic circuitry, and/or other electronic components (described below in reference to FIG. 28) that are enclosed in wearable band 2710. In some embodiments, the flexible electronic connectors are configured to interconnect sensors 2713, the electronic circuitry, and/or other electronic components of wearable band 2710 with respective sensors and/or other electronic components of another electronic device (e.g., watch body 2720). The flexible electronic connectors are configured to move with wearable structure 2711 such that the user adjustment to wearable structure 2711 (e.g., resizing, pulling, folding, etc.) does not stress or strain the electrical coupling of components of wearable band 2710.

As described above, wearable band 2710 is configured to be worn by a user. In particular, wearable band 2710 can be shaped or otherwise manipulated to be worn by a user. For example, wearable band 2710 can be shaped to have a substantially circular shape such that it can be configured to be worn on the user's lower arm or wrist. Alternatively, wearable band 2710 can be shaped to be worn on another body part of the user, such as the user's upper arm (e.g., around a bicep), forearm, chest, legs, etc. Wearable band 2710 can include a retaining mechanism 2712 (e.g., a buckle, a hook and loop fastener, etc.) for securing wearable band 2710 to the user's wrist or other body part. While wearable band 2710 is worn by the user, sensors 2713 sense data (referred to as sensor data) from the user's skin. In some examples, sensors 2713 of wearable band 2710 obtain (e.g., sense and record) neuromuscular signals.

The sensed data (e.g., sensed neuromuscular signals) can be used to detect and/or determine the user's intention to perform certain motor actions. In some examples, sensors 2713 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2705 of wrist-wearable device 2700 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2713 can be used to provide a user with an enhanced interaction with a physical object (e.g., devices communicatively coupled with wearable band 2710) and/or a virtual object in an artificial-reality application generated by an artificial-reality system (e.g., user interface objects presented on the display 2705, or another computing device (e.g., a smartphone)).

In some embodiments, wearable band 2710 includes one or more haptic devices 2846 (e.g., a vibratory haptic actuator) that are configured to provide haptic feedback (e.g., a cutaneous and/or kinesthetic sensation, etc.) to the user's skin. Sensors 2713 and/or haptic devices 2846 (shown in FIG. 28) can be configured to operate in conjunction with multiple applications including, without limitation, health monitoring, social media, games, and artificial reality (e.g., the applications associated with artificial reality).

Wearable band 2710 can also include coupling mechanism 2716 for detachably coupling a capsule (e.g., a computing unit) or watch body 2720 (via a coupling surface of the watch body 2720) to wearable band 2710. For example, a cradle or a shape of coupling mechanism 2716 can correspond to shape of watch body 2720 of wrist-wearable device 2700. In particular, coupling mechanism 2716 can be configured to receive a coupling surface proximate to the bottom side of watch body 2720 (e.g., a side opposite to a front side of watch body 2720 where display 2705 is located), such that a user can push watch body 2720 downward into coupling mechanism 2716 to attach watch body 2720 to coupling mechanism 2716. In some embodiments, coupling mechanism 2716 can be configured to receive a top side of the watch body 2720 (e.g., a side proximate to the front side of watch body 2720 where display 2705 is located) that is pushed upward into the cradle, as opposed to being pushed downward into coupling mechanism 2716. In some embodiments, coupling mechanism 2716 is an integrated component of wearable band 2710 such that wearable band 2710 and coupling mechanism 2716 are a single unitary structure. In some embodiments, coupling mechanism 2716 is a type of frame or shell that allows watch body 2720 coupling surface to be retained within or on wearable band 2710 coupling mechanism 2716 (e.g., a cradle, a tracker band, a support base, a clasp, etc.).

Coupling mechanism 2716 can allow for watch body 2720 to be detachably coupled to the wearable band 2710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2720 to wearable band 2710 and to decouple the watch body 2720 from the wearable band 2710. For example, a user can twist, slide, turn, push, pull, or rotate watch body 2720 relative to wearable band 2710, or a combination thereof, to attach watch body 2720 to wearable band 2710 and to detach watch body 2720 from wearable band 2710. Alternatively, as discussed below, in some embodiments, the watch body 2720 can be decoupled from the wearable band 2710 by actuation of a release mechanism 2729.

Wearable band 2710 can be coupled with watch body 2720 to increase the functionality of wearable band 2710 (e.g., converting wearable band 2710 into wrist-wearable device 2700, adding an additional computing unit and/or battery to increase computational resources and/or a battery life of wearable band 2710, adding additional sensors to improve sensed data, etc.). As described above, wearable band 2710 and coupling mechanism 2716 are configured to operate independently (e.g., execute functions independently) from watch body 2720. For example, coupling mechanism 2716 can include one or more sensors 2713 that contact a user's skin when wearable band 2710 is worn by the user, with or without watch body 2720 and can provide sensor data for determining control commands.

A user can detach watch body 2720 from wearable band 2710 to reduce the encumbrance of wrist-wearable device 2700 to the user. For embodiments in which watch body 2720 is removable, watch body 2720 can be referred to as a removable structure, such that in these embodiments wrist-wearable device 2700 includes a wearable portion (e.g., wearable band 2710) and a removable structure (e.g., watch body 2720).

Turning to watch body 2720, in some examples watch body 2720 can have a substantially rectangular or circular shape. Watch body 2720 is configured to be worn by the user on their wrist or on another body part. More specifically, watch body 2720 is sized to be easily carried by the user, attached on a portion of the user's clothing, and/or coupled to wearable band 2710 (forming the wrist-wearable device 2700). As described above, watch body 2720 can have a shape corresponding to coupling mechanism 2716 of wearable band 2710. In some embodiments, watch body 2720 includes a single release mechanism 2729 or multiple release mechanisms (e.g., two release mechanisms 2729 positioned on opposing sides of watch body 2720, such as spring-loaded buttons) for decoupling watch body 2720 from wearable band 2710. Release mechanism 2729 can include, without limitation, a button, a knob, a plunger, a handle, a lever, a fastener, a clasp, a dial, a latch, or a combination thereof.

A user can actuate release mechanism 2729 by pushing, turning, lifting, depressing, shifting, or performing other actions on release mechanism 2729. Actuation of release mechanism 2729 can release (e.g., decouple) watch body 2720 from coupling mechanism 2716 of wearable band 2710, allowing the user to use watch body 2720 independently from wearable band 2710 and vice versa. For example, decoupling watch body 2720 from wearable band 2710 can allow a user to capture images using rear-facing camera 2725b. Although release mechanism 2729 is shown positioned at a corner of watch body 2720, release mechanism 2729 can be positioned anywhere on watch body 2720 that is convenient for the user to actuate. In addition, in some embodiments, wearable band 2710 can also include a respective release mechanism for decoupling watch body 2720 from coupling mechanism 2716. In some embodiments, release mechanism 2729 is optional and watch body 2720 can be decoupled from coupling mechanism 2716 as described above (e.g., via twisting, rotating, etc.).

Watch body 2720 can include one or more peripheral buttons 2723 and 2727 for performing various operations at watch body 2720. For example, peripheral buttons 2723 and 2727 can be used to turn on or wake (e.g., transition from a sleep state to an active state) display 2705, unlock watch body 2720, increase or decrease a volume, increase or decrease a brightness, interact with one or more applications, interact with one or more user interfaces, etc. Additionally or alternatively, in some embodiments, display 2705 operates as a touch screen and allows the user to provide one or more inputs for interacting with watch body 2720.

In some embodiments, watch body 2720 includes one or more sensors 2721. Sensors 2721 of watch body 2720 can be the same or distinct from sensors 2713 of wearable band 2710. Sensors 2721 of watch body 2720 can be distributed on an inside and/or an outside surface of watch body 2720. In some embodiments, sensors 2721 are configured to contact a user's skin when watch body 2720 is worn by the user. For example, sensors 2721 can be placed on the bottom side of watch body 2720 and coupling mechanism 2716 can be a cradle with an opening that allows the bottom side of watch body 2720 to directly contact the user's skin. Alternatively, in some embodiments, watch body 2720 does not include sensors that are configured to contact the user's skin (e.g., including sensors internal and/or external to the watch body 2720 that are configured to sense data of watch body 2720 and the surrounding environment). In some embodiments, sensors 2721 are configured to track a position and/or motion of watch body 2720.

Watch body 2720 and wearable band 2710 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2720 and wearable band 2710 can share data sensed by sensors 2713 and 2721, as well as application and device specific information (e.g., active and/or available applications, output devices (e.g., displays, speakers, etc.), input devices (e.g., touch screens, microphones, imaging sensors, etc.).

In some embodiments, watch body 2720 can include, without limitation, a front-facing camera 2725a and/or a rear-facing camera 2725b, sensors 2721 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2863), a touch sensor, a sweat sensor, etc.). In some embodiments, watch body 2720 can include one or more haptic devices 2876 (e.g., a vibratory haptic actuator) that is configured to provide haptic feedback (e.g., a cutaneous and/or kinesthetic sensation, etc.) to the user. Sensors 2821 and/or haptic device 2876 can also be configured to operate in conjunction with multiple applications including, without limitation, health monitoring applications, social media applications, game applications, and artificial reality applications (e.g., the applications associated with artificial reality).

As described above, watch body 2720 and wearable band 2710, when coupled, can form wrist-wearable device 2700. When coupled, watch body 2720 and wearable band 2710 may operate as a single device to execute functions (operations, detections, communications, etc.) described herein. In some embodiments, each device may be provided with particular instructions for performing the one or more operations of wrist-wearable device 2700. For example, in accordance with a determination that watch body 2720 does not include neuromuscular signal sensors, wearable band 2710 can include alternative instructions for performing associated instructions (e.g., providing sensed neuromuscular signal data to watch body 2720 via a different electronic device). Operations of wrist-wearable device 2700 can be performed by watch body 2720 alone or in conjunction with wearable band 2710 (e.g., via respective processors and/or hardware components) and vice versa. In some embodiments, operations of wrist-wearable device 2700, watch body 2720, and/or wearable band 2710 can be performed in conjunction with one or more processors and/or hardware components.

As described below with reference to the block diagram of FIG. 28, wearable band 2710 and/or watch body 2720 can each include independent resources required to independently execute functions. For example, wearable band 2710 and/or watch body 2720 can each include a power source (e.g., a battery), a memory, data storage, a processor (e.g., a central processing unit (CPU)), communications, a light source, and/or input/output devices.

FIG. 28 shows block diagrams of a computing system 2830 corresponding to wearable band 2710 and a computing system 2860 corresponding to watch body 2720 according to some embodiments. Computing system 2800 of wrist-wearable device 2700 may include a combination of components of wearable band computing system 2830 and watch body computing system 2860, in accordance with some embodiments.

Watch body 2720 and/or wearable band 2710 can include one or more components shown in watch body computing system 2860. In some embodiments, a single integrated circuit may include all or a substantial portion of the components of watch body computing system 2860 included in a single integrated circuit. Alternatively, in some embodiments, components of the watch body computing system 2860 may be included in a plurality of integrated circuits that are communicatively coupled. In some embodiments, watch body computing system 2860 may be configured to couple (e.g., via a wired or wireless connection) with wearable band computing system 2830, which may allow the computing systems to share components, distribute tasks, and/or perform other operations described herein (individually or as a single device).

Watch body computing system 2860 can include one or more processors 2879, a controller 2877, a peripherals interface 2861, a power system 2895, and memory (e.g., a memory 2880).

Power system 2895 can include a charger input 2896, a power-management integrated circuit (PMIC) 2897, and a battery 2898. In some embodiments, a watch body 2720 and a wearable band 2710 can have respective batteries (e.g., battery 2898 and 2859) and can share power with each other. Watch body 2720 and wearable band 2710 can receive a charge using a variety of techniques. In some embodiments, watch body 2720 and wearable band 2710 can use a wired charging assembly (e.g., power cords) to receive the charge. Alternatively, or in addition, watch body 2720 and/or wearable band 2710 can be configured for wireless charging. For example, a portable charging device can be designed to mate with a portion of watch body 2720 and/or wearable band 2710 and wirelessly deliver usable power to battery 2898 of watch body 2720 and/or battery 2859 of wearable band 2710. Watch body 2720 and wearable band 2710 can have independent power systems (e.g., power system 2895 and 2856, respectively) to enable each to operate independently. Watch body 2720 and wearable band 2710 can also share power (e.g., one can charge the other) via respective PMICs (e.g., PMICs 2897 and 2858) and charger inputs (e.g., 2857 and 2896) that can share power over power and ground conductors and/or over wireless charging antennas.

In some embodiments, peripherals interface 2861 can include one or more sensors 2821. Sensors 2821 can include one or more coupling sensors 2862 for detecting when watch body 2720 is coupled with another electronic device (e.g., a wearable band 2710). Sensors 2821 can include one or more imaging sensors 2863 (e.g., one or more of cameras 2825, and/or separate imaging sensors 2863 (e.g., thermal-imaging sensors)). In some embodiments, sensors 2821 can include one or more SpO2 sensors 2864. In some embodiments, sensors 2821 can include one or more biopotential-signal sensors (e.g., EMG sensors 2865, which may be disposed on an interior, user-facing portion of watch body 2720 and/or wearable band 2710). In some embodiments, sensors 2821 may include one or more capacitive sensors 2866. In some embodiments, sensors 2821 may include one or more heart rate sensors 2867. In some embodiments, sensors 2821 may include one or more IMU sensors 2868. In some embodiments, one or more IMU sensors 2868 can be configured to detect movement of a user's hand or other location where watch body 2720 is placed or held.

In some embodiments, one or more of sensors 2821 may provide an example human-machine interface. For example, a set of neuromuscular sensors, such as EMG sensors 2865, may be arranged circumferentially around wearable band 2710 with an interior surface of EMG sensors 2865 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2710 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2879. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2865 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2861 includes a near-field communication (NFC) component 2869, a global-position system (GPS) component 2870, a long-term evolution (LTE) component 2871, and/or a Wi-Fi and/or Bluetooth communication component 2872. In some embodiments, peripherals interface 2861 includes one or more buttons 2873 (e.g., peripheral buttons 2723 and 2727 in FIG. 27), which, when selected by a user, cause operation to be performed at watch body 2720. In some embodiments, the peripherals interface 2861 includes one or more indicators, such as a light emitting diode (LED), to provide a user with visual indicators (e.g., message received, low battery, active microphone and/or camera, etc.).

Watch body 2720 can include at least one display 2705 for displaying visual representations of information or data to a user, including user-interface elements and/or three-dimensional virtual objects. The display can also include a touch screen for inputting user inputs, such as touch gestures, swipe gestures, and the like. Watch body 2720 can include at least one speaker 2874 and at least one microphone 2875 for providing audio signals to the user and receiving audio input from the user. The user can provide user inputs through microphone 2875 and can also receive audio output from speaker 2874 as part of a haptic event provided by haptic controller 2878. Watch body 2720 can include at least one camera 2825, including a front camera 2825a and a rear camera 2825b. Cameras 2825 can include ultra-wide-angle cameras, wide angle cameras, fish-eye cameras, spherical cameras, telephoto cameras, depth-sensing cameras, or other types of cameras.

Watch body computing system 2860 can include one or more haptic controllers 2878 and associated componentry (e.g., haptic devices 2876) for providing haptic events at watch body 2720 (e.g., a vibrating sensation or audio output in response to an event at the watch body 2720). Haptic controllers 2878 can communicate with one or more haptic devices 2876, such as electroacoustic devices, including a speaker of the one or more speakers 2874 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2878 can provide haptic events to that are capable of being sensed by a user of watch body 2720. In some embodiments, one or more haptic controllers 2878 can receive input signals from an application of applications 2882.

In some embodiments, wearable band computing system 2830 and/or watch body computing system 2860 can include memory 2880, which can be controlled by one or more memory controllers of controllers 2877. In some embodiments, software components stored in memory 2880 include one or more applications 2882 configured to perform operations at the watch body 2720. In some embodiments, one or more applications 2882 may include games, word processors, messaging applications, calling applications, web browsers, social media applications, media streaming applications, financial applications, calendars, clocks, etc. In some embodiments, software components stored in memory 2880 include one or more communication interface modules 2883 as defined above. In some embodiments, software components stored in memory 2880 include one or more graphics modules 2884 for rendering, encoding, and/or decoding audio and/or visual data and one or more data management modules 2885 for collecting, organizing, and/or providing access to data 2887 stored in memory 2880. In some embodiments, one or more of applications 2882 and/or one or more modules can work in conjunction with one another to perform various tasks at the watch body 2720.

In some embodiments, software components stored in memory 2880 can include one or more operating systems 2881 (e.g., a Linux-based operating system, an Android operating system, etc.). Memory 2880 can also include data 2887. Data 2887 can include profile data 2888A, sensor data 2889A, media content data 2890, and application data 2891.

It should be appreciated that watch body computing system 2860 is an example of a computing system within watch body 2720, and that watch body 2720 can have more or fewer components than shown in watch body computing system 2860, can combine two or more components, and/or can have a different configuration and/or arrangement of the components. The various components shown in watch body computing system 2860 are implemented in hardware, software, firmware, or a combination thereof, including one or more signal processing and/or application-specific integrated circuits.

Turning to the wearable band computing system 2830, one or more components that can be included in wearable band 2710 are shown. Wearable band computing system 2830 can include more or fewer components than shown in watch body computing system 2860, can combine two or more components, and/or can have a different configuration and/or arrangement of some or all of the components. In some embodiments, all, or a substantial portion of the components of wearable band computing system 2830 are included in a single integrated circuit. Alternatively, in some embodiments, components of wearable band computing system 2830 are included in a plurality of integrated circuits that are communicatively coupled. As described above, in some embodiments, wearable band computing system 2830 is configured to couple (e.g., via a wired or wireless connection) with watch body computing system 2860, which allows the computing systems to share components, distribute tasks, and/or perform other operations described herein (individually or as a single device).

Wearable band computing system 2830, similar to watch body computing system 2860, can include one or more processors 2849, one or more controllers 2847 (including one or more haptics controllers 2848), a peripherals interface 2831 that can includes one or more sensors 2813 and other peripheral devices, a power source (e.g., a power system 2856), and memory (e.g., a memory 2850) that includes an operating system (e.g., an operating system 2851), data (e.g., data 2854 including profile data 2888B, sensor data 2889B, etc.), and one or more modules (e.g., a communications interface module 2852, a data management module 2853, etc.).

One or more of sensors 2813 can be analogous to sensors 2821 of watch body computing system 2860. For example, sensors 2813 can include one or more coupling sensors 2832, one or more SpO2 sensors 2834, one or more EMG sensors 2835, one or more capacitive sensors 2836, one or more heart rate sensors 2837, and one or more IMU sensors 2838.

Peripherals interface 2831 can also include other components analogous to those included in peripherals interface 2861 of watch body computing system 2860, including an NFC component 2839, a GPS component 2840, an LTE component 2841, a Wi-Fi and/or Bluetooth communication component 2842, and/or one or more haptic devices 2846 as described above in reference to peripherals interface 2861. In some embodiments, peripherals interface 2831 includes one or more buttons 2843, a display 2833, a speaker 2844, a microphone 2845, and a camera 2855. In some embodiments, peripherals interface 2831 includes one or more indicators, such as an LED.

It should be appreciated that wearable band computing system 2830 is an example of a computing system within wearable band 2710, and that wearable band 2710 can have more or fewer components than shown in wearable band computing system 2830, combine two or more components, and/or have a different configuration and/or arrangement of the components. The various components shown in wearable band computing system 2830 can be implemented in one or more of a combination of hardware, software, or firmware, including one or more signal processing and/or application-specific integrated circuits.

Wrist-wearable device 2700 with respect to FIG. 27 is an example of wearable band 2710 and watch body 2720 coupled together, so wrist-wearable device 2700 will be understood to include the components shown and described for wearable band computing system 2830 and watch body computing system 2860. In some embodiments, wrist-wearable device 2700 has a split architecture (e.g., a split mechanical architecture, a split electrical architecture, etc.) between watch body 2720 and wearable band 2710. In other words, all of the components shown in wearable band computing system 2830 and watch body computing system 2860 can be housed or otherwise disposed in a combined wrist-wearable device 2700 or within individual components of watch body 2720, wearable band 2710, and/or portions thereof (e.g., a coupling mechanism 2716 of wearable band 2710).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2700 can be used in conjunction with a head-wearable device (e.g., AR glasses 2900 and VR system 3010) and/or an HIPD 3200 described below, and wrist-wearable device 2700 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2900 and VR headset 3010.

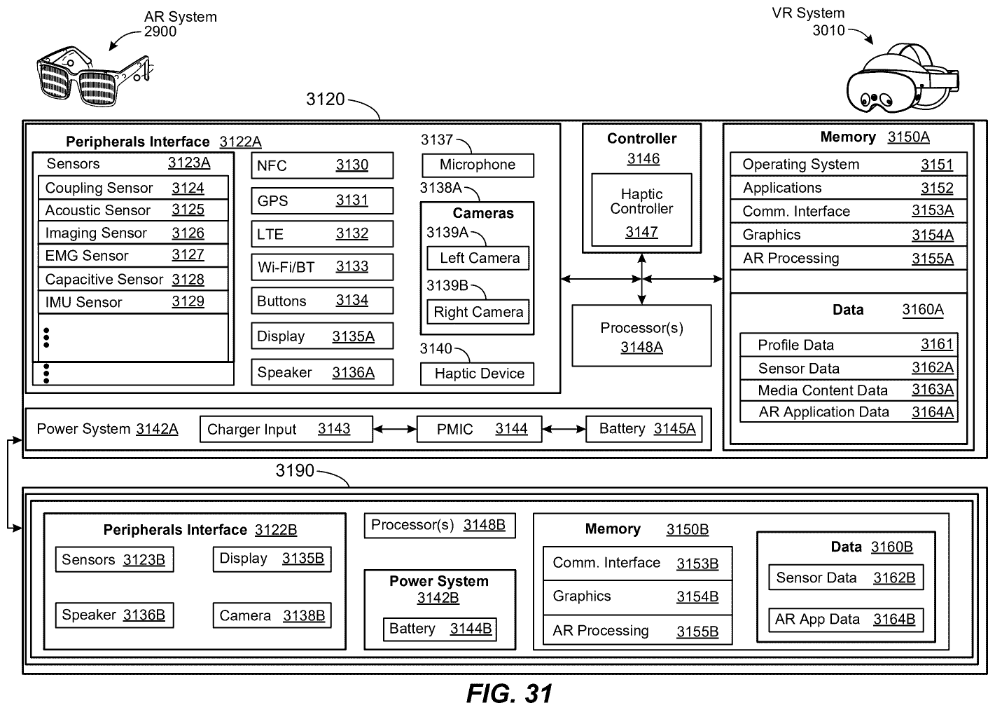

FIGS. 29 to 31 show example artificial-reality systems, which can be used as or in connection with wrist-wearable device 2700. In some embodiments, AR system 2900 includes an eyewear device 2902, as shown in FIG. 29. In some embodiments, VR system 3010 includes a head-mounted display (HMD) 3012, as shown in FIGS. 30A and 30B. In some embodiments, AR system 2900 and VR system 3010 can include one or more analogous components (e.g., components for presenting interactive artificial-reality environments, such as processors, memory, and/or presentation devices, including one or more displays and/or one or more waveguides), some of which are described in more detail with respect to FIG. 31. As described herein, a head-wearable device can include components of eyewear device 2902 and/or head-mounted display 3012. Some embodiments of head-wearable devices do not include any displays, including any of the displays described with respect to AR system 2900 and/or VR system 3010. While the example artificial-reality systems are respectively described herein as AR system 2900 and VR system 3010, either or both of the example AR systems described herein can be configured to present fully-immersive virtual-reality scenes presented in substantially all of a user's field of view or subtler augmented-reality scenes that are presented within a portion, less than all, of the user's field of view.

FIG. 29 show an example visual depiction of AR system 2900, including an eyewear device 2902 (which may also be described herein as augmented-reality glasses, and/or smart glasses). AR system 2900 can include additional electronic components that are not shown in FIG. 29, such as a wearable accessory device and/or an intermediary processing device, in electronic communication or otherwise configured to be used in conjunction with the eyewear device 2902. In some embodiments, the wearable accessory device and/or the intermediary processing device may be configured to couple with eyewear device 2902 via a coupling mechanism in electronic communication with a coupling sensor 3124 (FIG. 31), where coupling sensor 3124 can detect when an electronic device becomes physically or electronically coupled with eyewear device 2902. In some embodiments, eyewear device 2902 can be configured to couple to a housing 3190 (FIG. 31), which may include one or more additional coupling mechanisms configured to couple with additional accessory devices. The components shown in FIG. 29 can be implemented in hardware, software, firmware, or a combination thereof, including one or more signal-processing components and/or application-specific integrated circuits (ASICs).

Eyewear device 2902 includes mechanical glasses components, including a frame 2904 configured to hold one or more lenses (e.g., one or both lenses 2906-1 and 2906-2). One of ordinary skill in the art will appreciate that eyewear device 2902 can include additional mechanical components, such as hinges configured to allow portions of frame 2904 of eyewear device 2902 to be folded and unfolded, a bridge configured to span the gap between lenses 2906-1 and 2906-2 and rest on the user's nose, nose pads configured to rest on the bridge of the nose and provide support for eyewear device 2902, earpieces configured to rest on the user's ears and provide additional support for eyewear device 2902, temple arms configured to extend from the hinges to the earpieces of eyewear device 2902, and the like. One of ordinary skill in the art will further appreciate that some examples of AR system 2900 can include none of the mechanical components described herein. For example, smart contact lenses configured to present artificial reality to users may not include any components of eyewear device 2902.

Eyewear device 2902 includes electronic components, many of which will be described in more detail below with respect to FIG. 10. Some example electronic components are illustrated in FIG. 29, including acoustic sensors 2925-1, 2925-2, 2925-3, 2925-4, 2925-5, and 2925-6, which can be distributed along a substantial portion of the frame 2904 of eyewear device 2902. Eyewear device 2902 also includes a left camera 2939A and a right camera 2939B, which are located on different sides of the frame 2904. Eyewear device 2902 also includes a processor 2948 (or any other suitable type or form of integrated circuit) that is embedded into a portion of the frame 2904.

FIGS. 30A and 30B show a VR system 3010 that includes a head-mounted display (HMD) 3012 (e.g., also referred to herein as an artificial-reality headset, a head-wearable device, a VR headset, etc.), in accordance with some embodiments. As noted, some artificial-reality systems (e.g., AR system 2900) may, instead of blending an artificial reality with actual reality, substantially replace one or more of a user's visual and/or other sensory perceptions of the real world with a virtual experience (e.g., AR systems 2500 and 2600).

HMD 3012 includes a front body 3014 and a frame 3016 (e.g., a strap or band) shaped to fit around a user's head. In some embodiments, front body 3014 and/or frame 3016 include one or more electronic elements for facilitating presentation of and/or interactions with an AR and/or VR system (e.g., displays, IMUs, tracking emitter or detectors). In some embodiments, HMD 3012 includes output audio transducers (e.g., an audio transducer 3018), as shown in FIG. 30B. In some embodiments, one or more components, such as the output audio transducer(s) 3018 and frame 3016, can be configured to attach and detach (e.g., are detachably attachable) to HMD 3012 (e.g., a portion or all of frame 3016, and/or audio transducer 3018), as shown in FIG. 30B. In some embodiments, coupling a detachable component to HMD 3012 causes the detachable component to come into electronic communication with HMD 3012.

FIGS. 30A and 30B also show that VR system 3010 includes one or more cameras, such as left camera 3039A and right camera 3039B, which can be analogous to left and right cameras 2939A and 2939B on frame 2904 of eyewear device 2902. In some embodiments, VR system 3010 includes one or more additional cameras (e.g., cameras 3039C and 3039D), which can be configured to augment image data obtained by left and right cameras 3039A and 3039B by providing more information. For example, camera 3039C can be used to supply color information that is not discerned by cameras 3039A and 3039B. In some embodiments, one or more of cameras 3039A to 3039D can include an optional IR cut filter configured to remove IR light from being received at the respective camera sensors.

FIG. 31 illustrates a computing system 3120 and an optional housing 3190, each of which show components that can be included in AR system 2900 and/or VR system 3010. In some embodiments, more or fewer components can be included in optional housing 3190 depending on practical restraints of the respective AR system being described.

In some embodiments, computing system 3120 can include one or more peripherals interfaces 3122A and/or optional housing 3190 can include one or more peripherals interfaces 3122B. Each of computing system 3120 and optional housing 3190 can also include one or more power systems 3142A and 3142B, one or more controllers 3146 (including one or more haptic controllers 3147), one or more processors 3148A and 3148B (as defined above, including any of the examples provided), and memory 3150A and 3150B, which can all be in electronic communication with each other. For example, the one or more processors 3148A and 3148B can be configured to execute instructions stored in memory 3150A and 3150B, which can cause a controller of one or more of controllers 3146 to cause operations to be performed at one or more peripheral devices connected to peripherals interface 3122A and/or 3122B. In some embodiments, each operation described can be powered by electrical power provided by power system 3142A and/or 3142B.

In some embodiments, peripherals interface 3122A can include one or more devices configured to be part of computing system 3120, some of which have been defined above and/or described with respect to the wrist-wearable devices shown in FIGS. 27 and 28. For example, peripherals interface 3122A can include one or more sensors 3123A. Some example sensors 3123A include one or more coupling sensors 3124, one or more acoustic sensors 3125, one or more imaging sensors 3126, one or more EMG sensors 3127, one or more capacitive sensors 3128, one or more IMU sensors 3129, and/or any other types of sensors explained above or described with respect to any other embodiments discussed herein.

In some embodiments, peripherals interfaces 3122A and 3122B can include one or more additional peripheral devices, including one or more NFC devices 3130, one or more GPS devices 3131, one or more LTE devices 3132, one or more Wi-Fi and/or Bluetooth devices 3133, one or more buttons 3134 (e.g., including buttons that are slidable or otherwise adjustable), one or more displays 3135A and 3135B, one or more speakers 3136A and 3136B, one or more microphones 3137, one or more cameras 3138A and 3138B (e.g., including the left camera 3139A and/or a right camera 3139B), one or more haptic devices 3140, and/or any other types of peripheral devices defined above or described with respect to any other embodiments discussed herein.

AR systems can include a variety of types of visual feedback mechanisms (e.g., presentation devices). For example, display devices in AR system 2900 and/or VR system 3010 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 3135A and 3135B can be coupled to each of the lenses 2906-1 and 2906-2 of AR system 2900. Displays 3135A and 3135B may be coupled to each of lenses 2906-1 and 2906-2, which can act together or independently to present an image or series of images to a user. In some embodiments, AR system 2900 includes a single display 3135A or 3135B (e.g., a near-eye display) or more than two displays 3135A and 3135B. In some embodiments, a first set of one or more displays 3135A and 3135B can be used to present an augmented-reality environment, and a second set of one or more display devices 3135A and 3135B can be used to present a virtual-reality environment. In some embodiments, one or more waveguides are used in conjunction with presenting artificial-reality content to the user of AR system 2900 (e.g., as a means of delivering light from one or more displays 3135A and 3135B to the user's eyes). In some embodiments, one or more waveguides are fully or partially integrated into the eyewear device 2902. Additionally, or alternatively to display screens, some artificial-reality systems include one or more projection systems. For example, display devices in AR system 2900 and/or VR system 3010 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 3135A and 3135B.

Computing system 3120 and/or optional housing 3190 of AR system 2900 or VR system 3010 can include some or all of the components of a power system 3142A and 3142B. Power systems 3142A and 3142B can include one or more charger inputs 3143, one or more PMICs 3144, and/or one or more batteries 3145A and 3144B.

Memory 3150A and 3150B may include instructions and data, some or all of which may be stored as non-transitory computer-readable storage media within the memories 3150A and 3150B. For example, memory 3150A and 3150B can include one or more operating systems 3151, one or more applications 3152, one or more communication interface applications 3153A and 3153B, one or more graphics applications 3154A and 3154B, one or more AR processing applications 3155A and 3155B, and/or any other types of data defined above or described with respect to any other embodiments discussed herein.

Memory 3150A and 3150B also include data 3160A and 3160B, which can be used in conjunction with one or more of the applications discussed above. Data 3160A and 3160B can include profile data 3161, sensor data 3162A and 3162B, media content data 3163A, AR application data 3164A and 3164B, and/or any other types of data defined above or described with respect to any other embodiments discussed herein.

In some embodiments, controller 3146 of eyewear device 2902 may process information generated by sensors 3123A and/or 3123B on eyewear device 2902 and/or another electronic device within AR system 2900. For example, controller 3146 can process information from acoustic sensors 2925-1 and 2925-2. For each detected sound, controller 3146 can perform a direction of arrival (DOA) estimation to estimate a direction from which the detected sound arrived at eyewear device 2902 of R system 2900. As one or more of acoustic sensors 3125 (e.g., the acoustic sensors 2925-1, 2925-2) detects sounds, controller 3146 can populate an audio data set with the information (e.g., represented in FIG. 10 as sensor data 3162A and 3162B).

In some embodiments, a physical electronic connector can convey information between eyewear device 2902 and another electronic device and/or between one or more processors 2948, 3148A, 3148B of AR system 2900 or VR system 3010 and controller 3146. The information can be in the form of optical data, electrical data, wireless data, or any other transmittable data form. Moving the processing of information generated by eyewear device 2902 to an intermediary processing device can reduce weight and heat in the eyewear device, making it more comfortable and safer for a user. In some embodiments, an optional wearable accessory device (e.g., an electronic neckband) is coupled to eyewear device 2902 via one or more connectors. The connectors can be wired or wireless connectors and can include electrical and/or non-electrical (e.g., structural) components. In some embodiments, eyewear device 2902 and the wearable accessory device can operate independently without any wired or wireless connection between them.

In some situations, pairing external devices, such as an intermediary processing device (e.g., HIPD 2306, 2406, 2506) with eyewear device 2902 (e.g., as part of AR system 2900) enables eyewear device 2902 to achieve a similar form factor of a pair of glasses while still providing sufficient battery and computation power for expanded capabilities. Some, or all, of the battery power, computational resources, and/or additional features of AR system 2900 can be provided by a paired device or shared between a paired device and eyewear device 2902, thus reducing the weight, heat profile, and form factor of eyewear device 2902 overall while allowing eyewear device 2902 to retain its desired functionality. For example, the wearable accessory device can allow components that would otherwise be included on eyewear device 2902 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2902 standing alone. Because weight carried in the wearable accessory device can be less invasive to a user than weight carried in the eyewear device 2902, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2900 and/or VR system 3010 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 30A and 30B show VR system 3010 having cameras 3039A to 3039D, which can be used to provide depth information for creating a voxel field and a two-dimensional mesh to provide object information to the user to avoid collisions.

In some embodiments, AR system 2900 and/or VR system 3010 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2900 and/or VR system 3010, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

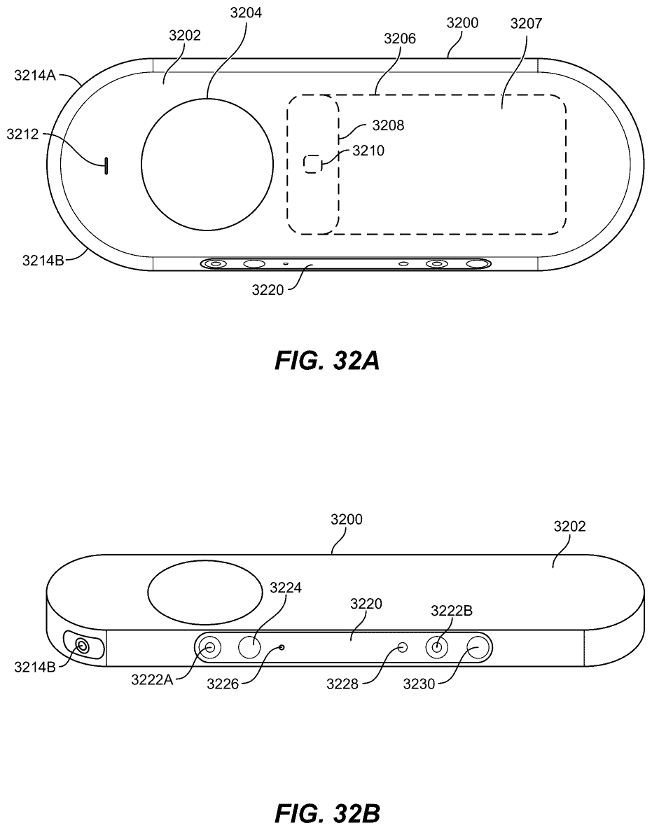

FIGS. 32A and 32B illustrate an example handheld intermediary processing device (HIPD) 3200 in accordance with some embodiments. HIPD 3200 is an instance of the intermediary device described herein, such that HIPD 3200 should be understood to have the features described with respect to any intermediary device defined above or otherwise described herein and vice versa. FIG. 32A shows a top view and FIG. 32B shows a side view of the HIPD 3200. HIPD 3200 is configured to communicatively couple with one or more wearable devices (or other electronic devices) associated with a user. For example, HIPD 3200 is configured to communicatively couple with a user's wrist-wearable device 2302, 2402 (or components thereof, such as watch body 2720 and wearable band 2710), AR glasses 2900, and/or VR headset 2550 and 3000. HIPD 3200 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 3200 can successfully be communicatively coupled with an electronic device, such as a wearable device).

HIPD 3200 can perform various functions independently and/or in conjunction with one or more wearable devices (e.g., wrist-wearable device 2302, AR glasses 2900, VR system 3010, etc.). HIPD 3200 can be configured to increase and/or improve the functionality of communicatively coupled devices, such as the wearable devices. HIPD 3200 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 23-25B. Additionally, as will be described in more detail below, functionality and/or operations of HIPD 3200 can include, without limitation, task offloading and/or handoffs; thermals offloading and/or handoffs; six degrees of freedom (6DoF) raycasting and/or gaming (e.g., using imaging devices or cameras 3214A, 3214B, which can be used for simultaneous localization and mapping (SLAM) and/or with other image processing techniques), portable charging, messaging, image capturing via one or more imaging devices or cameras 3222A and 3222B, sensing user input (e.g., sensing a touch on a touch input surface 3202), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 3200 and/or in communication between HIPD 3200 and another wearable device described herein. In some embodiments, functions can be executed on HIPD 3200 in conjunction with an AR environment. As the skilled artisan will appreciate upon reading the descriptions provided herein that HIPD 3200 can be used with any type of suitable AR environment.

While HIPD 3200 is communicatively coupled with a wearable device and/or other electronic device, HIPD 3200 is configured to perform one or more operations initiated at the wearable device and/or the other electronic device. In particular, one or more operations of the wearable device and/or the other electronic device can be offloaded to HIPD 3200 to be performed. HIPD 3200 performs the one or more operations of the wearable device and/or the other electronic device and provides to data corresponded to the completed operations to the wearable device and/or the other electronic device. For example, a user can initiate a video stream using AR glasses 2900 and back-end tasks associated with performing the video stream (e.g., video rendering) can be offloaded to HIPD 3200, which HIPD 3200 performs and provides corresponding data to AR glasses 2900 to perform remaining front-end tasks associated with the video stream (e.g., presenting the rendered video data via a display of AR glasses 2900). In this way, HIPD 3200, which has more computational resources and greater thermal headroom than a wearable device, can perform computationally intensive tasks for the wearable device, thereby improving performance of an operation performed by the wearable device.

HIPD 3200 includes a multi-touch input surface 3202 on a first side (e.g., a front surface) that is configured to detect one or more user inputs. In particular, multi-touch input surface 3202 can detect single tap inputs, multi-tap inputs, swipe gestures and/or inputs, force-based and/or pressure-based touch inputs, held taps, and the like. Multi-touch input surface 3202 is configured to detect capacitive touch inputs and/or force (and/or pressure) touch inputs. Multi-touch input surface 3202 includes a first touch-input surface 3204 defined by a surface depression and a second touch-input surface 3206 defined by a substantially planar portion. First touch-input surface 3204 can be disposed adjacent to second touch-input surface 3206. In some embodiments, first touch-input surface 3204 and second touch-input surface 3206 can be different dimensions and/or shapes. For example, first touch-input surface 3204 can be substantially circular and second touch-input surface 3206 can be substantially rectangular. In some embodiments, the surface depression of multi-touch input surface 3202 is configured to guide user handling of HIPD 3200. In particular, the surface depression can be configured such that the user holds HIPD 3200 upright when held in a single hand (e.g., such that the using imaging devices or cameras 3214A and 3214B are pointed toward a ceiling or the sky). Additionally, the surface depression is configured such that the user's thumb rests within first touch-input surface 3204.

In some embodiments, the different touch-input surfaces include a plurality of touch-input zones. For example, second touch-input surface 3206 includes at least a second touch-input zone 3208 within a first touch-input zone 3207 and a third touch-input zone 3210 within second touch-input zone 3208. In some embodiments, one or more of touch-input zones 3208 and 3210 are optional and/or user defined (e.g., a user can specific a touch-input zone based on their preferences). In some embodiments, each touch-input surface 3204 and 3206 and/or touch-input zone 3208 and 3210 are associated with a predetermined set of commands. For example, a user input detected within first touch-input zone 3208 may cause HIPD 3200 to perform a first command and a user input detected within second touch-input surface 3206 may cause HIPD 3200 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 3208 can be configured to detect force touch inputs (e.g., a magnitude at which the user presses down) and capacitive touch inputs, and second touch-input zone 3210 can be configured to detect capacitive touch inputs.

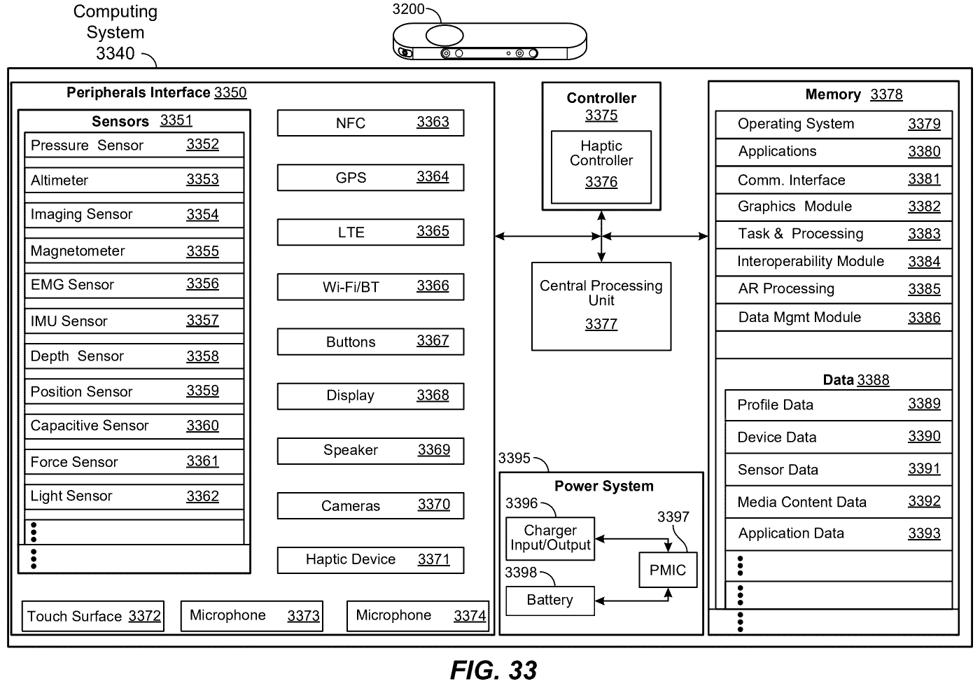

As shown in FIG. 33, HIPD 3200 includes one or more sensors 3351 for sensing data used in the performance of one or more operations and/or functions. For example, HIPD 3200 can include an IMU sensor that is used in conjunction with cameras 3214A, 3214B (FIGS. 32A-32B) for 3-dimensional object manipulation (e.g., enlarging, moving, destroying, etc., an object) in an AR or VR environment. Non-limiting examples of sensors 3351 included in HIPD 3200 include a light sensor, a magnetometer, a depth sensor, a pressure sensor, and a force sensor.

HIPD 3200 can include one or more light indicators 3212 to provide one or more notifications to the user. In some embodiments, light indicators 3212 are LEDs or other types of illumination devices. Light indicators 3212 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 3204. Light indicators 3212 can be illuminated in different colors and/or patterns to provide the user with one or more notifications and/or information about the device. For example, a light indicator positioned around first touch-input surface 3204 may flash when the user receives a notification (e.g., a message), change red when HIPD 3200 is out of power, operate as a progress bar (e.g., a light ring that is closed when a task is completed (e.g., 0% to 100%)), operate as a volume indicator, etc.

In some embodiments, HIPD 3200 includes one or more additional sensors on another surface. For example, as shown FIG. 32A, HIPD 3200 includes a set of one or more sensors (e.g., sensor set 3220) on an edge of HIPD 3200. Sensor set 3220, when positioned on an edge of the of HIPD 3200, can be pe positioned at a predetermined tilt angle (e.g., 26 degrees), which allows sensor set 3220 to be angled toward the user when placed on a desk or other flat surface. Alternatively, in some embodiments, sensor set 3220 is positioned on a surface opposite the multi-touch input surface 3202 (e.g., a back surface). The one or more sensors of sensor set 3220 are discussed in further detail below.

The side view of the of HIPD 3200 in FIG. 32B shows sensor set 3220 and camera 3214B. Sensor set 3220 can include one or more cameras 3222A and 3222B, a depth projector 3224, an ambient light sensor 3228, and a depth receiver 3230. In some embodiments, sensor set 3220 includes a light indicator 3226. Light indicator 3226 can operate as a privacy indicator to let the user and/or those around them know that a camera and/or microphone is active. Sensor set 3220 is configured to capture a user's facial expression such that the user can puppet a custom avatar (e.g., showing emotions, such as smiles, laughter, etc., on the avatar or a digital representation of the user). Sensor set 3220 can be configured as a side stereo RGB system, a rear indirect Time-of-Flight (iToF) system, or a rear stereo RGB system. As the skilled artisan will appreciate upon reading the descriptions provided herein, HIPD 3200 described herein can use different sensor set 3220 configurations and/or sensor set 3220 placement.

Turning to FIG. 33, in some embodiments, a computing system 3340 of HIPD 3200 can include one or more haptic devices 3371 (e.g., a vibratory haptic actuator) that are configured to provide haptic feedback (e.g., kinesthetic sensation). Sensors 3351 and/or the haptic devices 3371 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 3200 is configured to operate without a display. However, optionally, computing system 3340 of the HIPD 3200 can include a display 3368. HIPD 3200 can also include one or more optional peripheral buttons 3367. For example, peripheral buttons 3367 can be used to turn on or turn off HIPD 3200. Further, HIPD 3200 housing can be formed of polymers and/or elastomers. In other words, HIPD 3200 may be designed such that it would not easily slide off a surface. In some embodiments, HIPD 3200 includes one or magnets to couple HIPD 3200 to another surface. This allows the user to mount HIPD 3200 to different surfaces and provide the user with greater flexibility in use of HIPD 3200.

As described above, HIPD 3200 can distribute and/or provide instructions for performing the one or more tasks at HIPD 3200 and/or a communicatively coupled device. For example, HIPD 3200 can identify one or more back-end tasks to be performed by HIPD 3200 and one or more front-end tasks to be performed by a communicatively coupled device. While HIPD 3200 is configured to offload and/or handoff tasks of a communicatively coupled device, HIPD 3200 can perform both back-end and front-end tasks (e.g., via one or more processors, such as CPU 3377). HIPD 3200 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 3200 can perform the above operations alone or in conjunction with a wearable device (or other communicatively coupled electronic device).

FIG. 33 shows a block diagram of a computing system 3340 of HIPD 3200 in accordance with some embodiments. HIPD 3200, described in detail above, can include one or more components shown in HIPD computing system 3340. HIPD 3200 will be understood to include the components shown and described below for HIPD computing system 3340. In some embodiments, all, or a substantial portion of the components of HIPD computing system 3340 are included in a single integrated circuit. Alternatively, in some embodiments, components of HIPD computing system 3340 are included in a plurality of integrated circuits that are communicatively coupled.

HIPD computing system 3340 can include a processor (e.g., a CPU 3377, a GPU, and/or a CPU with integrated graphics), a controller 3375, a peripherals interface 3350 that includes one or more sensors 3351 and other peripheral devices, a power source (e.g., a power system 3395), and memory (e.g., a memory 3378) that includes an operating system (e.g., an operating system 3379), data (e.g., data 3388), one or more applications (e.g., applications 3380), and one or more modules (e.g., a communications interface module 3381, a graphics module 3382, a task and processing management module 3383, an interoperability module 3384, an AR processing module 3385, a data management module 3386, etc.). HIPD computing system 3340 further includes a power system 3395 that includes a charger input and output 3396, a PMIC 3397, and a battery 3398, all of which are defined above.

In some embodiments, peripherals interface 3350 can include one or more sensors 3351. Sensors 3351 can include analogous sensors to those described above in reference to FIG. 27. For example, sensors 3351 can include imaging sensors 3354, (optional) EMG sensors 3356, IMU sensors 3358, and capacitive sensors 3360. In some embodiments, sensors 3351 can include one or more pressure sensors 3352 for sensing pressure data, an altimeter 3353 for sensing an altitude of the HIPD 3200, a magnetometer 3355 for sensing a magnetic field, a depth sensor 3357 (or a time-of flight sensor) for determining a difference between the camera and the subject of an image, a position sensor 3359 (e.g., a flexible position sensor) for sensing a relative displacement or position change of a portion of the HIPD 3200, a force sensor 3361 for sensing a force applied to a portion of the HIPD 3200, and a light sensor 3362 (e.g., an ambient light sensor) for detecting an amount of lighting. Sensors 3351 can include one or more sensors not shown in FIG. 33.

Analogous to the peripherals described above in reference to FIG. 27, peripherals interface 3350 can also include an NFC component 3363, a GPS component 3364, an LTE component 3365, a Wi-Fi and/or Bluetooth communication component 3366, a speaker 3369, a haptic device 3371, and a microphone 3373. As noted above, HIPD 3200 can optionally include a display 3368 and/or one or more peripheral buttons 3367. Peripherals interface 3350 can further include one or more cameras 3370, touch surfaces 3372, and/or one or more light emitters 3374. Multi-touch input surface 3202 described above in reference to FIGS. 32A and 32B is an example of touch surface 3372. Light emitters 3374 can be one or more LEDs, lasers, etc. and can be used to project or present information to a user. For example, light emitters 3374 can include light indicators 3212 and 3226 described above in reference to FIGS. 32A and 32B. Cameras 3370 (e.g., cameras 3214A, 3214B, 3222A, and 3222B described above in reference to FIGS. 32A and 32B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 3370 can be used for SLAM, 6DoF ray casting, gaming, object manipulation and/or other rendering, facial recognition and facial expression recognition, etc.

Similar to watch body computing system 2860 and watch band computing system 2830 described above in reference to FIG. 28, HIPD computing system 3340 can include one or more haptic controllers 3376 and associated componentry (e.g., haptic devices 3371) for providing haptic events at HIPD 3200.

Memory 3378 can include high-speed random-access memory and/or non-volatile memory, such as one or more magnetic disk storage devices, flash memory devices, or other non-volatile solid-state memory devices. Access to memory 3378 by other components of HIPD 3200, such as the one or more processors and peripherals interface 3350, can be controlled by a memory controller of controllers 3375.

In some embodiments, software components stored in memory 3378 include one or more operating systems 3379, one or more applications 3380, one or more communication interface modules 3381, one or more graphics modules 3382, and/or one or more data management modules 3386, which are analogous to the software components described above in reference to FIG. 27.

In some embodiments, software components stored in memory 3378 include a task and processing management module 3383 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 3383 uses data 3388 (e.g., device data 3390) to distribute the one or more front-end and/or back-end tasks based on communicatively coupled devices' computing resources, available power, thermal headroom, ongoing operations, and/or other factors. For example, task and processing management module 3383 can cause the performance of one or more back-end tasks (of an operation performed at communicatively coupled AR system 2900) at HIPD 3200 in accordance with a determination that the operation is utilizing a predetermined amount (e.g., at least 70%) of computing resources available at AR system 2900.

In some embodiments, software components stored in memory 3378 include an interoperability module 3384 for exchanging and utilizing information received and/or provided to distinct communicatively coupled devices. Interoperability module 3384 allows for different systems, devices, and/or applications to connect and communicate in a coordinated way without user input. In some embodiments, software components stored in memory 3378 include an AR processing module 3385 that is configured to process signals based at least on sensor data for use in an AR and/or VR environment. For example, AR processing module 3385 can be used for 3D object manipulation, gesture recognition, facial and facial expression recognition, etc.

Memory 3378 can also include data 3388. In some embodiments, data 3388 can include profile data 3389, device data 3390 (including device data of one or more devices communicatively coupled with HIPD 3200, such as device type, hardware, software, configurations, etc.), sensor data 3391, media content data 3392, and application data 3393.

It should be appreciated that HIPD computing system 3340 is an example of a computing system within HIPD 3200, and that HIPD 3200 can have more or fewer components than shown in HIPD computing system 3340, combine two or more components, and/or have a different configuration and/or arrangement of the components. The various components shown HIPD computing system 3340 are implemented in hardware, software, firmware, or a combination thereof, including one or more signal processing and/or application-specific integrated circuits.

The techniques described above in FIGS. 32A, 32B, and 33 can be used with any device used as a human-machine interface controller. In some embodiments, an HIPD 3200 can be used in conjunction with one or more wearable device such as a head-wearable device (e.g., AR system 2900 and VR system 3010) and/or a wrist-wearable device 2700 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

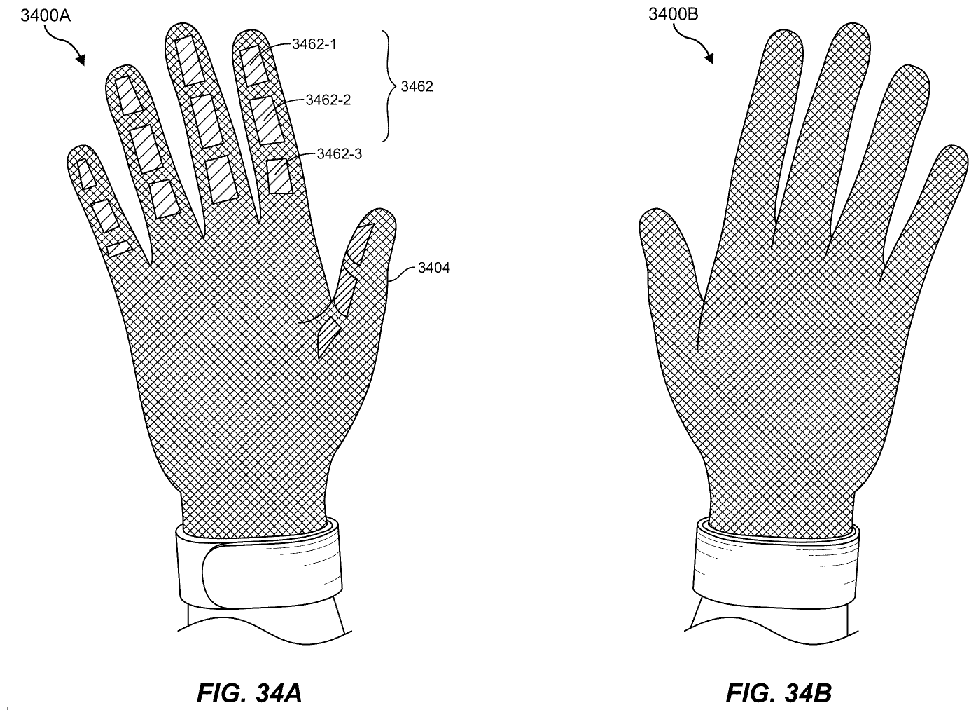

FIGS. 34A and 34B show example haptic feedback systems (e.g., hand-wearable devices) for providing feedback to a user regarding the user's interactions with a computing system (e.g., an artificial-reality environment presented by the AR system 2900 or the VR system 3010). In some embodiments, a computing system (e.g., the AR systems 2500 and/or 2600) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 3462 of haptic device 3400 (e.g., haptic assemblies 3462-1, 3462-2, 3462-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 3400 can change (either directly or indirectly) a pressurized state of one or more of haptic assemblies 3462.

Vibrotactile system 3400 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 3462 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 34A and 34B, each of haptic assemblies 3462 may include a mechanism that, at a minimum, provides resistance when the respective haptic assembly 3462 is transitioned from a first pressurized state (e.g., atmospheric pressure or deflated) to a second pressurized state (e.g., inflated to a threshold pressure). Structures of haptic assemblies 3462 can be integrated into various devices configured to be in contact or proximity to a user's skin, including, but not limited to devices such as glove worn devices, body worn clothing device, headset devices.

As noted above, haptic assemblies 3462 described herein can be configured to transition between a first pressurized state and a second pressurized state to provide haptic feedback to the user. Due to the ever-changing nature of artificial-reality, haptic assemblies 3462 may be required to transition between the two states hundreds, or perhaps thousands of times, during a single use. Thus, haptic assemblies 3462 described herein are durable and designed to quickly transition from state to state. To provide some context, in the first pressurized state, haptic assemblies 3462 do not impede free movement of a portion of the wearer's body. For example, one or more haptic assemblies 3462 incorporated into a glove are made from flexible materials that do not impede free movement of the wearer's hand and fingers (e.g., an electrostatic-zipping actuator). Haptic assemblies 3462 may be configured to conform to a shape of the portion of the wearer's body when in the first pressurized state. However, once in the second pressurized state, haptic assemblies 3462 can be configured to restrict and/or impede free movement of the portion of the wearer's body (e.g., appendages of the user's hand). For example, the respective haptic assembly 3462 (or multiple respective haptic assemblies) can restrict movement of a wearer's finger (e.g., prevent the finger from curling or extending) when haptic assembly 3462 is in the second pressurized state. Moreover, once in the second pressurized state, haptic assemblies 3462 may take different shapes, with some haptic assemblies 3462 configured to take a planar, rigid shape (e.g., flat and rigid), while some other haptic assemblies 3462 are configured to curve or bend, at least partially.

As a non-limiting example, haptic device 3400 includes a plurality of haptic devices (e.g., a pair of haptic gloves, a haptics component of a wrist-wearable device (e.g., any of the wrist-wearable devices described with respect to FIGS. 23-27), etc.), each of which can include a garment component (e.g., a garment 3404) and one or more haptic assemblies coupled (e.g., physically coupled) to the garment component. For example, each of the haptic assemblies 3462-1, 3462-2, 3462-3, . . . 3462-N are physically coupled to the garment 3404 and are configured to contact respective phalanges of a user's thumb and fingers. As explained above, haptic assemblies 3462 are configured to provide haptic simulations to a wearer of device 3400. Garment 3404 of each device 3400 can be one of various articles of clothing (e.g., gloves, socks, shirts, pants, etc.). Thus, a user may wear multiple haptic devices 3400 that are each configured to provide haptic stimulations to respective parts of the body where haptic devices 3400 are being worn.

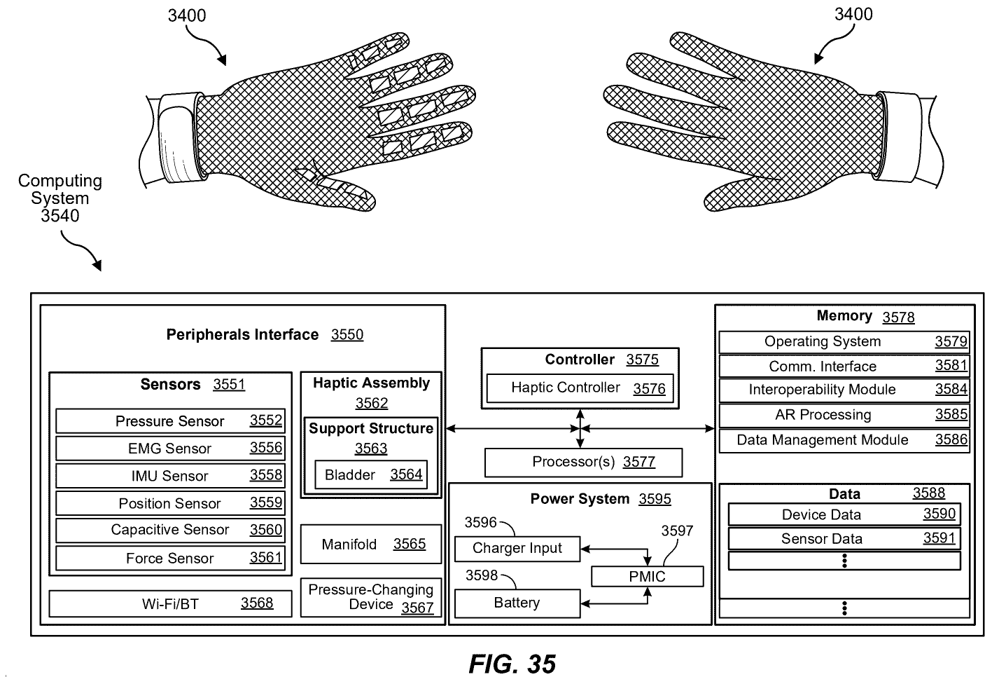

FIG. 35 shows block diagrams of a computing system 3540 of haptic device 3400, in accordance with some embodiments. Computing system 3540 can include one or more peripherals interfaces 3550, one or more power systems 3595, one or more controllers 3575 (including one or more haptic controllers 3576), one or more processors 3577 (as defined above, including any of the examples provided), and memory 3578, which can all be in electronic communication with each other. For example, one or more processors 3577 can be configured to execute instructions stored in the memory 3578, which can cause a controller of the one or more controllers 3575 to cause operations to be performed at one or more peripheral devices of peripherals interface 3550. In some embodiments, each operation described can occur based on electrical power provided by the power system 3595. The power system 3595 can include a charger input 3596, a PMIC 3597, and a battery 3598.

In some embodiments, peripherals interface 3550 can include one or more devices configured to be part of computing system 3540, many of which have been defined above and/or described with respect to wrist-wearable devices shown in FIGS. 27 and 28. For example, peripherals interface 3550 can include one or more sensors 3551. Some example sensors include: one or more pressure sensors 3552, one or more EMG sensors 3556, one or more IMU sensors 3558, one or more position sensors 3559, one or more capacitive sensors 3560, one or more force sensors 3561; and/or any other types of sensors defined above or described with respect to any other embodiments discussed herein.

In some embodiments, the peripherals interface can include one or more additional peripheral devices, including one or more Wi-Fi and/or Bluetooth devices 3568; one or more haptic assemblies 3562; one or more support structures 3563 (which can include one or more bladders 3564; one or more manifolds 3565; one or more pressure-changing devices 3567; and/or any other types of peripheral devices defined above or described with respect to any other embodiments discussed herein.

In some embodiments, each haptic assembly 3562 includes a support structure 3563 and at least one bladder 3564. Bladder 3564 (e.g., a membrane) may be a sealed, inflatable pocket made from a durable and puncture-resistant material, such as thermoplastic polyurethane (TPU), a flexible polymer, or the like. Bladder 3564 contains a medium (e.g., a fluid such as air, inert gas, or even a liquid) that can be added to or removed from bladder 3564 to change a pressure (e.g., fluid pressure) inside the bladder 3564. Support structure 3563 is made from a material that is stronger and stiffer than the material of bladder 3564. A respective support structure 3563 coupled to a respective bladder 3564 is configured to reinforce the respective bladder 3564 as the respective bladder 3564 changes shape and size due to changes in pressure (e.g., fluid pressure) inside the bladder.

The system 3540 also includes a haptic controller 3576 and a pressure-changing device 3567. In some embodiments, haptic controller 3576 is part of the computer system 3540 (e.g., in electronic communication with one or more processors 3577 of the computer system 3540). Haptic controller 3576 is configured to control operation of pressure-changing device 3567, and in turn operation of haptic device 3400. For example, haptic controller 3576 sends one or more signals to pressure-changing device 3567 to activate pressure-changing device 3567 (e.g., turn it on and off). The one or more signals may specify a desired pressure (e.g., pounds-per-square inch) to be output by pressure-changing device 3567. Generation of the one or more signals, and in turn the pressure output by pressure-changing device 3567, may be based on information collected by sensors 3551. For example, the one or more signals may cause pressure-changing device 3567 to increase the pressure (e.g., fluid pressure) inside a first haptic assembly 3562 at a first time, based on the information collected by sensors 3551 (e.g., the user makes contact with an artificial coffee mug or other artificial object). Then, the controller may send one or more additional signals to pressure-changing device 3567 that cause pressure-changing device 3567 to further increase the pressure inside first haptic assembly 3562 at a second time after the first time, based on additional information collected by sensors 3551. Further, the one or more signals may cause pressure-changing device 3567 to inflate one or more bladders 3564 in a first device 3400A, while one or more bladders 3564 in a second device 3400B remain unchanged. Additionally, the one or more signals may cause pressure-changing device 3567 to inflate one or more bladders 3564 in a first device 3400A to a first pressure and inflate one or more other bladders 3564 in first device 3400A to a second pressure different from the first pressure. Depending on number of devices 3400 serviced by pressure-changing device 3567, and the number of bladders therein, many different inflation configurations can be achieved through the one or more signals and the examples above are not meant to be limiting.

The system 3540 may include an optional manifold 3565 between pressure-changing device 3567 and haptic devices 3400. Manifold 3565 may include one or more valves (not shown) that pneumatically couple each of haptic assemblies 3562 with pressure-changing device 3567 via tubing. In some embodiments, manifold 3565 is in communication with controller 3575, and controller 3575 controls the one or more valves of manifold 3565 (e.g., the controller generates one or more control signals). Manifold 3565 is configured to switchably couple pressure-changing device 3567 with one or more haptic assemblies 3562 of the same or different haptic devices 3400 based on one or more control signals from controller 3575. In some embodiments, instead of using manifold 3565 to pneumatically couple pressure-changing device 3567 with haptic assemblies 3562, system 3540 may include multiple pressure-changing devices 3567, where each pressure-changing device 3567 is pneumatically coupled directly with a single haptic assembly 3562 or multiple haptic assemblies 3562. In some embodiments, pressure-changing device 3567 and optional manifold 3565 can be configured as part of one or more of the haptic devices 3400 while, in other embodiments, pressure-changing device 3567 and optional manifold 3565 can be configured as external to haptic device 3400. A single pressure-changing device 3567 may be shared by multiple haptic devices 3400.

In some embodiments, pressure-changing device 3567 is a pneumatic device, hydraulic device, a pneudraulic device, or some other device capable of adding and removing a medium (e.g., fluid, liquid, gas) from the one or more haptic assemblies 3562.

The devices shown in FIGS. 34A-35 may be coupled via a wired connection (e.g., via busing). Alternatively, one or more of the devices shown in FIGS. 34A-35 may be wirelessly connected (e.g., via short-range communication signals).

Memory 3578 includes instructions and data, some or all of which may be stored as non-transitory computer-readable storage media within memory 3578. For example, memory 3578 can include one or more operating systems 3579; one or more communication interface applications 3581; one or more interoperability modules 3584; one or more AR processing applications 3585; one or more data management modules 3586; and/or any other types of applications or modules defined above or described with respect to any other embodiments discussed herein.

Memory 3578 also includes data 3588 which can be used in conjunction with one or more of the applications discussed above. Data 3588 can include: device data 3590; sensor data 3591; and/or any other types of data defined above or described with respect to any other embodiments discussed herein.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

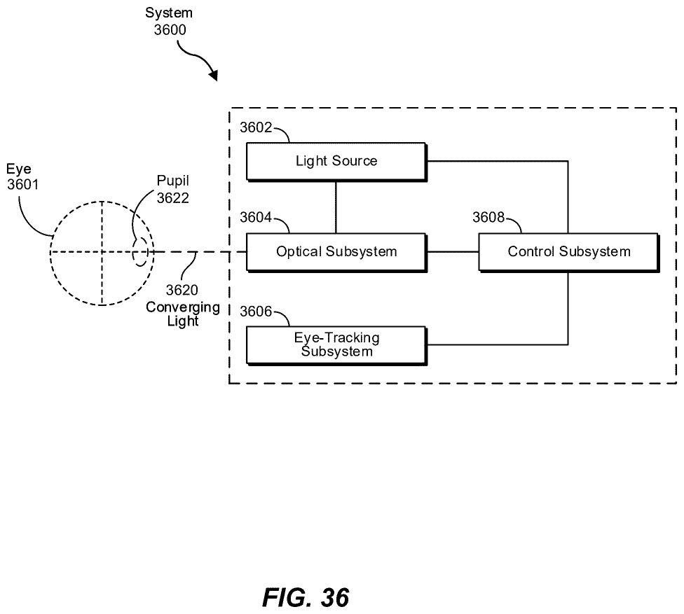

FIG. 36 is an illustration of an example system 3600 that incorporates an eye-tracking subsystem capable of tracking a user's eye(s). As depicted in FIG. 36, system 3600 may include a light source 3602, an optical subsystem 3604, an eye-tracking subsystem 3606, and/or a control subsystem 3608. In some examples, light source 3602 may generate light for an image (e.g., to be presented to an eye 3601 of the viewer). Light source 3602 may represent any of a variety of suitable devices. For example, light source 3602 can include a two-dimensional projector (e.g., a LCOS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 3604 may receive the light generated by light source 3602 and generate, based on the received light, converging light 3620 that includes the image. In some examples, optical subsystem 3604 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 3620. Further, various mechanical couplings may serve to maintain the relative spacing and/or the orientation of the optical components in any suitable combination.

In one embodiment, eye-tracking subsystem 3606 may generate tracking information indicating a gaze angle of an eye 3601 of the viewer. In this embodiment, control subsystem 3608 may control aspects of optical subsystem 3604 (e.g., the angle of incidence of converging light 3620) based at least in part on this tracking information. Additionally, in some examples, control subsystem 3608 may store and utilize historical tracking information (e.g., a history of the tracking information over a given duration, such as the previous second or fraction thereof) to anticipate the gaze angle of eye 3601 (e.g., an angle between the visual axis and the anatomical axis of eye 3601). In some embodiments, eye-tracking subsystem 3606 may detect radiation emanating from some portion of eye 3601 (e.g., the cornea, the iris, the pupil, or the like) to determine the current gaze angle of eye 3601. In other examples, eye-tracking subsystem 3606 may employ a wavefront sensor to track the current location of the pupil.

Any number of techniques can be used to track eye 3601. Some techniques may involve illuminating eye 3601 with infrared light and measuring reflections with at least one optical sensor that is tuned to be sensitive to the infrared light. Information about how the infrared light is reflected from eye 3601 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 3606 may be digitized (i.e., converted to an electronic signal). Further, the sensor may transmit a digital representation of this electronic signal to one or more processors (for example, processors associated with a device including eye-tracking subsystem 3606). Eye-tracking subsystem 3606 may include any of a variety of sensors in a variety of different configurations. For example, eye-tracking subsystem 3606 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 3606 to track the movement of eye 3601. In another example, these processors may track the movements of eye 3601 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 3606 may be programmed to use an output of the sensor(s) to track movement of eye 3601. In some embodiments, eye-tracking subsystem 3606 may analyze the digital representation generated by the sensors to extract eye rotation information from changes in reflections. In one embodiment, eye-tracking subsystem 3606 may use corneal reflections or glints (also known as Purkinje images) and/or the center of the eye's pupil 3622 as features to track over time.

In some embodiments, eye-tracking subsystem 3606 may use the center of the eye's pupil 3622 and infrared or near-infrared, non-collimated light to create corneal reflections. In these embodiments, eye-tracking subsystem 3606 may use the vector between the center of the eye's pupil 3622 and the corneal reflections to compute the gaze direction of eye 3601. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 3606 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 3601 may act as a retroreflector as the light reflects off the retina, thereby creating a bright pupil effect similar to a red-eye effect in photography. If the illumination source is offset from the optical path, then the eye's pupil 3622 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 3608 may control light source 3602 and/or optical subsystem 3604 to reduce optical aberrations (e.g., chromatic aberrations and/or monochromatic aberrations) of the image that may be caused by or influenced by eye 3601. In some examples, as mentioned above, control subsystem 3608 may use the tracking information from eye-tracking subsystem 3606 to perform such control. For example, in controlling light source 3602, control subsystem 3608 may alter the light generated by light source 3602 (e.g., by way of image rendering) to modify (e.g., pre-distort) the image so that the aberration of the image caused by eye 3601 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

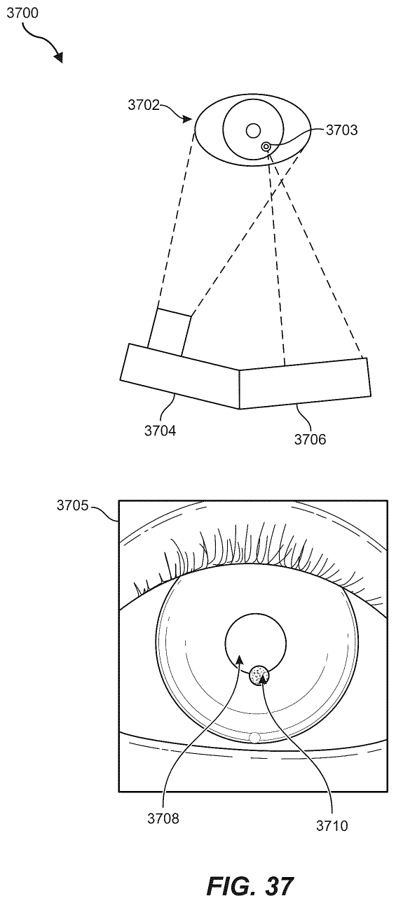

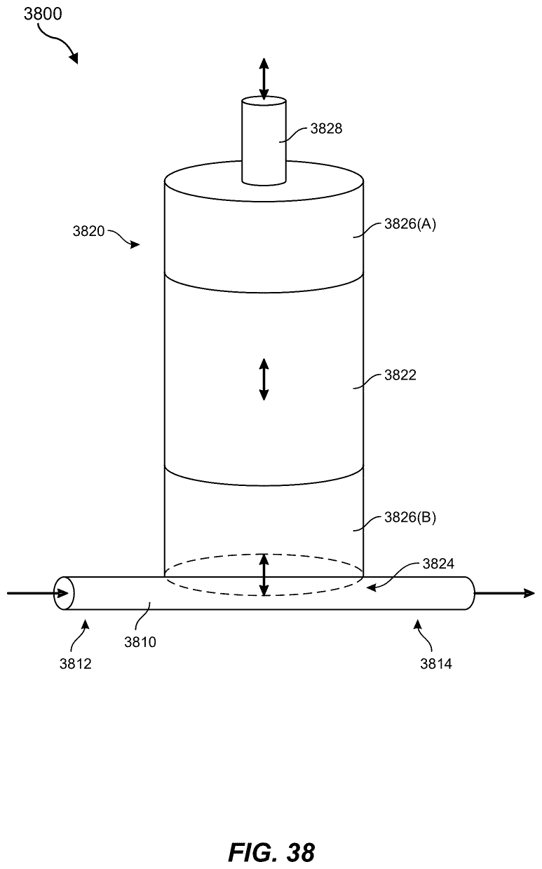

FIG. 37 is a more detailed illustration of various aspects of the eye-tracking subsystem illustrated in FIG. 36. As shown in this figure, an eye-tracking subsystem 3700 may include at least one source 3704 and at least one sensor 3706. Source 3704 generally represents any type or form of element capable of emitting radiation. In one example, source 3704 may generate visible, infrared, and/or near-infrared radiation. In some examples, source 3704 may radiate non-collimated infrared and/or near-infrared portions of the electromagnetic spectrum towards an eye 3702 of a user. Source 3704 may utilize a variety of sampling rates and speeds. For example, the disclosed systems may use sources with higher sampling rates in order to capture fixational eye movements of a user's eye 3702 and/or to correctly measure saccade dynamics of the user's eye 3702. As noted above, any type or form of eye-tracking technique may be used to track the user's eye 3702, including optical-based eye-tracking techniques, ultrasound-based eye-tracking techniques, etc.

Sensor 3706 generally represents any type or form of element capable of detecting radiation, such as radiation reflected off the user's eye 3702. Examples of sensor 3706 include, without limitation, a charge coupled device (CCD), a photodiode array, a complementary metal-oxide-semiconductor (CMOS) based sensor device, and/or the like. In one example, sensor 3706 may represent a sensor having predetermined parameters, including, but not limited to, a dynamic resolution range, linearity, and/or other characteristic selected and/or designed specifically for eye tracking.

As detailed above, eye-tracking subsystem 3700 may generate one or more glints. As detailed above, a glint 3703 may represent reflections of radiation (e.g., infrared radiation from an infrared source, such as source 3704) from the structure of the user's eye. In various embodiments, glint 3703 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 37 shows an example image 3705 captured by an eye-tracking subsystem, such as eye-tracking subsystem 3700. In this example, image 3705 may include both the user's pupil 3708 and a glint 3710 near the same. In some examples, pupil 3708 and/or glint 3710 may be identified using an artificial intelligence-based algorithm, such as a computer-vision-based algorithm. In one embodiment, image 3705 may represent a single frame in a series of frames that may be analyzed continuously in order to track the eye 3702 of the user. Further, pupil 3708 and/or glint 3710 may be tracked over a period of time to determine a user's gaze.

In one example, eye-tracking subsystem 3700 may be configured to identify and measure the inter-pupillary distance (IPD) of a user. In some embodiments, eye-tracking subsystem 3700 may measure and/or calculate the IPD of the user while the user is wearing the artificial reality system. In these embodiments, eye-tracking subsystem 3700 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 3600 and/or eye-tracking subsystem 3700 may be incorporated into any of the augmented-reality systems in and/or virtual-reality systems described herein in to enable these systems to perform various eye-tracking tasks (including one or more of the eye-tracking operations described herein).

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 38 shows a schematic diagram of a fluidic valve 3800 for controlling flow through a fluid channel 3810, according to at least one embodiment of the present disclosure. Fluid from a fluid source (e.g., a pressurized fluid source, a fluid pump, etc.) may flow through the fluid channel 3810 from an inlet port 3812 to an outlet port 3814, which may be operably coupled to, for example, a fluid-driven mechanism, another fluid channel, or a fluid reservoir.

Fluidic valve 3800 may include a gate 3820 for controlling the fluid flow through fluid channel 3810. Gate 3820 may include a gate transmission element 3822, which may be a movable component that is configured to transmit an input force, pressure, or displacement to a restricting region 3824 to restrict or stop flow through the fluid channel 3810. Conversely, in some examples, application of a force, pressure, or displacement to gate transmission element 3822 may result in opening restricting region 3824 to allow or increase flow through the fluid channel 3810. The force, pressure, or displacement applied to gate transmission element 3822 may be referred to as a gate force, gate pressure, or gate displacement. Gate transmission element 3822 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 38, gate 3820 of fluidic valve 3800 may include one or more gate terminals, such as an input gate terminal 3826(A) and an output gate terminal 3826(B) (collectively referred to herein as “gate terminals 3826”) on opposing sides of gate transmission element 3822. Gate terminals 3826 may be elements for applying a force (e.g., pressure) to gate transmission element 3822. By way of example, gate terminals 3826 may each be or include a fluid chamber adjacent to gate transmission element 3822. Alternatively or additionally, one or more of gate terminals 3826 may include a solid component, such as a lever, screw, or piston, that is configured to apply a force to gate transmission element 3822.

In some examples, a gate port 3828 may be in fluid communication with input gate terminal 3826(A) for applying a positive or negative fluid pressure within the input gate terminal 3826(A). A control fluid source (e.g., a pressurized fluid source, a fluid pump, etc.) may be in fluid communication with gate port 3828 to selectively pressurize and/or depressurize input gate terminal 3826(A). In additional embodiments, a force or pressure may be applied at the input gate terminal 3826(A) in other ways, such as with a piezoelectric element or an electromechanical actuator, etc.

In the embodiment illustrated in FIG. 38, pressurization of the input gate terminal 3826(A) may cause the gate transmission element 3822 to be displaced toward restricting region 3824, resulting in a corresponding pressurization of output gate terminal 3826(B). Pressurization of output gate terminal 3826(B) may, in turn, cause restricting region 3824 to partially or fully restrict to reduce or stop fluid flow through the fluid channel 3810. Depressurization of input gate terminal 3826(A) may cause gate transmission element 3822 to be displaced away from restricting region 3824, resulting in a corresponding depressurization of the output gate terminal 3826(B). Depressurization of output gate terminal 3826(B) may, in turn, cause restricting region 3824 to partially or fully expand to allow or increase fluid flow through fluid channel 3810. Thus, gate 3820 of fluidic valve 3800 may be used to control fluid flow from inlet port 3812 to outlet port 3814 of fluid channel 3810.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
forming a layer of an organic solid crystal (OSC) material;
forming a hard mask over the OSC layer;
creating an opening in the hard mask; and
etching the OSC layer through the opening in the hard mask to form a grating structure in the OSC layer.

2. A method of claim 1, wherein the OSC layer comprises a crystalline phase.

3. A method of claim 1, wherein the grating structure comprises pyramids and rectangular prisms.

4. The method of claim 1, wherein opening the hard mask further comprises etching the hard mask prior to etching the OSC layer.

5. The method of claim 1, further comprises forming a conformal coating over the grating structure.

6. The method of claim 1, wherein the hard mask is silicon oxide, silicon nitride, or titanium nitride.

7. A device comprising:
a reflective backplane;
an array of micro-ribbons disposed on the reflective backplane; and
a metasurface structure positioned beneath the array of micro-ribbons.

8. The device of claim 7, wherein the metasurface structure comprises a plurality of metasurface structures individually positioned beneath each micro-ribbon in the array of micro-ribbons.

9. A method of speckle reduction in holographic displays, comprising:
generating a broad spectrum of light using a laser architecture;
filtering multiple ‘discrete wavelengths using an image optimization module;
multiplexing multiple discrete wavelengths using the image optimization module; and
incoherently averaging speckle patterns across various wavelengths using a spatial light modulator architecture.

10. The method of claim 9, wherein the laser architecture is configured to generate a set of polychromatic, spatially coherent wavefronts.

11. The method of claim 9, wherein the laser architecture comprises one or more lasers.

12. The method of claim 9, wherein the image optimization module is configured to optimize for wavelengths and intensity of light emitted from the laser architecture.

13. The method of claim 9, wherein the spatial light modulator architecture comprises:
multiple spatial light modulators; and
multiple hyperspectral lookup tables.

14. The method of claim 9, wherein spatial light modulators have an air gap in between one and any subsequent spatial light modulators.
